(19) United States
(12) Patent Application Publication
(10) Pub. No.: US 2011/0135935 A1
(43) Pub. Date: Jun. 9, 2011

(54) METHOD FOR FORMING A MULTILAYER COATING FILM

(76) Inventors: Takato Adachi, Kanagawa (JP); Kazuaki Kitazono, Kanagawa (JP); Shuichi Nakahara, Aichi (JP)

(21) Appl. No.: 13/057,890

(22) PCT Filed: Aug. 10, 2009
(86) PCT No.: PCT/JP2009/064370

§ 371 Date: Feb. 7, 2011

(30) Foreign Application Priority Data
Aug. 12, 2008 (JP) 2008-208258
Aug. 12, 2008 (JP) 2008-208261

(51) Int. Cl. B32B 27/26; B05D 3/10; C08K 5/11

(52) U.S. Cl. 428/422.8; 427/301; 428/473.5; 524/314

(57) ABSTRACT

An object of the present invention is to provide a method of producing a multilayer coating film having excellent smoothness and high distinctness of image. The method of forming a multilayer coating film according to the present invention includes the steps of: successively applying an aqueous intermediate coating composition, an aqueous base coating composition, and a clear coating composition to a substrate; and simultaneously heat-curing the resulting intermediate, base, and clear coating layers, the aqueous intermediate coating composition (X) comprising: a base resin (A); a curing agent (B); and a diester compound (C), the curing agent (B) being a polyisocyanate compound (B1) and/or a polycarbodiimide compound (B2); and the diester compound (C) being represented by formula (1): (wherein R¹ and R² are each independently a hydrocarbon group having 4 to 18 carbon atoms, R³ is an alkylene group having 2 to 4 carbon atoms, m is an integer of 3 to 25, and m oxyalkylene units (R³—O) may be the same or different).

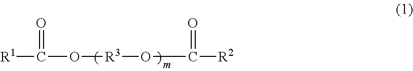

### TECHNICAL FIELD

The present invention relates to a method of forming a multilayer coating film having excellent appearance, by a 3-coat-1-bake process comprising successively applying an aqueous intermediate coating composition, an aqueous base coating composition, and a clear coating composition to a substrate, and heat-curing the resulting three layers simultaneously to form a multilayer coating film.

### BACKGROUND ART

A method of forming a multilayer coating film by a 3-coat-2-bake (3C2B) process is widely used as a method for forming a coating film on automobile bodies. This method comprises the following steps after applying an electrodeposition coating composition to a substrate: application of an intermediate coating composition→curing by baking→application of a base coating composition→preheating (preliminary heating)→application of a clear coating composition→curing by baking. However, in recent years, for the purpose of saving energy, attempts have been made to omit the bake-curing step that is performed after applying the intermediate coating composition and use a 3-coat-1-bake (3C1B) process comprising the following steps after applying an electrodeposition coating composition to a substrate: application of an intermediate coating composition→preheating (preliminary heating)→application of a base coating composition→preheating (preliminary heating)→application of a clear coating composition→curing by baking.

From the viewpoint of controlling the environmental pollution caused by the vaporization of organic solvents, the establishment of a 3-coat 1-bake process using an aqueous intermediate coating composition and an aqueous base coating composition is particularly desired.

However, the 3-coat 1-bake process using an aqueous intermediate composition and an aqueous base coating composition has the following drawback due to the use of water as a main solvent in the composition. When an aqueous base coating composition is applied to an intermediate coating layer, the intermediate coating layer is dissolved by the water contained in the aqueous base coating composition, thus forming a mixed layer at the interface between the intermediate and base coating layers and resulting in a coating film having low smoothness and low distinctness of image. Particularly, when an aqueous base coating composition containing a luster pigment is used, the mixed layer distorts the orientation of the luster pigment contained in the aqueous base composition, thus resulting in low flip-flop effect and/or metallic mottling of the resulting coating film.

To solve the above problem, Patent Document 1 discloses a method of forming a multilayer coating film comprising applying an aqueous intermediate coating composition to a substrate to form an intermediate coating layer thereon, applying an aqueous metallic base coating composition to the intermediate coating layer to form a metallic base coating layer thereon, and applying a clear coating composition to the base coating layer to form a clear coating layer thereon. Patent Document 1 describes that when the aqueous intermediate coating composition and/or the aqueous metallic base coating composition contains a polycarbodiimide compound and a carboxy-containing aqueous resin, the resulting multilayer coating film has excellent water resistance and high distinctness of image. However, the coating film obtained by the method disclosed in Patent Document 1 has insufficient smoothness.

Patent Document 2 discloses a method of forming a multilayer coating film by a 3C1B process using an aqueous intermediate coating composition (A), an aqueous base coating composition (B), and a clear coating composition (C). According to Patent Document 2, the aqueous intermediate coating composition (A) contains a polyester resin (X) and a curing agent (Y), and the polyester resin (X) contains a benzene ring and a cyclohexane ring in an amount of 1.0 to 2.2 mol/kg (resin solids content) in total; and that the curing agent (Y) is at least one compound selected from the group consisting of isocyanate group-containing compounds (a), oxazoline group-containing compounds (b), carbodiimide group-containing compounds (c), hydrazide group-containing compounds (d), and semicarbazide group-containing compounds (e). Patent Document 2 describes that the method disclosed therein can produce a multilayer coating film having excellent smoothness, distinctness of image, chipping resistance, and water resistance. However, even when the method disclosed in Patent Document 2 is used, the resulting multilayer coating film may be insufficient in terms of smoothness and distinctness of image.

### CITATION LIST

### Patent Literature

PTL 1: Japanese Unexamined Patent Publication No. 2001-9357
PTL 2: WO 2007/126107

### SUMMARY OF INVENTION

### Technical Problem

An object of the present invention is to provide a method of forming a multilayer coating film having excellent smoothness and high distinctness of image, by a 3-coat 1-bake process comprising successively applying an aqueous intermediate coating composition, an aqueous base coating composition, and a clear coating composition to a substrate, and simultaneously heat-curing the resulting three layers to form a multilayer coating film, and in particular to provide a method of forming a multilayer coating film having an excellent appearance with a high flip-flop effect and little metallic mottling when using an aqueous base coating composition containing a luster pigment.

### Solution to Problem

To achieve the above object, the present inventors carried out extensive research. As a result, the inventors found that the above object can be achieved by a 3-coat 1-bake process comprising successively applying an aqueous intermediate coating composition, an aqueous base coating composition, and a clear coating composition to a substrate, and simultaneously heat-curing the resulting three layers to form a multilayer coating film, while using, as the intermediate coating composition, a specific coating composition comprising a base resin (A), a specific curing agent (B), and a diester compound (C) having a specific structure. The present invention has been accomplished based on this finding.

The present invention provides a method of forming a multilayer coating film, an aqueous intermediate coating composition used in the method, and an article having a multilayer coating film formed thereon by the method, as itemized below.

1. A method of forming a multilayer coating film comprising the steps of:
(1) applying an aqueous intermediate coating composition (X) to a substrate to form an intermediate coating layer thereon;
(2) applying an aqueous base coating composition (Y) to the uncured intermediate coating layer formed in step (1) to form a base coating layer thereon;
(3) applying a clear coating composition (Z) to the uncured base coating layer formed in step (2) to form a clear coating layer thereon; and
(4) simultaneously heat-curing the uncured intermediate coating, uncured base coating, and uncured clear coating layers formed in steps (1) to (3),
the aqueous intermediate coating composition (X) comprising: a base resin (A); a curing agent (B); and a diester compound (C),
the curing agent (B) being a polyisocyanate compound (B1) and/or a polycarbodiimide compound (B2); and
the diester compound (C) being represented by formula (1):

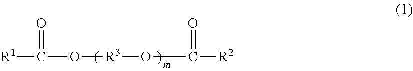

(wherein R¹ and R² are each independently a hydrocarbon group having 4 to 18 carbon atoms, R³ is an alkylene group having 2 to 4 carbon atoms, m is an integer of 3 to 25, and m oxyalkylene units (R³—O) may be the same or different).
2. The method of forming a multilayer coating film according to item 1 wherein the base resin (A) is a hydroxy-containing resin (A1), and the curing agent (B) is a polyisocyanate compound (B1).
3. The method of forming a multilayer coating film according to item 2 wherein the hydroxy-containing resin (A1) is a hydroxy-containing polyester resin (A1-1) and/or a hydroxy-containing acrylic resin (A1-2).
4. The method of forming a multilayer coating film according to item 3 wherein the hydroxy-containing polyester resin (A1-1) is a polyester resin containing a C₄ or higher linear alkylene group in an amount of 0.3 to 2.5 mol/kg (on a resin solids basis).
5. The method of forming a multilayer coating film according to item 3 wherein the hydroxy-containing polyester resin (A1-1) contains a benzene ring and/or a cyclohexane ring in such an amount that the total amount of benzene ring and cyclohexane ring is in the range of 1.5 to 4.0 mol/kg (on a resin solids basis).
6. The method of forming a multilayer coating film according to item 2 wherein the polyisocyanate compound (B1) is a water-dispersible polyisocyanate compound.
7. The method of forming a multilayer coating film according to item 2 wherein the proportions of the hydroxy-containing resin (A1), polyisocyanate compound (B1), and diester compound (C) are such that the amount of hydroxyl-containing resin (A1) is 30 to 95 parts by mass, the amount of polyisocyanate compound (B1) is 5 to 70 parts by mass, and the amount of diester compound (C) is 1 to 30 parts by mass, per 100 parts by mass of the total amount of hydroxy-containing resin (A1) and polyisocyanate compound (B1), on a solids basis.
8. The method of forming a multilayer coating film according to item 1 wherein the base resin (A) is a carboxy-containing resin (A2), and the curing agent (B) is a polycarbodiimide compound (B2).
9. The method of forming a multilayer coating film according to item 8 wherein the carboxy-containing resin (A2) is a carboxy-containing polyester resin (A2-1) and/or a carboxy-containing acrylic resin (A2-2).
10. The method of forming a multilayer coating film according to item 9 wherein the carboxy-containing polyester resin (A2-1) is a polyester resin containing a C₄ or higher linear alkylene group in an amount of 0.3 to 2.5 mol/kg (on a resin solids basis).
11. The method of forming a multilayer coating film according to item 9 wherein the carboxy-containing polyester resin (A2-1) contains a benzene ring and/or a cyclohexane ring in such an amount that the total amount of benzene ring and cyclohexane ring is in the range of 1.5 to 4.0 mol/kg (on a resin solids basis).
12. The method of forming a multilayer coating film according to item 8 wherein the proportions of the carboxy-containing resin (A2), the polycarbodiimide compound (B2), and the diester compound (C) are such that the amount of carboxy-containing resins (A2) is 30 to 95 parts by mass, the amount of polycarbodiimide compound (B2) is 5 to 70 parts by mass, and the amount of diester compound (C) is 1 to 30 parts by mass, per 100 parts by mass of the total amount of carboxy-containing resin (A2) and polycarbodiimide compound (B2), on a solids basis.
13. The method of forming a multilayer coating film according to item 1 wherein the coating composition (X) contains a carboxy- and hydroxy-containing resin (A3) as the base resin (A), a polycarbodiimide compound (B2) as the curing agent (B), and further contains an amino resin (B3).
14. The method of forming a multilayer coating film according to item 13 wherein the amino resin (B3) is a melamine resin (B3-1), the melamine resin (B3-1) being a methyl-butyl mixed etherified melamine resin having a methoxy/butoxy molar ratio in the range of 90/10 to 50/50.
15. The method of forming a multilayer coating film according to item 1 wherein the aqueous intermediate coating composition (X) further contains a coloring pigment (D1) and/or an extender pigment (D2) in such an amount that the total amount of coloring pigment (D1) and extender pigment (D2) is in the range of 40 to 180 parts by mass per 100 parts by mass of the total amount of base resin (A) and curing agent (B), on a solids basis.
16. The method of forming a multilayer coating film according to item 1 wherein the aqueous base coating composition (Y) comprises a luster pigment (D3).
17. The method of forming a multilayer coating film according to item 1 wherein the substrate is a vehicle body having an undercoating layer formed thereon using an electrodeposition coating composition.
18. An article having a multilayer coating film formed thereon by the method of item 1.
19. An aqueous intermediate coating composition for forming a multilayer coating film comprising a base resin (A), a curing agent (B), and a diester compound (C), the curing agent (B) being a polyisocyanate compound (B1) and/or a polycarbodiimide compound (B2); and the diester compound (C) being represented by formula (1):

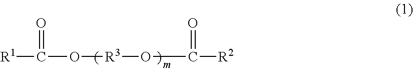

(wherein R¹ and R² are each independently a hydrocarbon group having 4 to 18 carbon atoms, R³ is an alkylene group having 2 to 4 carbon atoms, m is an integer of 3 to 25, and m oxyalkylene units (R³—O) may be the same or different).

### Advantageous Effects of Invention

According to the method of forming a coating film of the present invention, a multilayer coating film having excellent smoothness and excellent distinctness of image can be produced by a 3-coat 1-bake process comprising successively applying an aqueous intermediate coating composition, an aqueous base coating composition, and a clear coating composition to a substrate, and simultaneously heat-curing the resulting three layers to form a multilayer coating film. When using an aqueous base coating composition containing a luster pigment, a multilayer coating film having excellent appearance with a high flip-flop effect and little metallic mottling can be formed.

### DESCRIPTION OF EMBODIMENTS

The method of forming a multilayer coating film of the present invention will be described below in more detail.

### 1. Step (1)

In step (1) of the method of forming a multilayer coating film of the present invention, an aqueous intermediate coating composition (X) is applied to a substrate. The aqueous intermediate coating composition (X) comprises: a base resin (A); a curing agent (B); and a diester compound (C),

the curing agent (B) being a polyisocyanate compound (B1) and/or a polycarbodiimide compound (B2), and the diester compound (C) being represented by formula (1):

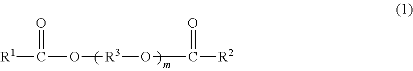

(wherein R¹ and R² are each independently a hydrocarbon group having 4 to 18 carbon atoms, R³ is an alkylene group having 2 to 4 carbon atoms, m is an integer of 3 to 25, and m oxyalkylene units (R³—O) may be the same or different).

### 1.1 Substrate

The substrate to be coated with the aqueous intermediate coating composition (X) is not particularly limited. Examples of substrates include exterior panel parts of automobile bodies such as passenger cars, trucks, motorcycles, and buses; automotive components such as bumpers; exterior panel parts of household electric appliances such as cellular phones and audio equipment; etc. Among these substrates, exterior panel parts of automobile bodies and automotive components are preferable.

The material for the substrate is not particularly limited. Examples of the material include metallic materials such as iron, aluminium, brass, copper, tin, stainless steel, galvanized steel, steel plated with zinc alloys (Zn—Al, Zn—Ni, Zn—Fe, etc.); plastic materials such as polyethylene resins, polypropylene resins, acrylonitrile-butadiene-styrene (ABS) resins, polyamide resins, acrylic resins, vinylidene chloride resins, polycarbonate resins, polyurethane resins, epoxy resins, and like resins, mixtures of these resins, and various types of fiber-reinforced plastics (FRP); inorganic materials such as glass, cement, and concrete; wood; textile materials such as paper and cloth; etc. Among these materials, metallic materials and plastic materials are particularly preferable.

The substrate may be a surface-treated substrate which may further have a coating layer formed thereon. More specifically, the substrate may be a metal material or a metal body formed of the material as mentioned above, such as a vehicle body, which may be subjected to a surface treatment, such as phosphate treatment, chromate treatment, or composite oxide treatment, and which may be further coated thereon.

Examples of the substrate having a coating layer formed thereon include base materials whose surface is optionally treated and which have an undercoating layer formed thereon. Among these, vehicle bodies having an undercoating layer formed thereon using an electrodeposition coating composition are preferable, and those having an undercoating layer formed thereon using a cationic deposition coating composition are particularly preferable.

The substrate may be a plastic material as mentioned above or a plastic member formed therefrom, such as an automotive component (or parts), which may have been surface-treated or coated with a primer, etc. The substrate may be a combination of plastic and metallic materials mentioned above.

### 1.2 Base Resin (A)

The resin that can be used as the base resin (A) is not particularly limited. Examples of the base resin (A) include a hydroxy-containing resin (A1), a carboxy-containing resin (A2), and a carboxy- and hydroxy-containing resin (A3). Each of the resins is described below.

### 1.2.1 Hydroxy-Containing Resin (A1)

The hydroxy-containing resin (A1) is a resin having at least one hydroxy group per molecule. From the viewpoint of the water resistance and other properties of the resulting coating film, the hydroxy-containing resin (A1) preferably has a hydroxy value of about 5 to about 300 mg KOH/g, more preferably about 15 to about 200 mg KOH/g, and even more preferably about 30 to about 180 mg KOH/g.

The hydroxy-containing resin (A1) may have acid group(s) in the molecule. Examples of the acid group include a carboxy group, a sulfonic acid group, a phosphoric acid group, etc. It is particularly preferable that the hydroxy-containing resin (A) have one or more carboxy groups as the acid group. When the hydroxy-containing resin (A1) has carboxy group(s), the hydroxy-containing resin (A1) is a carboxy- and hydroxy-containing resin (A3) as described below. The hydroxy-containing resin (A1) can be made water soluble or water dispersible by neutralizing the acid group(s) with a basic compound.

Examples of the basic compound include hydroxides of alkali metals or alkaline earth metals such as sodium hydroxide, potassium hydroxide, lithium hydroxide, calcium hydroxide, and barium hydroxide; ammonia; primary monoamines such as ethylamine, propylamine, butylamine, benzylamine, monoethanolamine, neopentanolamine, 2-aminopropanol, 2-amino-2-methyl-1-propanol, and 3-aminopropanol; secondary monoamines such as diethylamine, diethanolamine, di-n-propanolamine, di-iso-propanolamine, N-methylethanolamine, and N-ethylethanolamine; tertiary monoamines such as dimethylethanolamine, trimethylamine, triethylamine, triisopropylamine, methyldiethanolamine, and 2-(dimethylamino)ethanol; polyamines such as diethylenetriamine, hydroxyethylaminoethylamine, ethylaminoethylamine, and methylaminopropylamine; etc.

From the viewpoint of the water resistance of the resulting coating film, the amount of basic compound is preferably about 0.1 to about 1.5 equivalents, and more preferably about 0.2 to about 1.2 equivalents, relative to the acid groups of the hydroxy-containing resin (A1).

When the hydroxy-containing resin (A1) contains acid group(s), the hydroxy-containing resin (A1) preferably has an acid value of about 3 to about 100 mg KOH/g, more preferably about 5 to about 80 mg KOH/g, and even more preferably about 10 to about 70 mg KOH/g, from the viewpoint of the storage stability of the immediate coating composition (X), the water resistance of the resulting coating film, etc. When a hydroxy-containing resin (A1) with an acid value of 10 mg KOH/g or less is used, the hydroxy-containing resin (A1) may be mixed with an emulsifier and agitated by applying a mechanical shear force to forcibly disperse the hydroxy-containing resin (A1) in water, instead of being neutralized with a basic compound.

Examples of the hydroxy-containing resin (A1) include polyester resins, acrylic resins, polyether resins, polycarbonate resins, polyurethane resins, epoxy resins, alkyd resins, etc. Such resins can be used singly or in a combination of two or more. It is particularly preferable to use a hydroxy-containing polyester resin (A1-1) and/or a hydroxy-containing acrylic resin (A1-2) as the hydroxy-containing resin (A1), and it is more preferable that the hydroxy-containing resin (A1) be a hydroxy-containing polyester resin (A1-1).

It is also possible to use, as the hydroxy-containing resin (A1), a so-called urethane-modified polyester resin or urethane-modified acrylic resin, which is obtained by a urethane reaction of a polyisocyanate compound with some of the hydroxy groups of the hydroxy-containing polyester resin (A1-1) or hydroxy-containing acrylic resin (A1-2) to extend the chain of the resin to increase the molecular weight.

### 1) Hydroxy-Containing Polyester Resin (A1-1)

The hydroxy-containing polyester resin (A1-1) can be produced by an esterification or transesterification reaction of an acid component (a1-1) with an alcohol component (a1-2).

A compound that is typically used as an acid component to produce a polyester resin can be used as the acid component (a1-1). Examples of the acid component (a1-1) include an aliphatic polybasic acid (a1-1-1), an alicyclic polybasic acid (a1-1-2), an aromatic polybasic acid (a1-1-3), and the like.

The aliphatic polybasic acid (a1-1-1) is generally an aliphatic compound having two or more carboxy groups per molecule; an acid anhydride of the aliphatic compound; or an ester of the aliphatic compound. Examples of the aliphatic polybasic acid (a1-1-1) include aliphatic polycarboxylic acids such as butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, tridecanedioic acid (brasylic acid), hexadecanedioic acid, and octadecanedioic acid; anhydrides of these aliphatic polycarboxylic acids; lower alkyl esters of these aliphatic polycarboxylic acids; and the like. Such examples of the aliphatic polybasic acid (a1-1-1) can be used singly or in a combination of two or more.

From the viewpoint of the smoothness, distinctness of image, water resistance, and chipping resistance of the resulting coating film, it is preferable to use, as the aliphatic polybasic acid (a1-1-1), an aliphatic dicarboxylic acid containing a C₄ or higher, preferably C₄₋₁₈, and more preferably C₆₋₁₂ linear alkyelene group. Examples of the aliphatic dicarboxylic acid containing a C₄ or higher linear alkylene group include hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, tridecanedioic acid (brasylic acid), hexadecanedioic acid, and octadecanedioic acid; anhydrides of these aliphatic dicarboxylic acids; lower alkyl esters of these aliphatic dicarboxylic acids; and the like. Such compounds can be used singly or in a combination of two or more.

The alicyclic polybasic acid (a1-1-2) is generally a compound having one or more alicyclic structures (mainly 4- to 6-membered rings) and two or more carboxy groups per molecule; an acid anhydride of the compound; or an ester of the compound. Examples of the alicyclic polybasic acid (a1-1-2) include alicyclic polycarboxylic acids such as 1,2-cyclohexanedicarboxylic acid, 1,3-cyclohexanedicarboxylic acid, 1,4-cyclohexanedicarboxylic acid, 4-cyclohexene-1,2-dicarboxylic acid, 3-methyl-1,2-cyclohexanedicarboxylic acid, 4-methyl-1,2-cyclohexanedicarboxylic acid, 1,2,4-cyclohexanetricarboxylic acid, and 1,3,5-cyclohexanetricarboxylic acid; anhydrides of these alicyclic polycarboxylic acids; lower alkyl esters of these alicyclic polycarboxylic acids; etc. Such examples of the alicyclic polybasic acid (a1-1-2) can be used singly or in a combination of two or more.

The aromatic polybasic acid (a1-1-3) is generally an aromatic compound having two or more carboxy groups per molecule; an acid anhydride of the aromatic compound; and an ester of the aromatic compound. Examples of the aromatic polybasic acid (a1-1-3) include aromatic polycarboxylic acids such as phthalic acid, isophthalic acid, terephthalic acid, naphthalenedicarboxylic acid, 4,4′-biphenyldicarboxylic acid, trimellitic acid, and pyromellitic acid; anhydrides of these aromatic polycarboxylic acids; lower alkyl esters of these aromatic polycarboxylic acids; and the like. Such examples of the aromatic polybasic acid (a1-1-3) can be used singly or in a combination of two or more.

It is particularly preferable to use, as the aromatic polybasic acid (a1-1-3), phthalic acid, phthalic anhydride, isophthalic acid, trimellitic acid, or trimellitic anhydride.

Examples of the acid component (a1-1) other than the aliphatic polybasic acid (a1-1-1), alicyclic polybasic acid (a1-1-2), and aromatic polybasic acid (a1-1-3) include fatty acids such as palm oil fatty acid, cottonseed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid, and safflower oil fatty acid; monocarboxylic acids such as lauric acid, myristic acid, palmitic acid, stearic acid, oleic acid, linolic acid, linolenic acid, benzoic acid, p-tert-butylbenzoic acid, cyclohexanoic acid, and 10-phenyloctadecanoic acid; hydroxycarboxylic acids such as lactic acid, 3-hydroxybutanoic acid, and 3-hydroxy-4-ethoxybenzoic acid; and the like. Such examples of the acid component (a1-1) can be used singly or in a combination of two or more.

A polyhydric alcohol having at least two hydroxy groups per molecule can be preferably used as the alcohol component (a1-2). Examples of the polyhydric alcohol include an aliphatic diol (a1-2-1), an alicyclic diol (a1-2-2), an aromatic diol (a1-2-3), and the like.

The aliphatic diol (a1-2-1) is generally an aliphatic compound having two hydroxy groups per molecule. Examples of the aliphatic diol (a1-2-1) include ethylene glycol, propylene glycol, diethylene glycol, trimethylene glycol, tetraethylene glycol, triethylene glycol, dipropylene glycol, 1,4-butanediol, 1,3-butanediol, 2,3-butanediol, 1,2-butanediol, 3-methyl-1,2-butanediol, 2-butyl-2-ethyl-1,3-propanediol, 1,2-pentanediol, 1,5-pentanediol, 1,4-pentanediol, 2,4-pentanediol, 2,3-dimethyltrimethylene glycol, tetramethylene glycol, 3-methyl-4,3-pentanediol, 3-methyl-1,5-pentanediol, 2,2,4-trimethyl-1,3-pentanediol, 1,6-hexanediol, 1,5-hexanediol, 1,4-hexanediol, 2,5-hexanediol, 1,9-nonanediol, 1,10-decanediol, 1,12-dodecanediol, neopentylglycol, and the like. Such compounds can be used singly or in a combination of two or more.

From the viewpoint of the smoothness, distinctness of image, chipping resistance, etc., of the resulting coating film, it is preferable to use, as the aliphatic diol (a1-2-1), an aliphatic diol containing a C₄ or higher, preferably C₄₋₁₂, and more preferably C₆₋₁₀ linear alkylene group. Examples of the aliphatic diol containing C₄ or higher linear alkylene group include 1,4-butanediol, 1,5-pentanediol, 1,6-hexanediol, 1,7-heptanediol, 1,8-octanediol, 1,9-nonanediol, etc. Such compounds can be used singly or in a combination of two or more.

The alicyclic diol (a1-2-2) is generally a compound having one or more alicyclic structures (mainly 4- to 6-membered rings) and two or more hydroxy groups per molecule. Examples of the alicyclic diol (a1-2-2) include dihydric alcohols such as 1,4-cyclohexane dimethanol, tricyclodecanedimethanol, hydrogenated bisphenol A, and hydrogenated bisphenol F; polylactone diols obtained by adding lactones, such as s-caprolactone, to these dihydric alcohols; etc. Such compounds can be used singly or in a combination of two or more.

The aromatic diol (a1-2-3) is generally an aromatic compound having two or more hydroxy groups per molecule. Examples of the aromatic diol (a1-2-3) include ester diols such as bis(hydroxyethyl)terephthalate; alkylene oxide adducts of bisphenol A; and the like. Such compounds can be used singly or in a combination of two or more.

Examples of the polyhydric alcohol other than the aliphatic diol (a1-2-1), alicyclic diol (a1-2-2), and aromatic diol (a1-2-3) include polyether diols such as polyethylene glycol, polypropylene glycol, and polybutylene glycol; trihydric or higher alcohols such as glycerol, trimethylolethane, trimethylolpropane, diglycerol, triglycerin, 1,2,6-hexanetriol, pentaerythritol, dipentaerythritol, tris(2-hydroxyethyl)isocyanurate, sorbitol, and mannite; polylactone polyols obtained by adding lactones, such as ε-caprolactone, to these trihydric or higher hydric alcohols; and the like.

Examples of the alcohol component (a1-2) other than the above polyhydric alcohols include monohydric alcohols such as methanol, ethanol, propyl alcohol, butyl alcohol, stearyl alcohol, and 2-phenoxyethanol; alcohol compounds obtained by reacting acids with monoepoxy compounds, such as propylene oxide, butylene oxide, and a glycidyl ester of a synthetic highly branched saturated fatty acid (trade name “Cardula E10”, manufactured by HEXION Specialty Chemicals); and the like.

From the viewpoint of the smoothness, distinctness of image, water resistance, chipping resistance, etc. of the resulting coating film, a polyester resin containing a C₄ or higher linear alkylene group in an amount of 0.3 to 2.5 mol/kg (on a resin solids basis), and more preferably 0.6 to 2.0 mol/kg (on a resin solids basis) is preferably used as the hydroxy-containing polyester resin (A1-1).

The hydroxy-containing polyester resin containing a C₄ or higher linear alkylene group can be produced, for example, by using, as the acid component (a1-1), an aliphatic dicarboxylic acid containing a C₄ or higher linear alkylene group or using, as the alcohol component (a1-2), an aliphatic diol containing a C₄ or higher linear alkylene group.

The “amount of C₄ or higher linear alkylene group”, as used herein, is expressed by the number of moles of the C₄ or higher linear alkylene group per kg of the polyester resin (on a solids basis). This can be calculated by dividing the total mole number (Wm) of the C₄ or higher linear alkylene group-containing monomers used to produce a polyester resin by the mass (Wr, unit: kg) of the obtained resin excluding the mass of condensed water (i.e., Wm/Wr).

The “amount of the C₄ or higher linear alkylene group” can be controlled by adjusting the proportion of the C₄ or higher linear alkylene group-containing aliphatic dicarboxylic acid and C₄ or higher linear alkylene group-containing aliphatic diol in the acid component (a1-1) and alcohol component (a1-2).

From the viewpoint of the smoothness, distinctness of image, water resistance, chipping resistance, etc. of the resulting coating film, the hydroxy-containing polyester resin (A1-1) preferably contains a benzene ring and/or a cyclohexane ring in such an amount that the total amount of benzene ring and cyclohexane ring is in the range of 1.5 to 4.0 mol/kg (on a resin solids basis), and more preferably 2.0 to 3.5 mol/kg (on a resin solids basis).

The hydroxy-containing polyester resin containing a benzene ring and/or a cyclohexane ring can be produced, for example, by using, as the acid component (a1-1) or the alcohol component (a1-2), at least one compound selected from the group consisting of an alicyclic polybasic acid (a1-1-2), an aromatic polybasic acid (a1-1-3), an alicyclic diol (a1-2-2), and an aromatic diol (a1-2-3), and performing an esterification or transesterification reaction.

The “total amount of benzene ring and cyclohexane ring” as used herein refers to the total mole number of the benzene ring and the cyclohexane ring contained per kg of the polyester resin (on a solids basis). This can be calculated by dividing the total mole number (Wn) of the benzene ring-containing monomers and cyclohexane ring-containing monomers contained in monomers used to produce a polyester resin by the mass (Wr, unit: kg) of the obtained resin excluding the mass of condensed water (i.e., Wn/Wr).

The “total amount of benzene ring and cyclohexane ring” can be controlled, for example, by adjusting the proportions of the alicyclic polybasic acid (a1-1-2), aromatic polybasic acid (a1-1-3), alicyclic diol (a1-2-2), and aromatic diol (a1-2-3) in the acid component (a1-1) and alcohol component (a1-2).

The method of producing the hydroxy-containing polyester resin (A1-1) is not particularly limited, and may be a commonly used method. For example, a method can be employed in which the acid component (a1-1) is reacted with the alcohol component (a1-2) in a nitrogen stream at 150 to 250° C. for 5 to 10 hours to perform an esterification or transesterification reaction.

In the esterification or transesterification reaction, the acid component (a1-1) and the alcohol component (a1-2) can be added at once or in divided portions. A carboxy-containing polyester resin may be first synthesized and then esterified with the alcohol component (a1-2). Alternatively, the hydroxy-containing polyester resin (A1-1) may be first synthesized and then reacted with an acid anhydride to half-esterify the hydroxy-containing polyester resin.

In the esterification or transesterification reaction, a catalyst may be used to promote the reaction. Known catalysts are usable including dibutyltin oxide, antimony trioxide, zinc acetate, manganese acetate, cobalt acetate, calcium acetate, lead acetate, tetrabutyl titanate, tetraisopropyl titanate, etc.

The hydroxy-containing polyester resin (A1-1) can be modified with a fatty acid, a monoepoxy compound, a polyisocyanate compound, or the like during the preparation of the resin or after the esterification or transesterification reaction.

Examples of the fatty acid include palm oil fatty acid, cottonseed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid, safflower oil fatty acid, and the like.

Preferable examples of the monoepoxy compound include a glycidyl ester of a synthetic highly branched saturated fatty acid (trade name “Cardura E10”, a product of HEXION Specialty Chemicals).

Examples of the polyisocyanate compound include aliphatic diisocyanates such as lysine diisocyanate, hexamethylene diisocyanate, and trimethylhexane diisocyanate; alicyclic diisocyanates such as hydrogenated xylylene diisocyanate, isophorone diisocyanate, methylcyclohexane-2,4-diisocyanate, methylcyclohexane-2,6-diisocyanate, 4,4′-methylenebis(cyclohexylisocyanate), and 1,3-(isocyanatomethyl)cyclohexane; aromatic diisocyanates such as tolylene diisocyanate, xylylene diisocyanate, and diphenylmethane diisocyanate; organic polyisocyanates such as lysine triisocyanate and like tri- or higher polyisocyanates; adducts of such organic polyisocyanates with polyhydric alcohols, low-molecular-weight polyester resins, water or the like; cyclopolymers (e.g., isocyanurates), biuret-type adducts, etc., of such organic diisocyanates; and the like. Such compounds can be used singly or in a combination of two or more.

The hydroxy-containing polyester resin (A1-1) has a hydroxy value of preferably about 10 to about 300 mg KOH/g, more preferably about 50 to about 200 mg KOH/g, and even more preferably about 80 to about 180 mg KOH/g. The hydroxy-containing polyester resin (A1-1) has an acid value of preferably about 3 to about 100 mg KOH/g, more preferably about 5 to about 80 mg KOH/g, and even more preferably about 10 to about 70 mg KOH/g.

The hydroxy-containing polyester resin (A1-1) has a weight average molecular weight of preferably about 500 to about 50,000, more preferably about 1,000 to about 30,000, and even more preferably about 1,500 to about 20,000.

The hydroxy-containing polyester resin (A1-1) has a number average molecular weight of preferably about 500 to about 5,000, more preferably about 750 to about 4,000, and even more preferably about 1,000 to about 3,000.

The number average molecular weight and weight average molecular weight as used herein are determined by converting the number average molecular weight and the weight average molecular weight measured using a gel permeation chromatograph (GPC), based on the molecular weight of polystyrene standards.

When the aqueous intermediate coating composition (X) contains a hydroxy-containing polyester resin (A1-1) as the hydroxy-containing resin (A1), the amount of hydroxy-containing polyester resin (A1-1), on a solids basis, in the composition is preferably about 5 to about 95 mass %, more preferably about 20 to about 90 mass %, and even more preferably about 30 to about 85 mass %, based on the total amount of hydroxy-containing resin (A1) and polyisocyanate compound (B1), on a solids basis.

### 2) Hydroxy-Containing Acrylic Resin (A1-2)

The hydroxy-containing acrylic resin (A1-2) typically can be produced by copolymerizing a hydroxy-containing polymerizable unsaturated monomer (a1-3) and another polymerizable unsaturated monomer (a1-4) that is copolymerizable with the hydroxy-containing polymerizable unsaturated monomer (a1-3) by, for example, a known method such as solution polymerization in an organic solvent, emulsion polymerization in water, etc.

The hydroxy-containing polymerizable unsaturated monomer (a1-3) is a compound having one or more hydroxy groups and one or more polymerizable unsaturated bonds per molecule. Examples of the hydroxy-containing polymerizable unsaturated monomer (a1-3) include monoesters of (meth)acrylates with C₂₋₈ dihydric alcohols, such as 2-hydroxyethyl(meth)acrylate, 2-hydroxypropyl(meth)acrylate, 3-hydroxypropyl(meth)acrylate, and 4-hydroxybutyl(meth)acrylate; ε-caprolactone-modified products of these monoesters; N-hydroxymethyl(meth)acrylamide; allyl alcohol; (meth)acrylates having hydroxy-terminated polyoxyethylene chains; and the like.

Examples of another polymerizable unsaturated monomer (a1-4) that is copolymerizable with the hydroxy-containing polymerizable unsaturated monomer (a1-3) include alkyl or cycloalkyl(meth)acrylates such as methyl(meth)acrylate, ethyl (meth)acrylate, n-propyl(meth)acrylate, i-propyl(meth)acrylate, n-butyl(meth)acrylate, i-butyl(meth)acrylate, tert-butyl (meth)acrylate, n-hexyl(meth)acrylate, n-octyl(meth)acrylate, 2-ethylhexyl(meth)acrylate, nonyl(meth)acrylate, tridecyl (meth)acrylate, lauryl(meth)acrylate, stearyl(meth)acrylate, “Isostearyl Acrylate” (trade name, a product of Osaka Organic Chemical Industry Ltd.), cyclohexyl(meth)acrylate, methylcyclohexyl(meth)acrylate, t-butylcyclohexyl(meth)acrylate, and cyclododecyl(meth)acrylate; isobornyl group-containing polymerizable unsaturated monomers such as isobornyl (meth)acrylate; adamanthyl group-containing polymerizable unsaturated monomers such as adamanthyl(meth)acrylate; vinyl aromatic compounds such as styrene, α-methylstyrene, and vinyltoluene; alkoxysilyl group-containing polymerizable unsaturated monomers such as vinyltrimethoxysilane, vinyltriethoxysilane, vinyltris(2-methoxyethoxy)silane, γ-(meth)acryloyloxypropyltrimethoxysilane, and γ-(meth) acryloyloxypropyltriethoxysilane; perfluoroalkyl (meth)acrylates such as perfluorobutylethyl(meth)acrylate, and perfluorooctylethyl(meth)acrylate; polymerizable unsaturated monomers having fluorinated alkyl groups, such as fluoroolefins; polymerizable unsaturated monomers having photopolymerizable functional groups, such as a maleimide group; vinyl compounds such as N-vinylpyrrolidone, ethylene, butadiene, chloroprene, vinyl propionate, and vinyl acetate; carboxy-containing polymerizable unsaturated monomers, such as (meth)acrylic acid, maleic acid, crotonic acid, and β-carboxyethyl acrylate; nitrogen-containing polymerizable unsaturated monomers, such as (meth) acrylonitrile, (meth) acrylamide, N,N-dimethylaminoethyl (meth)acrylate, N,N-dimethylaminopropyl(meth) acrylamide, and amine adducts of glycidyl(meth)acrylate; polymerizable unsaturated monomers having two or more polymerizable unsaturated groups per molecule, such as allyl(meth)acrylate and 1,6-hexanediol di(meth)acrylate; epoxy group-containing polymerizable unsaturated monomers, such as glycidyl(meth)acrylate, β-methylglycidyl(meth)acrylate, 3,4-epoxycyclohexylmethyl (meth)acrylate, 3,4-epoxycyclohexylethyl(meth)acrylate, 3,4-epoxycyclohexylpropyl(meth)acrylate, and allyl glycidyl ether; (meth)acrylates having alkoxy-terminated polyoxyethylene chains; sulfonic acid group-containing polymerizable unsaturated monomers, such as 2-acrylamide-2-methylpropanesulfonic acid, allylsulfonic acid, styrenesulfonic acid, and sulfoethyl methacrylate; sodium salts and ammonium salts of these sulfonic acid group-containing polymerizable unsaturated monomers; phosphoric acid group-containing polymerizable unsaturated monomers, such as 2-acryloyloxyethyl acid phosphate, 2-methacryloyloxyethyl acid phosphate, 2-acryloyloxypropyl acid phosphate, and 2-methacryloyloxypropyl acid phosphate; polymerizable unsaturated monomers having UV-absorbing functional groups, such as 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone, and 2-(2′-hydroxy-5′-methacryloyloxyethylphenyl)-2H-benzotriazole; UV-stable polymerizable unsaturated monomers such as 4-(meth) acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, and 1-crotonoyl-4-crotonoyloxy-2,2,6,6-tetramethylpiperidine; carbonyl group-containing polymerizable unsaturated monomers such as acrolein, diacetone acrylamide, diacetone methacrylamide, acetoacetoxylethyl methacrylate, formylstyrol, and vinyl alkyl ketones having 4 to 7 carbon atoms (e.g, vinyl methyl ketone, vinyl ethyl ketone, and vinyl butyl ketone); polymerizable unsaturated monomers having cationic functional groups, such as tertiary amino groups, and quaternary ammonium salt groups; and the like. Such examples of the polymerizable unsaturated monomer (a1-4) can be used singly or in a combination of two or more.

The hydroxy-containing acrylic resin (A1-2) may have a cationic functional group. The hydroxy-containing acrylic resin having a cationic functional group can be produced by, for example, using a polymerizable unsaturated monomer having a cationic functional group, such as a tertiary amino group or a quaternary ammonium salt group, as at least a part of the above-mentioned polymerizable unsaturated monomer (a1-4).

Examples of the tertiary amino group-containing polymerizable unsaturated monomer include N,N-dimethylaminoethyl (meth)acrylate, N,N-diethylaminoethyl(meth)acrylate, N,N-dimethylaminopropyl (meth)acrylate, N,N-di-t-butylaminoethyl (meth)acrylate, N,N-dimethylaminobutyl(meth)acrylate, and like N,N-dialkylaminoalkyl(meth)acrylates; N,N-dimethylaminoethyl (meth) acrylamide, N,N-diethylaminoethyl(meth) acrylamide, N,N-dimethylaminopropyl (meth)acrylamide, and like N,N-dialkylaminoalkyl (meth)acrylamides; etc. Among these, it is particularly preferable to use at least one selected from N,N-dimethylaminoethyl(meth)acrylate and N,N-diethylaminoethyl (meth)acrylate.

Examples of the quaternary ammonium salt group-containing polymerizable unsaturated monomer include 2-(methacryloyloxy)ethyl trimethyl ammonium chloride, 2-(methacryloyloxy)ethyl trimethyl ammonium bromide, 2-(methacryloyloxy)ethyl trimethyl ammonium dimethyl phosphate, and like (meth)acryloyloxyalkyl trialkyl ammonium salts; methacryloylaminopropyltrimethylammonium chloride, methacryloylaminopropyltrimethylammonium bromide, and like (meth)acryloylaminoalkyltrialkylammonium salts; etc. Among these, it is particularly preferable to use 2-(methacryloyloxy)ethyltrimethylammonium chloride.

From the viewpoint of the storage stability, the water resistance of the resulting coating film, etc., the hydroxy-containing acrylic resin (A1-2) preferably has a hydroxy value of about 5 to about 300 mg KOH/g, more preferably about 15 to about 200 mg KOH/g, and even more preferably about 30 to about 180 mg KOH/g.

When the hydroxy-containing acrylic resin (A1-2) has an acid group such as a carboxy group, the hydroxy-containing acrylic resin (A1-2) has an acid value of preferably about 3 to about 100 mg KOH/g, more preferably about 5 to about 80 mg KOH/g, and even more preferably about 10 to about 70 mg KOH/g, from the viewpoint of the water resistance and other properties of the resulting coating film.

The hydroxy-containing acrylic resin (A1-2) has a weight average molecular weight of preferably about 2,000 to about 5,000,000, and more preferably about 3,000 to about 2,000,000.

When the aqueous intermediate coating composition (X) of the present invention comprises the hydroxy-containing acrylic resin (A1-2) as the hydroxy-containing resin (A1), the amount of hydroxy-containing acrylic resin (A1-2), on a solids basis, in the composition is preferably about 5 to about 95 mass %, more preferably about 10 to about 70 mass %, and even more preferably about 20 to about 50 mass %, based on the total amount of the hydroxy-containing resin (A1) and the polyisocyanate compound (B1), on a solids basis.

### 1.2.2 Carboxy-Containing Resin (A2)

The carboxy-containing resin (A2) contains at least one carboxy group per molecule. From the viewpoint of the water resistance and other properties of the resulting coating film, the carboxy-containing resin (A2) has an acid value of preferably about 10 to about 100 mg KOH/g, more preferably about 15 to about 90 mg KOH/g, and even more preferably about 15 to about 80 mg KOH/g.

The carboxy-containing resin (A2) can be made water soluble or water dispersible by neutralizing the carboxy group with a basic compound. Examples of the basic compound include those mentioned above in Section 1.2.1 Hydroxy-containing resin (A1).

From the viewpoint of the water resistance and other properties of the resulting coating film, the amount of basic compound is preferably about 0.1 to about 1.5 equivalents, and more preferably about 0.2 to about 1.2 equivalents, relative to the acid groups of the carboxy-containing resin (A2).

When the carboxy-containing resin (A2) has a hydroxy group, the carboxy-containing resin (A2) is a carboxy- and hydroxy-containing resin (A3).

When the carboxy-containing resin (A2) has a hydroxy group, the carboxy-containing resin (A2) has a hydroxy value of preferably about 5 to about 200 mg KOH/g, more preferably about 15 to about 180 mg KOH/g, and even more preferably about 20 to about 160 mg KOH/g, from the viewpoint of the water resistance, chipping resistance, etc. of the resulting coating film.

Examples of the carboxy-containing resin (A2) include polyester resins, acrylic resins, polyether resins, polycarbonate resins, polyurethane resins, epoxy resins, alkyd resins, and the like. Such resins can be used singly or in a combination of two or more. It is particularly preferable to use, as the carboxy-containing resin (A2), a carboxy-containing polyester resin (A2-1) and/or a carboxy-containing acrylic resin (A2-2), and it is more preferable to use a carboxy-containing polyester resin (A2-1).

### 1) The Carboxy-Containing Polyester Resin (A2-1)

The carboxy-containing polyester resin (A2-1) can typically be produced by an esterification or transesterification reaction of an acid component (a1-1) with an alcohol component (a1-2).

A compound that is usually used as an acid component to produce a polyester resin can be used as the acid component (a1-1). Examples of the acid component (a1-1) include an aliphatic polybasic acid (a1-1-1), an alicyclic polybasic acid (a1-1-2), an aromatic polybasic acid (a1-1-3), and the like. Examples of the aliphatic polybasic acid (a1-1-1), alicyclic polybasic acid (a1-1-2), and aromatic polybasic acid (a1-1-3) include those mentioned above in Section 1.2.1 Hydroxy-containing resin (A1). From the viewpoint of the smoothness, distinctness of image, water resistance, chipping resistance, etc. of the resulting coating film, it is preferable to use, as the aliphatic polybasic acid (a1-1-1), an aliphatic dicarboxylic acid containing a C₄ or higher linear alkylene group, preferably a C₄₋₁₈, more preferably C₆₋₁₂ linear alkylene group.

It is particularly preferable to use, as the aromatic polybasic acid (a1-1-3), phthalic acid, phthalic anhydride, isophthalic acid, trimellitic acid, or trimellitic anhydride.

Examples of the acid component (a1-1) other than the aliphatic polybasic acid (a1-1-1), alicyclic polybasic acid (a1-1-2), and aromatic polybasic acid (a1-1-3) include those mentioned above in Section 1.2.1 Hydroxy-containing resin (A1).

A polyhydric alcohol having two or more hydroxy groups per molecule can be preferably used as the alcohol component (a1-2). The polyhydric alcohol may be, for example, an aliphatic diols (a1-2-1), an alicyclic diols (a1-2-2), an aromatic diols (a1-2-3), etc. Examples of the aliphatic diol (a1-2-1), alicyclic diol (a1-2-2), and aromatic diol (a1-2-3) include those mentioned above in Section 1.2.1 Hydroxy-containing resin (A1).

From the viewpoint of the smoothness, distinctness of image, chipping resistance, etc., of the resulting coating film, it is preferable to use, as the aliphatic diol (a1-2-1), an aliphatic diol containing a C₄ or higher, preferably a C₄₋₁₂, and more preferably C₆₋₁₀ linear alkylene group.

Examples of the polyhydric alcohol other than the aliphatic diol (a1-2-1), alicyclic diol (a1-2-2), and aromatic diol (a1-2-3) include those mentioned above in Section 1.2.1 Hydroxy-containing resin (A1).

Examples of the alcohol component (a1-2) other than the above-mentioned polyhydric alcohols include those mentioned above in Section 1.2.1 Hydroxy-containing resin (A1).

From the viewpoint of the smoothness, distinctness of image, water resistance, chipping resistance, etc., of the resulting coating film, the carboxy-containing polyester resin (A2-1) is preferably a polyester resin containing a C₄ or higher linear alkylene group in an amount of 0.3 to 2.5 mol/kg (on a resin solids basis), and more preferably 0.6 to 2.0 mol/kg (on a resin solids basis).

The carboxy-containing polyester resin containing C₄ or higher linear alkylene groups can be produced, for example, by using an aliphatic dicarboxylic acid containing a C₄ or higher linear alkylene group as the acid component (a1-1) or using an aliphatic diol containing a C₄ or high linear alkylene group as the alcohol component (a1-2).

The “amount of C₄ or higher linear alkylene group” as used herein refers to the number of moles of the C₄ or higher linear alkylene group contained per kg of the polyester resin (on a solids basis). This can be calculated by dividing the total mole number (Wm) of the C₄ or higher linear alkylene group-containing monomers used to produce a polyester resin by the mass (Wr, unit: kg) of the obtained resin excluding the mass of condensed water (i.e., Wm/Wr).

The “amount of C₄ or higher linear alkylene group” can be controlled by adjusting the proportions of the C₄ or higher linear alkylene group-containing aliphatic dicarboxylic acid and C₄ or higher linear alkylene group-containing aliphatic diol in the acid component (a1-1) and alcohol component (a1-2).

From the viewpoint of the smoothness, distinctness of image, water resistance, chipping resistance, etc., of the resulting coating film, the carboxy-containing polyester resin (A2-1) preferably contains a benzene ring and/or a cyclohexane ring in such an amount that the total amount of benzene ring and cyclohexane ring is the range of 1.5 to 4.0 mol/kg, and preferably 2.0 to 3.5 mol/kg (on a resin solids basis).

The carboxy-containing polyester resin having a benzene ring and/or a cyclohexane ring can be produced, for example, by using, as the acid component (a1-1) or alcohol component (a1-2), at least one compound selected from the group consisting of an alicyclic polybasic acid (a1-1-2), an aromatic polybasic acid (a1-1-3), an alicyclic diol (a1-2-2), an aromatic diol (a1-2-3) and performing an esterification or transesterification reaction.

The “total amount of benzene ring and cyclohexane ring”, as used herein, refers to the total mole number of the benzene ring and cyclohexane ring contained per kg of the polyester resin (on a solids basis). This can be calculated by dividing the total mole number (Wn) of the benzene ring-containing monomers and cyclohexane ring-containing monomers contained in monomers used to produce a polyester resin by the mass (Wr, unit: kg) of the obtained resin excluding the mass of condensed water (i.e., Wn/Wr).

The “total amount of benzene ring and cyclohexane ring” can be controlled, for example, by adjusting the proportions of the alicyclic polybasic acid (a1-1-2), aromatic polybasic acid (a1-1-3), alicyclic diol (a1-2-2), and aromatic diol (a1-2-3) in the acid component (a1-1) and alcohol component (a1-2).

The method for producing the carboxy-containing polyester resin (A2-1) is not particularly limited, and may be a known method. For example, a method can be employed in which the acid component (a1-1) is reacted with the alcohol component (a1-2) in a nitrogen stream at 150 to 250° C. for 5 to 10 hours to perform an esterification or transesterification reaction.

In the esterification or transesterification reaction, the acid component (a1-1) and the alcohol component (a1-2) can be added at once or in divided portions. A carboxy-containing polyester resin (A2-1) may be first synthesized and then esterified with the alcohol component (a1-2). Alternatively, the hydroxy-containing polyester resin may be first synthesized and then reacted with an acid anhydride to half-esterify the hydroxy-containing polyester resin.

In the esterification or transesterification reaction, a catalyst may be used to promote the reaction. Examples of the catalyst include dibutyltin oxide, antimony trioxide, zinc acetate, manganese acetate, cobalt acetate, calcium acetate, lead acetate, tetrabutyl titanate, tetraisopropyl titanate, and like known catalysts.

The carboxy-containing polyester resin (A2-1) can be modified with a fatty acid, a monoepoxy compound, a polyisocyanate compound, or the like during the preparation of the resin or after the esterification or transesterification reaction.

Examples of the fatty acid, monoepoxy compound, and polyisocyanate compound include those mentioned above in Section 1.2.1 Hydroxy-containing resin (A1).

The carboxy-containing resin (A2-1) preferably has an acid value of about 10 to about 100 mg KOH/g, more preferably about 15 to about 90 mg KOH/g, and even more preferably about 15 to about 80 mg KOH/g.

The carboxy-containing polyester resin (A2-1) has a weight average molecular weight of preferably about 500 to about 50,000, more preferably about 1,000 to about 30,000, and even more preferably about 1,500 to about 20,000.

The carboxy-containing polyester resin (A2-1) has a number average molecular weight of preferably about 500 to about 5,000, more preferably about 750 to about 4,000, and even more preferably about 1,000 to about 3,000.

When the aqueous intermediate coating composition (X) contains a carboxy-containing polyester resin (A2-1) as the carboxy-containing resin (A2), the amount of carboxy-containing polyester resin (A2-1), on a solids basis, in the composition is preferably about 5 to about 95 mass %, more preferably about 20 to about 90 mass %, and even more preferably about 30 to about 85 mass %, based on the total amount of carboxy-containing resin (A2) and polycarbodiimide compound (B2), on a solids basis.

### 2) Carboxy-Containing Acrylic Resin (A2-2)

The carboxy-containing acrylic resin (A2-2) can be typically produced by copolymerizing a carboxy-containing polymerizable unsaturated monomer (a2-1) and another polymerizable unsaturated monomer (a2-2) that is copolymerizable with the carboxy-containing polymerizable unsaturated monomer (a2-1) by, for example, a known method such as solution polymerization in an organic solvent, emulsion polymerization in water, etc.

The carboxy-containing polymerizable unsaturated monomer (a2-1) is a compound having one or more carboxy groups and one or more polymerizable unsaturated bonds per molecule. Examples of the carboxy-containing polymerizable unsaturated monomers (a2-1) include (meth)acrylic acid, maleic acid, crotonic acid, β-carboxyethyl acrylate, and the like. Such compounds can be used singly or in a combination of two or more. It is particularly preferable to use acrylic acid and/or methacrylic acid as the carboxy-containing polymerizable unsaturated monomer (a2-1).

Examples of another polymerizable unsaturated monomer (a2-2) that is copolymerizable with the carboxy-containing polymerizable unsaturated monomer (a2-1) include alkyl or cycloalkyl(meth)acrylates such as methyl(meth)acrylate, ethyl (meth)acrylate, n-propyl(meth)acrylate, i-propyl(meth)acrylate, n-butyl(meth)acrylate, i-butyl(meth)acrylate, tert-butyl (meth)acrylate, n-hexyl(meth)acrylate, n-octyl(meth)acrylate, 2-ethylhexyl(meth)acrylate, nonyl(meth)acrylate, tridecyl (meth)acrylate, lauryl(meth)acrylate, stearyl(meth)acrylate, “Isostearyl Acrylate” (trade name, a product of Osaka Organic Chemical Industry Ltd.), cyclohexyl(meth)acrylate, methylcyclohexyl(meth)acrylate, t-butylcyclohexyl(meth)acrylate, and cyclododecyl(meth)acrylate; hydroxy-containing polymerizable unsaturated monomers such as 2-hydroxyethyl(meth)acrylate, 2-hydroxypropyl(meth)acrylate, 3-hydroxypropyl(meth)acrylate, and 4-hydroxybutyl(meth)acrylate, and like monoesters of (meth)acrylates with C₂₋₈ dihydric alcohols, ε-caprolactone-modified products of these monoesters, N-hydroxymethyl (meth)acrylamide, allyl alcohol, and (meth)acrylates having hydroxy-terminated polyoxyethylene chains; isobornyl group-containing polymerizable unsaturated monomers such as isobornyl (meth)acrylate; adamanthyl group-containing polymerizable unsaturated monomers such as adamanthyl(meth)acrylate; vinyl aromatic compounds such as styrene, α-methylstyrene, and vinyltoluene; alkoxysilyl group-containing polymerizable unsaturated monomers such as vinyltrimethoxysilane, vinyltriethoxysilane, vinyltris(2-methoxyethoxy)silane, γ-(meth) acryloyloxypropyltrimethoxysilane, and γ-(meth)acryloyloxypropyltriethoxysilane; perfluoroalkyl (meth)acrylates such as perfluorobutylethyl(meth)acrylate, and perfluorooctylethyl(meth)acrylate; polymerizable unsaturated monomers having fluorinated alkyl groups, such as fluoroolefins; polymerizable unsaturated monomers having photopolymerizable functional groups, such as a maleimide group; vinyl compounds such as N-vinylpyrrolidone, ethylene, butadiene, chloroprene, vinyl propionate, and vinyl acetate; nitrogen-containing polymerizable unsaturated monomers, such as (meth)acrylonitrile, (meth)acrylamide, N,N-dimethylaminoethyl(meth)acrylate, N,N-dimethylaminopropyl (meth) acrylamide, and amine adducts of glycidyl(meth)acrylate; polymerizable unsaturated monomers having two or more polymerizable unsaturated groups per molecule, such as allyl(meth)acrylate and 1,6-hexanediol di(meth)acrylate; epoxy group-containing polymerizable unsaturated monomers, such as glycidyl(meth)acrylate, β-methylglycidyl(meth)acrylate, 3,4-epoxycyclohexylmethyl(meth)acrylate, 3,4-epoxycyclohexylethyl(meth)acrylate, 3,4-epoxycyclohexylpropyl(meth)acrylate, and allyl glycidyl ether; (meth)acrylates having alkoxy-terminated polyoxyethylene chains; sulfonic acid group-containing polymerizable unsaturated monomers, such as 2-acrylamide-2-methylpropanesulfonic acid, allylsulfonic acid, styrenesulfonic acid, and sulfoethyl methacrylate; sodium salts and ammonium salts of these sulfonic acid group-containing polymerizable unsaturated monomers; phosphoric acid group-containing polymerizable unsaturated monomers, such as 2-acryloyloxyethyl acid phosphate, 2-methacryloyloxyethyl acid phosphate, 2-acryloyloxypropyl acid phosphate, and 2-methacryloyloxypropyl acid phosphate; polymerizable unsaturated monomers having UV-absorbing functional groups, such as 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone, and 2-(2′-hydroxy-5′-methacryloyloxyethylphenyl)-2H-benzotriazole; UV-stable polymerizable unsaturated monomers such as 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, and 1-crotonoyl-4-crotonoyloxy-2,2,6,6-tetramethylpiperidine; carbonyl group-containing polymerizable unsaturated monomers such as acrolein, diacetone acrylamide, diacetone methacrylamide, acetoacetoxylethyl methacrylate, formylstyrol, and vinyl alkyl ketones having 4 to 7 carbon atoms (e.g, vinyl methyl ketone, vinyl ethyl ketone, and vinyl butyl ketone); polymerizable unsaturated monomers having cationic functional groups, such as tertiary amino groups, and quaternary ammonium salt groups; and the like. Such examples of the polymerizable unsaturated monomer (a2-2) can be used singly or in a combination of two or more.

The carboxy-containing acrylic resin (A2-2) may have a cationic functional group. The carboxy-containing acrylic resin having a cationic functional group can be produced by, for example, using a polymerizable unsaturated monomer having a cationic functional group, such as a tertiary amino group or a quaternary ammonium salt group, as at least a part of the above-mentioned polymerizable unsaturated monomer (a2-2).

Examples of the tertiary amino group-containing polymerizable unsaturated monomer include N,N-dimethylaminoethyl (meth)acrylate, N,N-diethylaminoethyl(meth)acrylate, N,N-dimethylaminopropyl (meth)acrylate, N,N-di-t-butylaminoethyl (meth)acrylate, N,N-dimethylaminobutyl(meth)acrylate and like N,N-dialkylaminoalkyl(meth)acrylates; N,N-dimethylaminoethyl (meth) acrylamide, N,N-diethylaminoethyl(meth) acrylamide, N,N-dimethylaminopropyl (meth)acrylamide and like N,N-dialkylaminoalkyl (meth)acrylamides; etc. Among these, it is preferable to use at least one member selected from N,N-dimethylaminoethyl (meth)acrylate and N,N-diethylaminoethyl (meth)acrylate.

Examples of the quaternary ammonium salt group-containing polymerizable unsaturated monomer include 2-(methacryloyloxy)ethyl trimethyl ammonium chloride, 2-(methacryloyloxy)ethyl trimethyl ammonium bromide, 2-(methacryloyloxy)ethyl trimethyl ammonium dimethyl phosphate, and like (meth)acryloyloxyalkyl trialkyl ammonium salts; methacryloylaminopropyltrimethylammonium chloride, methacryloylaminopropyltrimethylammonium bromide, and like (meth)acryloylaminoalkyltrialkylammonium salts; etc. Among these, it is preferable to use 2-(methacryloyloxy)ethyltrimethylammonium chloride.

From the viewpoint of the storage stability, water resistance of the resulting coating film, etc., the carboxy-containing acrylic resin (A2-2) has an acid value of preferably about 10 to about 100 mg KOH/g, more preferably about 15 to about 90 mg KOH/g, and even more preferably about 15 to about 80 mg KOH/g.

The carboxy-containing acrylic resin (A2-2) has a weight average molecular weight of preferably about 2,000 to about 5,000,000, and more preferably about 3,000 to about 2,000,000.

When the aqueous intermediate coating composition (X) contains the carboxy-containing acrylic resin (A2-2) as the carboxy-containing resin (A2), the amount of carboxy-containing acrylic resin (A2-2), on a solids basis, in the composition is preferably about 5 to about 95 mass %, more preferably about 10 to about 70 mass %, and even more preferably about 20 to about 60 mass %, based on the total amount of the carboxy-containing resin (A2) and polycarbodiimide compound (B2), on a solids basis.

### 1.2.3 Carboxy- and Hydroxy-Containing Resin (A3)

The carboxy- and hydroxy-containing resin (A3) can be produced by converting the carboxy-containing resin (A2) to have a hydroxy group or by converting the hydroxy-containing resin (A1) to have a carboxy group.

The carboxy- and hydroxy-containing resin (A3) preferably has an acid value of 10 to 100 mg KOH/g, more preferably 15 to 90 mg KOH/g, and even more preferably 15 to 80 mg KOH/g, and preferably has a hydroxy value of 5 to 200 mg KOH/g, more preferably 15 to 180 mg KOH/g, and even more preferably 20 to 160 mg KOH/g.

It is preferable to use, as the carboxy- and hydroxy-containing resin (A3), a carboxy- and hydroxy-containing polyester resin (A3-1) and/or a carboxy- and hydroxy-containing acrylic resin (A3-2). A carboxy- and hydroxy-containing polyester resin (A3-1) is particularly preferable.

### 1) Carboxy- and Hydroxy-Containing Polyester Resin (A3-1)

The method for producing the carboxy- and hydroxy-containing polyester resin (A3-1) is not particularly limited, and may be a known method. For example, the resin (A3-1) can be produced by adjusting the proportions of the acid component (a1-1) and alcohol component (a1-2) or adjusting the reaction temperature and reaction time in an esterification or transesterification reaction. The following production methods can also be used for production. After the carboxy-containing polyester resin (A2-1) is synthesized, a portion of the carboxy groups in the carboxy-containing polyester resin (A2-1) is esterified with the alcohol component (a1-2). Alternatively, after the hydroxy-containing polyester resin (A1-1) is synthesized, a portion of the hydroxy groups in the hydroxy-containing polyester resin is half-esterified.

The carboxy- and hydroxy-containing polyester resin (A3-1) preferably has an acid value of 10 to 100 mg KOH/g, more preferably 15 to 90 mg KOH/g, and even more preferably 15 to 80 mg KOH/g, and preferably has a hydroxy value of 10 to 200 mg KOH/g, more preferably 30 to 180 mg KOH/g, and even more preferably 40 to 160 mg KOH/g.

The carboxy- and hydroxy-containing polyester resin (A3-1) has a weight average molecular weight of preferably about 500 to about 50,000, more preferably about 1,000 to about 30,000, and even more preferably about 1,500 to about 20,000.

The carboxy- and hydroxy-containing polyester resin (A3-1) has a number average molecular weight of preferably about 500 to about 5,000, more preferably about 750 to about 4,000, and even more preferably about 1,000 to about 3,000.

### 2) Carboxy- and Hydroxy-Containing Acrylic Resin (A3-2)

The method for producing the carboxy- and hydroxy-containing acrylic resin (A3-2) is not particularly limited, and may be a known method. More specifically, the carboxy- and hydroxy-containing acrylic resin (A3-2) can be produced, for example, by using a hydroxy-containing polymerizable unsaturated monomer as another polymerizable unsaturated monomers (a2-2) that is copolymerizable with the carboxy-containing polymerizable unsaturated monomer (a2-1).

Examples of the hydroxy-containing polymerizable unsaturated monomer include monoesters of (meth)acrylates with C₂₋₈ dihydric alcohols, such as 2-hydroxyethyl(meth)acrylate, 2-hydroxypropyl(meth)acrylate, 3-hydroxypropyl(meth)acrylate, and 4-hydroxybutyl(meth)acrylate; ε-caprolactone-modified products of these monoesters; N-hydroxymethyl(meth)acrylamide; allyl alcohol; (meth)acrylates having hydroxy-terminated polyoxyethylene chains; and the like. Such compounds can be used singly or in a combination of two or more.

The carboxy- and hydroxy-containing acrylic resin (A3-2) preferably has an acid value of 10 to 100 mg KOH/g, more preferably 15 to 90 mg KOH/g, and even more preferably 15 to 80 mg KOH/g, and preferably has a hydroxy value of 5 to 200 mg KOH/g, more preferably 15 to 180 mg KOH/g, and even more preferably 20 to 160 mg KOH/g.

The carboxy- and hydroxy-containing acrylic resin (A3-2) has a weight average molecular weight of preferably about 2,000 to about 5,000,000, and more preferably about 3,000 to about 2,000,000.

### 1.3 Curing Agent (B)

The curing agent (B) used in the present invention is a polyisocyanate compound (B1) and/or a polycarbodiimide compound (B2), and can be selected according to the type of base resin (A) used. For example, when the base resin (A) is a hydroxy-containing resin (A1), a polyisocyanate compound (B1) is preferably used as the curing agent (B). When the base resin (A) is a carboxy-containing resin (A2), a polycarbodiimide compound (B2) is preferably used. When the base resin (A) is a carboxy- and hydroxy-containing resin (A3), the curing agent (B) is preferably a polyisocyanate compound (B1) and/or a polycarbodiimide compound (B2). When the curing agent (B) is a polycarbodiimide compound (B2), the composition preferably further contains an amino resin (B3).

The polyisocyanate compound (B1), polycarbodiimide compound (B2), and amino resin (B3) are described below.

### 1.3.1 Polyisocyanate Compound (B1)

The polyisocyanate compound (B1) is a compound having two or more unblocked isocyanate groups per molecule. Examples of such compounds include aliphatic polyisocyanates, alicyclic polyisocyanates, aromatic-aliphatic polyisocyanates, aromatic polyisocyantates, derivatives thereof; and the like.

Examples of the aliphatic polyisocyanate include trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, 2,6-diisocyanatomethylcaproate, and like aliphatic diisocyanates; lysine ester triisocyanate, 1,4,8-triisocyanatooctane, 1,6,11-triisocyanatoundecane, 1,8-diisocyanato-4-isocyanatomethyloctane, 1,3,6-triisocyanatohexane, 2,5,7-trimethyl-1,8-diisocyanate-5-isocyanatomethyloctane and like aliphatic triisocyanates; and the like.

Examples of the alicyclic polyisocyanate include alicyclic diisocyanates such as 1,3-cyclopentene diisocyanate, 1,4-cyclohexane diisocyanate, 1,3-cyclohexane diisocyanate, 3-isocyanatomethyl-3,5,5-trimethylcyclohexylisocyanate (common name: isophorone diisocyanate), methyl-2,4-cyclohexane diisocyanate, methyl-2,6-cyclohexane diisocyanate, 1,3- or 1,4-bis(isocyanatomethyl)cyclohexane (common name: hydrogenated xylylene diisocyanate), mixtures thereof, and norbornane diisocyanate; alicyclic triisocyanates such as 1,3,5-triisocyanatocyclohexane, 1,3,5-trimethylisocyanatocyclohexane, 2-(3-isocyanatopropyl)-2,5-di(isocyanatomethyl)-bicyclo2.2.1heptane, 2-(3-isocyanatopropyl)-2,6-di(isocyanatomethyl)-bicyclo2.2.1heptane, 3-(3-isocyanatopropyl)-2,5-di(isocyanatomethyl)-bicyclo2.2.1heptane, 5-(2-isocyanatoethyl)-2-isocyanatomethyl-3-(3-isocyanatopropyl)-bicyclo2.2.1heptane, 6-(2-isocyanatoethyl)-2-isocyanatomethyl-3-(3-isocyanatopropyl)-bicyclo2.2.1heptane, 5-(2-isocyanatoethyl)-2-isocyanatomethyl-2-(3-isocyanatopropyl)-bicyclo2.2.1-heptane, and 6-(2-isocyanatoethyl)-2-isocyanatomethyl-2-(3-isocyanatopropyl)-bicyclo2.2.1heptane; and the like.

Examples of the aromatic-aliphatic polyisocyanate include aromatic-aliphatic diisocyanates such as 1,3- or 1,4-xylylene diisocyanate, mixtures thereof, ω,ω′-diisocyanato-1,4-diethylbenzene, 1,3-, or 1,4-bis(1-isocyanato-1-methylethyl)benzene (common name: tetramethylxylylene diisocyanate) or a mixture thereof; aromatic-aliphatic triisocyanates such as 1,3,5-triisocyanatomethylbenzene; and the like.

Examples of the aromatic polyisocyanate include aromatic diisocyanates such as m-phenylene diisocyanate, p-phenylene diisocyanate, 4,4′-diphenyldiisocyanate, 1,5-naphthalene diisocyanate, 2,4′- or 4,4′-diphenylmethane diisocyanate or a mixture thereof, 2,4- or 2,6-tolylene diisocyanate or a mixture thereof, 4,4′-toluidine diisocyanate and 4,4′-diphenylether diisocyanate; aromatic triisocyanates such as triphenylmethane-4,4′,4″-triisocyanate, 1,3,5-triisocyanatobenzene, and 2,4,6-triisocyanatotoluene; and aromatic tetraisocyanates such as 4′,4′-diphenylmethane-2,2′,5,5′-tetraisocyanate; and the like.

Examples of the polyisocyanate derivative include dimers, trimers, biurets, allophanates, urethodiones, urethoimines, isocyanurates, oxadiazinetriones, polymethylene polyphenyl polyisocyanates (crude MDI, polymeric MDI), crude TDI, or like derivatives of the above-mentioned polyisocyanate compounds.

Such polyisocyanates and derivatives thereof can be used singly or in a combination of two or more. It is particularly preferable to use aliphatic diisocyanates, alicyclic diisocyanates, and/or derivatives thereof singly or in a combination of two or more.

From the viewpoint of the smoothness, etc. of the resulting coating film, the polyisocyanate compound (B1) is preferably a water-dispersible polyisocyanate compound. Any polyisocyanate compound that can be stably dispersed in an aqueous medium can be used as the water-dispersible polyisocyanate compound. It is particularly preferable to use a hydrophilic polyisocyanate compound (B1-1) produced by modifying a polyisocyanate compound to impart hydrophilicity thereto and/or a water-dispersible polyisocyanate compound prepared by mixing a polyisocyanate compound (B1) with a surfactant.

Examples of the hydrophilic polyisocyanate compound (B1-1) include anionic hydrophilic polyisocyanate compounds (B1-1-1) obtained by reacting an isocyanate group of a polyisocyanate compound with an active hydrogen group of an active hydrogen group-containing compound having an anionic group; nonionic hydrophilic polyisocyanate compounds (B1-1-2) obtained by reacting a hydrophilic polyether alcohol such as a monoalcohol of polyoxyethylene with a polyisocyanate compound; and the like. Such compounds can be used singly or in a combination of two or more.

Examples of the active hydrogen group-containing compound having an anionic group include compounds having an anionic group such as a carboxyl group, a sulfonic acid group, a phosphoric acid group or a betaine structure-containing group, and also having an active hydrogen group that can react with an isocyanate group, such as a hydroxy group or an amino group.

The active hydrogen group-containing compound having an anionic group is not particularly limited. Examples thereof include compounds having one anionic group and at least two active hydrogen groups. More specifically, examples of the active hydrogen group-containing compound having a carboxyl group include dihydroxycarboxylic acids such as 2,2-dimethylolacetic acid, 2,2-dimethylollactic acid, 2,2-dimethylolpropionic acid, 2,2-dimethylolbutanoic acid, dimethylolheptanoic acid, dimethylolnonanoic acid, 2,2-dimethylolbutyric acid, and 2,2-dimethylolvaleric acid; diaminocarboxylic acids such as 1-carboxy-1,5-pentylenediamine, dihydroxybenzoic acid, 3,5-diaminobenzoic acid, lysine, and alginine; half-ester compounds of polyoxypropylene triol with maleic anhydride or phthalic anhydride; and the like.

Examples of the active hydrogen group-containing compound having a sulfonic acid group include N,N-bis(2-hydroxyethyl)-2-aminoethanesulfonic acid, 1,3-phenylenediamine-4,6-disulfonic acid, diaminobutanesulfonic acid, 3,6-diamino-2-toluenesulfonic acid, 2,4-diamino-5-toluenesulfonic acid, 2-(cyclohexylamino)-ethanesulfonic acid, 3-(cyclohexylamino)-propanesulfonic acid, and the like.

Examples of the active hydrogen group-containing compound having a phosphoric acid group include 2,3-dihydroxypropylphenyl phosphate and the like.

Examples of the active hydrogen group-containing compound having a betaine structure-containing group include sulfobetaine group-containing compounds obtained by reacting a tertiary amine such as N-methyldiethanolamine with 1,3-propanesultone.

These active hydrogen group-containing compounds having anionic groups may be converted to alkylene oxide modified products by the addition of an alkylene oxide, such as ethylene oxide or propylene oxide.

Such active hydrogen group-containing compounds having an anionic group can be used singly or in a combination of two or more.

From the viewpoint of smoothness of the resulting coating film, it is particularly preferable to use, as the anionic hydrophilic polyisocyanate compound (B1-1-1), an anionic hydrophilic polyisocyanate compound obtained by reacting an isocyanate group of a polyisocyanate compound with an active hydrogen group of an active hydrogen group-containing compound having sulfonic acid group and/or phosphoric acid group.

Examples of the polyisocyanate compound that can be converted to a hydrophilic modified polyisocyanate compound (B1-1) include those already mentioned above. Among these compounds, aliphatic diisocyanates, alicyclic diisocyanates, and derivatives thereof are preferable. Specific examples of preferable compounds include hexamethylene diisocyanate (HMDI), derivatives of hexamethylene diisocyanate (HMDI), isophorone diisocyanate (IPDI) and derivatives of isophorone diisocyanate (IPDI).

When water dispersibility is imparted by mixing a polyisocyanate compound (B1) with a surfactant beforehand, an anionic surfactant and/or a nonionic surfactant is preferably used as the surfactant, and an anionic surfactant is particularly preferable.

From the viewpoint of water resistance of the resulting coating film, it is usually preferable to use the polyisocyanate compound (B1) in a proportion such that the equivalent ratio (NCO/OH) of the isocyanate group in the polyisocyanate compound (B1) to the hydroxy group in the hydroxyl-containing resin (A1) is in the range of 0.5 to 2.0, and particularly 0.8 to 1.5.

### 1.3.2 Polycarbodiimide Compound (B2)

The polycarbodiimide compound (B2) is a compound having at least two carbodiimide groups per molecule. Examples of such compounds include those obtained by subjecting isocyanate groups of an isocyanate group-containing compound to a carbon dioxide removal reaction with each other.

From the viewpoint of the smoothness and other properties of the resulting coating film, it is preferable to use a water-soluble or water-dispersible polycarbodiimide compound as the polycarbodiimide compound (B2). Any polycarbodiimide compound that can be stably dissolved or dispersed in an aqueous medium can be used as the water-soluble or water-dispersible polycarbodiimide compound.

Examples of the water-soluble polycarbodiimide compound include “Carbodilite SV-02”, “Carbodilite V-02”, “Carbodilite V-02-L2”, “Carbodilite V-04” (products of Nisshinbo Industries, Inc., trade names), and the like. Examples of the water-dispersible polycarbodiimide compound include “Carbodilite E-01” and “Carbodilite E-02” (products of Nisshinbo Industries, Inc., trade names).

Such polycarbodiimide compounds (B2) can be used singly or in a combination of two or more.

### 1.3.3 Amino Resin (B3)

Examples of the amino resin (B3) include partially or fully methylolated amino resins obtained by reacting amino components with aldehyde components.

Examples of the amino components include melamine, urea, benzoguanamine, acetoguanamine, steroguanamine, spiroguanamine, dicyandiamide, and the like. Examples of the aldehyde components include formaldehyde, paraformaldehyde, acetaldehyde, benzaldehyde, and the like.

Also usable are products obtained by partially or fully etherifying, with suitable alcohols, the methylol groups of partially or fully methylolated amino resins. Examples of alcohols that can be used for etherification include methyl alcohol, ethyl alcohol, n-propyl alcohol, i-propyl alcohol, n-butyl alcohol, i-butyl alcohol, 2-ethyl-1-butanol, 2-ethyl-1-hexanol, and the like.

The amino resin (B3) is preferably a melamine resin (B3-1). Examples of the melamine resin (B3-1) include alkyl-etherified melamine resins, which are obtained by partially or fully etherifying, with suitable alcohols, methylol groups of partially or fully methylolated melamine resins.

Examples of alkyl-etherified melamine resins preferably used include methyl etherified melamine resins obtained by partially or fully etherifying, with methyl alcohol, methylol groups of partially or fully methylolated melamine resins; butyl-etherified melamine resins obtained by partially or fully etherifying, with butyl alcohol, methylol groups of partially or fully methylolated melamine resins; and methyl-butyl mixed etherified melamine resins obtained by partially or fully etherifying, with methyl alcohol and butyl alcohol, methylol groups of partially or fully methylolated melamine resins. Among these, methyl etherified melamine resins and methyl-butyl mixed etherified melamine resins are preferable, and methyl-butyl mixed etherified melamine resins are particularly preferable from the viewpoint of the smoothness, distinctness of image, water resistance, etc., of the resulting multilayer coating film.

From the viewpoint of the smoothness, distinctness of image, water resistance, etc., of the resulting multilayer coating film, the methyl-butyl mixed etherified melamine resin preferably has a methoxy/butoxy molar ratio in the range of 90/10 to 50/50, and preferably 80/20 to 60/40.

The melamine resin (B3-1) preferably has a weight average molecular weight of 400 to 6,000, preferably 500 to 4,000, and even more preferably 600 to 2,000.

Commercially available products can be used as the melamine resin (B3-1). Trade names of commercial products of such melamine resins include, for example, “Cymel 202”, “Cymel 203”, “Cymel 204”, “Cymel 211”, “Cymel 238”, “Cymel 251”, “Cymel 303”, “Cymel 323”, “Cymel 324”, “Cymel 325”, “Cymel 327”, “Cymel 350”, “Cymel 385”, “Cymel 1156”, “Cymel 1158”, “Cymel 1116”, “Cymel 1130” (products of Nihon Cytec Industries Inc.); and “U-Van 120”, “U-Van 20HS”, “U-Van 20SE60”, “U-Van 2021”, “U-Van 2028”, “U-Van 28-60” (products of Mitsui Chemicals, Inc.); and the like.

When the aqueous intermediate coating composition (X) contains the melamine resin (B3-1), a catalyst can be used. Examples of usable catalysts include sulfonic acids such as p-toluenesulfonic acid, dodecylbenzenesulfonic acid, and dinonylnaphthalene sulfonic acid; and salts obtained by neutralizing such sulfonic acids with amines; salts obtained by neutralizing phosphoric ester compounds with amines; and the like.

### 1.4 Diester Compound (C)

The diester compound (C) is represented by formula (1):

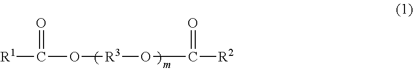

(wherein R¹ and R² are each independently a hydrocarbon group having 4 to 18 carbon atoms, R³ is an alkylene group having 2 to 4 carbon atoms, m is an integer of 3 to 25, and m oxyalkylene units (R³—O) may be the same or different).

From the viewpoint of the smoothness, distinctness of image, water resistance, flip-flop effect, and suppression of metallic mottling of the resulting coating film, the carbon number of each of R¹ and R² in Formula (1) is preferably 4 to 18, more preferably 5 to 11, even more preferably 5 to 9, and still more preferably 6 to 8. R¹ and R² are preferably straight- or branched-chain alkyl groups, and more preferably branched-chain alkyl groups. It is particularly preferable that R¹ and R² be C₆₋₈ branched-chain alkyl groups. When R¹ and R² are branched-chain alkyl groups, the composition of the present invention is capable of forming a multilayer coating film having excellent appearance in which the smoothness and flip-flop effect are excellent and metallic mottling is suppressed, even if the composition is applied after relatively long-term storage.

From the viewpoint of the smoothness, distinctness of image, flip-flop effect, and suppression of metallic mottling, of the resulting multilayer coating film, R³ in the above Formula (1) is preferably a C₂ or C₃ alkylene group, and more preferably a C₂ alkylene group (ethylene group). From the viewpoint of the smoothness, distinctness of image, water resistance, flip-flop effect, and suppression of metallic mottling, m in Formula (1) is preferably 4 to 12, and more preferably 6 to 9.

The diester compound (C) has a molecular weight of preferably about 320 to about 1,400, more preferably about 450 to about 1,000, even more preferably about 500 to about 800, and still more preferably about 500 to about 700.

The diester compound (C) is preferably a diester compound of a polyoxyalkylene glycol with an aliphatic monocarboxylic acid. Specifically, the diester compound (C) can be obtained by, for example, an esterification reaction of a polyoxyalkylene glycol having two terminal hydroxy groups with a monocarboxylic acid having a C₄₋₁₈ hydrocarbon group.

Examples of the polyoxyalkylene glycol include polyethylene glycol, polypropylene glycol, copolymers of polyethylene and propylene glycol, polybutylene glycol, etc. Among these, it is particularly preferable to use polyethylene glycol. The polyoxyalkylene glycol has a number average molecular weight of preferably about 100 to about 1,200, more preferably about 150 to about 600, and even more preferably about 200 to about 400.

Examples of the monocarboxylic acid having a C₄₋₁₈ hydrocarbon group include pentanoic acid, hexanoic acid, 2-ethylbutanoic acid, 3-methylpentanoic acid, benzoic acid, cyclohexanecarboxylic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid, 4-ethyloctanoic acid, dodecanoic acid, hexadecanoic acid, octadecanoic acid, and the like. Among these, monocarboxylic acids having C₅₋₉ alkyl groups, such as hexanoic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid, and 4-ethyloctanoic acid, are preferable; monocarboxylic acids having C₆₋₈ alkyl groups, such as heptanoic acid, 2-ethylpentanoic acid, 3-ethylpentanoic acid, octanoic acid, 2-ethylhexanoic acid, 4-ethylhexanoic acid, nonanoic acid, and 2-ethylheptanoic acid, are more preferable; and monocarboxylic acid having C₆₋₈ branched-chain alkyl groups, such as 2-ethylpentanoic acid, 3-ethylpentanoic acid, 2-ethylhexanoic acid, 4-ethylhexanoic acid, and 2-ethylheptanoic acid, are still more preferable.

These polyoxyalkylene glycols and monocarboxylic acids can be used singly or in a combination of two or more.

The diesterification reaction of the polyoxyalkylene glycol with the monocarboxylic acid having a C₄₋₁₈ hydrocarbon group can be carried out by a known method.

A multilayer coating film with excellent smoothness and high distinctness of image can be formed by using the aqueous intermediate coating composition (X) containing a base resin (A), a curing agent (B), and a diester compound (C) in a 3-coat 1-bake process comprising successively applying an aqueous intermediate coating composition, an aqueous base coating composition, and a clear coating composition and simultaneously heat-curing the resulting three coating layers to form a multilayer coating film. This is presumably for the following reason.

Application of the aqueous intermediate coating composition (X) containing a diester compound (C) forms an intermediate coating layer having appropriate hydrophilicity. Accordingly, the aqueous base coating composition (Y) applied to the intermediate coating layer uniformly spreads in a wet state over the intermediate coating layer, thus forming a multilayer coating film with excellent smoothness. Moreover, curing of the intermediate coating layer, which occurs in a relatively early stage of the heating step due to a relatively high reactivity between the base resin (A) and the curing agent (B) in the aqueous intermediate coating composition (X), inhibits the formation of a mixed layer of the intermediate coating with the aqueous base coating composition (Y) used to form an upper layer, thus enhancing the distinctness of image; furthermore, the presence of the diester compound (C) diminishes the reduction of thermal flowability of the coating caused by a rapid curing reaction between the base resin (A) and the curing agent (B), thus proving a multilayer coating film with excellent smoothness.

### 1.5 Aqueous Intermediate Coating Composition (X)

The aqueous intermediate coating composition (X) used in the method for forming a multilayer coating film of the present invention is an aqueous coating composition comprising a base resin (A), a curing agent (B) (a polyisocyanate compound (B1) and/or a polycarbodiimide compound (B2)), and a diester compound (C).

The “aqueous coating composition” as used herein is a term used in contrast with an “organic solvent-based coating composition”, and generally means a coating composition produced by dispersing or dissolving a coating film-forming resin, a pigment, etc., in water or in a medium mainly consisting of water (aqueous medium). The amount of water in the aqueous intermediate coating composition (X) is preferably about 10 to about 90 mass %, more preferably about 20 to about 80 mass %, and even more preferably about 30 to about 60 mass %.

The proportions of the base resin (A), curing agent (B), and diester compound (C) in the aqueous intermediate coating composition (X) are preferably within the following ranges, based on 100 parts by mass of the total solids content of the base resin (A) and the curing agent (B):

the amount of base resin (A) is 30 to 95 parts by mass, more preferably 50 to 90 parts by mass, and even more preferably 60 to 85 parts by mass;
the amount of curing agent (B) is 5 to 70 parts by mass, more preferably 10 to 50 parts by mass, and even more preferably 15 to 40 parts by mass; and
the amount of diester compound (C) is 1 to 30 parts by mass, more preferably 3 to 20 parts by mass, and even more preferably 5 to 15 parts by mass.

The above proportions can be used for any of the following combinations of the components:
(1) a combination wherein the base resin (A) is a hydroxy-containing resin (A1) and the curing agent (B) is a polyisocyanate compound (B1);
(2) a combination wherein the base resin (A) is a carboxy-containing resin (A2) and the curing agent (B) is a polycarbodiimide compound (B2);
(3) a combination wherein the base resin (A) is a carboxy- and hydroxy-containing resin (A3) and the curing agent (B) is a polyisocyanate compound (B1) and/or polycarbodiimide compound (B2); and
(4) a combination wherein the base resin (A) is a carboxy- and hydroxy-containing resin (A3) and the curing agent (B) is a polycarbodiimide compound (B2) and an amino resin (B3).

Various compositions described below comprise base resin (A) and curing agent (B) as basic components. The combination of base resin (A) and curing agent (B) in the compositions below can be selected from the combinations of base resin (A) and curing agent (B) shown above in (1) to (4).

From the viewpoint of the smoothness, distinctness of image, water resistance, chipping resistance, etc. of the resulting multilayer coating film, the aqueous intermediate coating composition (X) of the present invention preferably contains a carboxy- and hydroxy-containing resin (A3) as the base resin (A), and an amino resin as the curing agent (B). Examples of the amino resin are the same as mentioned above.

When the aqueous intermediate coating composition (X) contains a carboxy- and hydroxy-containing resin (A3) and a melamine resin (B3-1), the proportions of the carboxy- and hydroxy-containing resin (A3), polycarbodiimide compound (B2), diester compound (C), and melamine resin (B3-1) in the composition (X) are preferably within the following ranges, per 100 parts by mass of the total amount of carboxy- and hydroxy-containing resin (A3) and the polycarbodiimide compound (B2), on a solids basis:

the amount of carboxy- and hydroxy-containing resin (A3) is 30 to 95 parts by mass, preferably 50 to 90 parts by mass, and more preferably 60 to 85 parts by mass;
the amount of polycarbodiimide compound (B2) is 5 to 70 parts by mass, preferably 10 to 50 parts by mass, and even more preferably 15 to 40 parts by mass;
the amount of diester compound (C) is 1 to 30 parts by mass, preferably 3 to 20 parts by mass, and even more preferably 5 to 15 parts by mass; and
the amount of melamine resin (B3-1) is 5 to 70 parts by mass, preferably 10 to 50 parts by mass, and even more preferably 15 to 40 parts by mass.

The aqueous intermediate coating composition (X) may contain, in addition to the base resin (A), a resin for modification that is substantially free of hydroxy groups and/or carboxy groups. Examples of the resin for modification include water soluble- or water dispersible-, polyurethane resins, polyester resins, acrylic resins, alkyd resins, silicon resins, fluororesins, epoxy resins, and the like.

When the aqueous intermediate coating composition (X) contains such a resin for modification, the amount of the resin for modification is typically 1 to 50 parts by mass, preferably 3 to 40 parts by mass, and even more preferably 5 to 30 parts by mass, per 100 parts by mass of the total amount of base resin (A) and curing agent (B), on a solids basis.

From the viewpoint of the chipping resistance, it is preferable to use a polyurethane resin as the resin for modification. Examples of the polyurethane resin include a resin prepared as follows: a urethane prepolymer is produced by reacting at least one diol selected from the group consisting of polyetherdiols, polyesterdiols and polycarbonate diols, a low-molecular-weight polyhydroxy compound and dimethanol alkanoic acid with aliphatic and/or alicyclic diisocyanates; the urethane prepolymer is neutralized with a tertiary amine and emulsified and dispersed in water; and if necessary, the resulting emulsion is mixed with an aqueous medium containing a chain extender such as a polyamine, a crosslinking agent, and/or a terminator, to perform a reaction until substantially no isocyanate group remains. The above method usually yields a self-emulsifiable urethane emulsion with a mean particle diameter of about 0.001 to about 3 μm. Examples of commercial products of the urethane resin include “U-Coat UX-5000” and “U-Coat UX-8100” (trade names, products of Sanyo Chemical Industries, Ltd.), etc.

When the aqueous intermediate coating composition (X) contains a polyurethane resin as mentioned above, the amount of polyurethane resin is generally 1 to 50 parts by mass, preferably 3 to 40 parts by mass, and more preferably 5 to 30 parts by mass, per 100 parts by mass of the total amount of base resin (A) and curing agent (B) in the aqueous intermediate coating composition (X), on a solids basis.

When the hydroxy-containing resin (A1) and/or the resin for modification in the aqueous intermediate coating composition (X) of the present invention has one or more reactive functional groups other than hydroxy groups, the composition (X) may contain a compound that is reactive with the reactive functional groups. More specifically, for example, when the hydroxy-containing resin (A1) and/or the resin for modification has a carboxy group, the aqueous intermediate coating composition (X) may contain a carbodiimide group-containing compound.

Examples of the carbodiimide group-containing compound include those obtained by subjecting isocyanate groups of the isocyanate group-containing compound (B1) to a carbon dioxide removal reaction with each other. The polycarbodiimide compound (B2) can also be preferably used. Commercially available products can also be used as the carbodiimide group-containing compound. Examples of commercial products of such carbodiimide group-containing compounds include “Carbodilite SV-02”, “Carbodilite V-02”, “Carbodilite V-02-L2”, “Carbodilite V-04”, “Carbodilite E-01”, and “Carbodilite E-02” (products of Nisshinbo Industries, Inc., trade names), etc.

When the carboxy-containing resin (A2) and/or the resin for modification in the aqueous intermediate coating composition (X) of the present invention have one or more reactive functional groups other than carboxy groups, the composition (X) may contain a compound that is reactive with the reactive functional groups. More specifically, for example, when the carboxy-containing resin (A2) and/or the resin for modification has a hydroxy group, the aqueous intermediate coating composition (X) may contain an amino resin, a polyisocyanate compound, a blocked polyisocyanate compound, etc.

Examples of the amino resin and the polyisocyanate compound include those mentioned above.

The blocked polyisocyanate compound is a compound having at least two isocyanate groups per molecule wherein the isocyanate groups are blocked by a blocking agent.

Examples of the blocking agent include phenol compounds such as phenol, cresol, xylenol, nitrophenol, ethylphenol, hydroxydiphenyl, butylphenol, isopropylphenol, nonylphenol, octylphenol, and methyl hydroxybenzonate; lactam compounds such as ε-caprolactam, δ-valerolactam, γ-butyrolactam, and β-propiolactam; aliphatic alcohol compounds such as methanol, ethanol, propyl alcohol, butyl alcohol, amyl alcohol, and lauryl alcohol; ether compounds such as ethylene glycol monomethyl ether, ethylene glycol monoethyl ether, ethylene glycol monobutyl ether, diethylene glycol monomethyl ether, diethylene glycol monoethyl ether, propylene glycol monomethyl ether, and methoxymethanol; alcohol compounds such as benzyl alcohol, glycolic acid, methyl glycolate, ethyl glycolate, butyl glycolate, lactic acid, methyl lactate, ethyl lactate, butyl lactate, methylol urea, methylol melamine, diacetone alcohol, 2-hydroxyethyl acrylate, and 2-hydroxyethyl methacrylate; oxime compounds such as formamidoxime, acetamidooxime, acetoxime, methyl ethyl ketoxime, diacetylmonoxime, benzophenone oxime, and cyclohexane oxime; active methylene compounds such as dimethyl malonate, diethyl malonate, ethyl acetoacetate, methyl acetoacetate, and acetylacetone; mercaptan compounds such as butyl mercaptan, t-butyl mercaptan, hexyl mercaptan, t-dodecyl mercaptan, 2-mercapto benzo thiazole, thiophenol, methylthiophenol, and ethylthiophenol; acid amide compounds such as acetanilide, acetanisidide, acetotoluide, acrylamide, methacrylamide, acetamide, stearic acid amide, and benzamide; imide compounds such as succinimide, phthalimide, and maleinimide; amine compounds such as diphenylamine, phenylnaphthylamine, xylidine, N-phenylxylidine, carbazole, aniline, naphthylamine, butylamine, dibutylamine, and butylphenyl amine; imidazole compounds such as imidazole and 2-ethylimidazole; urea compounds such as urea, thiourea, ethyleneurea, ethylenetiourea, and diphenylurea; carbamate compounds such as phenyl N-phenylcarbamate; imine compounds such as ethyleneimine and propyleneimine; sulfite compounds such as sodium bisulfite and potassium bisulfite; azole compounds; and the like. Examples of such azole compounds include pyrazole or pyrazole derivatives such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, and 3-methyl-5-phenylpyrazole; imidazole or imidazole derivatives such as imidazole, benzimidazole, 2-methylimidazole, 2-ethylimidazole, and 2-phenylimidazole; imidazoline derivatives such as 2-methylimidazoline and 2-phenylimidazoline; and the like.

### 1.5.1 Pigment (D)

The aqueous intermediate coating composition (X) preferably contains a pigment (D). Examples of the pigment (D) include coloring pigments (D1), extender pigments (D2), luster pigments (D3), and the like. Such pigments can be used singly or in a combination of two or more.

When the aqueous intermediate coating composition (X) contains a pigment (D), the amount of pigment (D) in the aqueous intermediate coating composition (X) is generally 1 to 200 parts by mass, preferably 20 to 150 parts by mass, and more preferably 50 to 120 parts by mass, per 100 parts by mass of the total amount of base resin (A) and curing agent (B), on a solids basis.

It is particularly preferable that the aqueous intermediate coating composition (X) contains a coloring pigment (D1) and/or an extender pigment (D2) in such an amount that the total amount of coloring pigment (D1) and extender pigment (D2) is 40 to 180 parts by mass, preferably 50 to 160 parts by mass, and more preferably 60 to 140 parts by mass, per 100 parts by mass of the total amount of base resin (A) and curing agent (B) in the aqueous intermediate coating composition (X), on a solids basis.

Examples of the coloring pigment (D1) include titanium oxide, zinc flower, carbon black, molybdenum red, Prussian blue, cobalt blue, azo pigments, phthalocyanine pigments, quinacridone pigments, isoindoline pigments, threne pigments, perylene pigments, dioxazine pigments, diketopyrrolopyrrole pigments, and the like. Among these, titanium oxide and carbon black are preferable.

When the aqueous intermediate coating composition (X) contains a coloring pigment (D1) as described above, the amount of coloring pigment (D1) is typically 1 to 180 parts by mass, preferably 3 to 160 parts by mass, and even more preferably 5 to 140 parts by mass, per 100 parts by mass of the total amount of base resin (A) and curing agent (B) in the aqueous intermediate coating composition (X), on a solids basis.

Examples of the extender pigment (D2) include clay, kaolin, barium sulfate, barium carbonate, calcium carbonate, talc, silica, alumina white, etc. Among these, barium sulfate and talc are preferable.

It is particularly preferable to use, as the extender pigment (D2), barium sulfate having a mean primary particle diameter of 1 μm or less, more preferably 0.01 to 0.8 μm. The aqueous intermediate coating composition (X) containing such barium sulfate as the extender pigment (D2) can form a multilayer coating film that has an excellent appearance with excellent smoothness, and also with a high flip-flop effect and little metallic mottling, when the aqueous base coating composition (Y) described below contains a luster pigment (D3).

The mean primary particle diameter of barium sulfate as used herein is determined by observing barium sulfate using a scanning electron microscope and averaging the maximum diameters of 20 barium sulfate particles on a straight line drawn at random on the electron microscope photograph.

When the aqueous intermediate coating composition (X) contains an extender pigment (D2) as described above, the amount of extender pigment (D2) is typically 1 to 150 parts by mass, preferably 5 to 130 parts by mass, and even more preferably 10 to 110 parts by mass, per 100 parts by mass of the total amount of base resin (A) and curing agent (B) in the aqueous intermediate coating composition (X), on a solids basis.

Examples of the luster pigment (D3) include aluminium (which may be vapor-deposited aluminum), copper, zinc, brass, nickel, aluminium oxide, mica, titanium oxide-coated or iron oxide-coated aluminium oxide, titanium oxide-coated or iron oxide-coated mica, glass flakes, holographic pigments, etc. Such luster pigments (D3) can be used singly or in a combination of two or more. Examples of the aluminum pigment include leafing aluminum pigments and non-leafing aluminum pigments. Any of the pigments can be used.

When the aqueous intermediate coating composition (X) contains a luster pigment (D3) as described above, the amount of luster pigment (D3) is typically 1 to 50 parts by mass, preferably 2 to 30 parts by mass, and even more preferably 3 to 20 parts by mass, per 100 parts by mass of the total amount of base resin (A) and curing agent (B) in the aqueous intermediate coating composition (X), on a solids basis.

### 1.5.2 Hydrophobic Solvent (E)

From the viewpoint of improving the smoothness and distinctness of image, the aqueous intermediate coating composition (X) preferably further contains a hydrophobic solvent (E).

The hydrophobic solvent (E) is desirably an organic solvent of which a mass of 10 g or less dissolves in 100 g of water at 20° C., preferably 5 g or less, and more preferably 1 g or less. Examples of the organic solvent include hydrocarbon solvents such as rubber solvents, mineral spirits, toluene, xylene, and solvent naphtha; alcoholic solvents such as 1-hexanol, 1-octanol, 2-octanol, 2-ethyl-1-hexanol, 1-decanol, benzyl alcohol, ethylene glycol mono-2-ethylhexyl ether, propylene glycol mono-n-butyl ether, dipropylene glycol mono-n-butyl ether, tripropylene glycol mono-n-butyl ether, propylene glycol mono-2-ethylhexyl ether, and propylene glycol monophenyl ether; ester solvents such as n-butyl acetate, isobutyl acetate, isoamyl acetate, methylamyl acetate, and ethylene glycol monobutyl ether acetate; ketone solvents such as methyl isobutyl ketone, cyclohexanone, ethyl n-amyl ketone, and diisobutyl ketone; and the like. Such solvents can be used singly or in a combination of two or more.

From the viewpoint of the smoothness of the resulting coating film, it is preferable to use alcohol hydrophobic solvents as the hydrophobic solvent (E). Among these, C₇₋₁₄ hydrophobic alcoholic solvents are preferable, and it is particularly preferable to use at least one hydrophobic alcoholic solvent selected from the group consisting of 1-octanol, 2-octanol, 2-ethyl-1-hexanol, ethylene glycol mono-2-ethylhexyl ether, propylene glycol mono-n-butyl ether, and dipropylene glycol mono-n-butyl ether.

When the aqueous intermediate coating composition (X) contains a hydrophobic solvent (E) as mentioned above, the amount of hydrophobic solvent (E) is preferably 2 to 50 parts by mass, more preferably 5 to 40 parts by mass, and even more preferably 8 to 30 parts by mass, per 100 parts by mass of the total amount of base resin (A), curing agent (B), and diester compound (C), on a solids basis.

### 1.5.3 Curing Catalyst

The aqueous intermediate coating composition (X) may further contain a curing catalyst. Examples of the curing catalyst include organometallic compounds such as tin octylate, dibutyltin di(2-ethylhexanoate), dioctyltin di(2-ethylhexanoate), dioctyltin diacetate, dibutyltin dilaurate, dibutyltin oxide, dioctyltin oxide, dibutyltin fatty acid salt, lead 2-ethylhexanoate, zinc octylate, zinc naphthenate, zinc fatty acid salts, cobalt naphthenate, calcium octylate, copper naphthenate, and tetra(2-ethylhexyl)titanate; tertiary amine; phosphoric acid compounds; and the like. Such compounds can be used singly or in a combination of two or more.

When the aqueous intermediate coating composition (X) contains a curing catalyst as mentioned above, the amount of curing catalyst is usually 0.001 to 5 parts by mass, preferably 0.01 to 0.5 parts by mass, and more preferably 0.05 to 0.3 parts by mass, per 100 parts by mass of the total amount of base resin (A) and curing agent (B) in the aqueous intermediate coating composition (X), on a solids basis.

### 1.5.4 Other Additives for Coating Composition

If necessary, the aqueous intermediate coating composition (X) may contain additives for coating compositions, such as thickening agents, UV absorbers, light stabilizers, antifoaming agents, plasticizers, organic solvents other than the above hydrophobic solvents (E), surface control agents, antisettling agents, etc.

Examples of thickening agents include inorganic thickening agents such as silicate, metal silicate, montmorillonite, colloidal alumina, etc.; polyacrylic acid thickening agents such as copolymers of (meth)acrylic acid and (meth)acrylic ester, sodium polyacrylate, etc.; associative thickening agents having a hydrophilic moiety and a hydrophobic moiety per molecule, and which, in aqueous medium, effectively improve the viscosity by adsorption of the hydrophobic moiety on the surface of pigments or emulsion particles in a coating composition, or by association between hydrophobic moieties; cellulose derivative thickening agents such as carboxymethylcellulose, methylcellulose, hydroxyethylcellulose, etc.; protein thickening agents such as casein, sodium caseinate, ammonium caseinate, etc.; alginate thickening agents such as sodium alginate, etc.; polyvinyl thickening agents such as polyvinyl alcohol, polyvinylpyrrolidone, polyvinyl benzyl ether copolymers, etc.; polyether thickening agents such as pluronic polyether, polyether dialkyl ester, polyether dialkyl ether, polyether epoxy-modified products, etc.; maleic anhydride copolymer thickening agents such as partial esters of a copolymer of vinyl methyl ether and maleic anhydride, etc.; polyamide thickening agents such as polyamide amine salts, etc.; and the like. Such thickening agents can be used singly or in a combination of two or more.

Examples of usable polyacrylic acid thickening agents include commercially available products, which are available, for example, under the tradenames “PRIMAL ASE-60”, “PRIMAL TT-615”, and “PRIMAL RM-5”, manufactured by Rohm and Haas; “SN Thickener 613”, “SN Thickener 618”, “SN Thickener 630”, “SN Thickener 634”, and “SN Thickener 636”, manufactured by San Nopco Ltd.; and the like. Examples of usable associative thickening agents include commercially available products, which are available, for example, under the tradenames “UH-420”, “UH-450”, “UH-462”, “UH-472”, “UH-540”, “UH-752”, “UH-756VF”, and “UH-814N”, manufactured by ADEKA Co. Ltd.; “PRIMAL RM-8W”, “PRIMAL RM-825”, “PRIMAL RM-2020NPR”, “PRIMAL RM-12W”, and “PRIMAL SCT-275”, manufactured by Rohm and Haas; “SN Thickener 612”, “SN Thickener 621N”, “SN Thickener 625N”, “SN Thickener 627N”, and “SN Thickener 660T”, manufactured by San Nopco Ltd.; and the like.

As a thickening agent, it is preferable to use a polyacrylic acid thickening agent and/or an associative thickening agent, more preferably an associative thickening agent, and still more preferably a urethane associative thickening agent bearing a hydrophobic group at its end(s) and having a urethane bond in a molecular chain. Examples of usable urethane associative thickening agents include commercially available products, which are available, for example, under the tradenames “UH-420”, “UH-462”, “UH-472”, “UH-540”, “UH-752”, “UH-756VF”, and “UH-814N”, manufactured by ADEKA Co. Ltd.; “SN thickener 612”, “SN thickener 621N”, “SN thickener 625N”, “SN thickener 627N”, and “SN thickener 660T”, manufactured by San Nopco Ltd.; and the like.

When the aqueous intermediate coating composition (X) comprises a thickening agent as described above, the amount thereof is preferably about 0.01 to about 10 parts by mass, more preferably about 0.02 to about 3 parts by mass, and still more preferably about 0.03 to about 2 parts by mass, per 100 parts by mass of the total solids content of the base resin (A), curing agent (B) and diester compound (C).

The aqueous intermediate coating composition (X) can be prepared by mixing and dispersing, in an aqueous medium, a base resin (A), a curing agent (B), and a diester compound (C), together with, if necessary, a melamine resin (B3-1), a pigment (D), a hydrophobic solvent (E), and other additives for coating compositions, using a known method. Examples of usable aqueous media include deionized water, and a mixture of deionized water and hydrophilic organic solvent. Examples of hydrophilic organic solvents include propylene glycol monomethyl ether etc.

It is usually preferable that the solids content of the aqueous intermediate coating composition (X) be about 30 to about 80 mass %, more preferably about 40 to about 70 mass %, and still more preferably about 45 to about 60 mass %.

The aqueous intermediate coating composition (X) according to the present invention may be a single-component coating composition, or a multi-component coating composition; however, the following two-component coating compositions are preferable in view of storage stability etc.

1) A two-component coating composition consisting of a main agent (X1) that contains a hydroxy-containing resin (A1) and a diester compound (C), and a curing agent (X2) that contains a polyisocyanate compound (B1). It is usually preferable that the main agent (X1) further contain a pigment, a curing catalyst, and water, and that the curing agent (X2) further contain a solvent.

2) It is preferable to form a two-component coating composition consisting of a main agent (X1) that contains a carboxy-containing resin (A2) and a diester compound (C), and a curing agent (X2) that contains a polycarbodiimide compound (B2). It is generally desirable that the main agent (X1) further contain a pigment, a curing catalyst, and water, and that the curing agent (X2) further contain water. The curing agent (X2) may further contain a surfactant.

The curing agent (X2) may further contain a surfactant. Preferable as the surfactant are anionic surfactants and/or nonionic surfactants; anionic surfactants are more preferable. When the curing agent (X2) contains a surfactant, the polyisocyanate compound (B1) is dispersed in an aqueous intermediate coating composition (X) in a relatively uniform manner while mixing the main agent (X1) and the curing agent (X2). This allows the intermediate coating layer to cure uniformly, thereby forming a coating film with excellent smoothness and distinctness of image.

From the viewpoint of the smoothness, distinctness of image, flip-flop effect, decrease in metallic mottling, etc. of the resulting coating film, it is preferable that the aqueous intermediate coating composition (X) according to the present invention be applied to a cured film thickness of 30 μm, and have a gel fraction (G₈₀) of generally about 5 to about 100 mass %, preferably about 10 to about 95 mass %, more preferably about 15 to about 95 mass %, and even more preferably about 30 to about 90 mass %, after being heated at 80° C. for 10 minutes.

The gel fraction (G₈₀) can be calculated according to the following method:

First, the aqueous intermediate coating composition (X) is applied to a polypropylene plate to a cured film thickness of 30 μm, and then heated at 80° C. for 10 minutes. The intermediate coating layer over the polypropylene plate is collected to measure the mass (Wₐ). The layer is then placed into a stainless steel container with a 300-mesh sieve, extracted for 5 hours in a solvent mixture containing an equivalent amount of acetone and methanol that has been heated to 64° C., and then dried at 110° C. for 60 minutes. The mass (W_{b}) of the resulting coating layer is then measured. The remaining ratio (mass %) of the insoluble coating layer is calculated according to the following formula and is referred to as a gel fraction (G₈₀).

Gel fraction (G₈₀) mass %=(W_{b}/Wₐ)×100

The gel fraction (G₈₀) of the coating composition of the present invention can be determined by adjusting the proportion of the curing catalyst in the coating composition.

The aqueous intermediate coating composition (X) can be applied on the substrate using known methods such as air spray coating, airless spray coating, rotary atomization coating, curtain coating, etc. An electrostatic charge may be applied during coating. Among these, air spray coating and rotary atomization coating are preferable.

It is preferable that the aqueous intermediate coating composition (X) be applied in such a manner that the cured film thickness becomes usually about 5 to about 70 μm, preferably about 10 to about 50 μm, and more preferably about 15 to about 40 μm.

### 2. Step (2)

Subsequently, the aqueous base coating composition (Y) is applied to the layer of the aqueous intermediate coating composition (X) (hereinafter sometimes referred to as “intermediate coating film”) formed in Step (1).

It is preferable to perform, prior to the application of the aqueous base coating composition (Y), preheating, air blowing, etc. on the intermediate coating film under conditions in which the coating film does not substantially cure.

In the present invention, a cured coating film indicates a film in a dry hard condition according to JIS K 5600-1-1, i.e., a condition in which an imprint due to a fingerprint is not formed on the coating surface and no movement is detected on the coated film when the center of the surface is strongly pinched with a thumb and an index finger, or in which a scrape is unobservable on the coating surface when the center of the surface is rubbed repeatedly with a fingertip; the uncured coating film indicates a film that has not yet reached a dry hard condition, including a film in a set to touch condition and a film in a dry to touch condition according to JIS K 5600-1-1.

The preheating temperature is preferably about 40 to about 100° C., more preferably about 50 to about 90° C., and still more preferably about 60 to about 80° C. The preheating time is preferably about 30 seconds to about 15 minutes, more preferably about 1 to about 10 minutes, and still more preferably about 2 to about 5 minutes. Air blowing can usually be performed by blowing room temperature air or air heated to about 25 to about 80° C. over the coated surface of the substrate for about 30 seconds to about 15 minutes.

It is preferable to adjust the solids content of the intermediate coating film to generally about 60 to about 100 mass %, preferably about 80 to about 100 mass %, and more preferably about 90 to about 100 mass % by means of preheating, air blowing, etc., prior to the application of the aqueous base coating composition (Y).

It is further preferable to adjust the gel fraction of the coating film to the range described below.

When the aqueous intermediate coating composition (X) contains a hydroxy-containing resin (A1) and/or a hydroxy- and carboxy-containing resin (A3), a polyisocyanate compound (B1), and a diester compound (C), it is preferable to adjust the gel fraction of the coating film to within the range of generally about 1 to about 95 mass %, preferably about 15 to about 92 mass %, and more preferably about 20 to 90 mass %.

When the aqueous intermediate coating composition (X) contains a carboxy-containing resin (A2) and/or a hydroxy- and carboxy-containing resin (A3), a polycarbodiimide compound (B2) and a diester compound (C), it is preferable to adjust the gel fraction of the coating film to within the range of generally about 1 to about 95 mass %, preferably about 5 to 90 mass %, and more preferably about 10 to about 85 mass %.

The solids content of the coating film is calculated according to the following method:

First, an aqueous intermediate coating composition (X) is applied to the substrate. The aqueous intermediate coating composition (X) is also applied to an aluminum foil whose content (W₁) is previously measured. The aluminum foil is subjected to preheating and like treatment after application, and then collected just before the application of the aqueous base coating composition (Y). The content thereof (W₂) is measured. Subsequently, the collected aluminum foil is dried at 110° C. for 60 minutes and allowed to cool to room temperature in a desiccator, thereby obtaining the mass (W₃) of the aluminum foil. The solids content is then measured according to the following formula.

Solids content mass %={(W₃−W₁)/(W₂−W₁)}×100

The gel fraction of the coating film can be calculated according to the following method:

First, an aqueous intermediate coating composition (X) is applied to a substrate. The aqueous intermediate coating composition (X) is also applied to a polypropylene plate, and preheated. The polypropylene plate that is subjected to preheating and like treatment after application is collected just before the application of the aqueous base coating composition (Y). The intermediate coating film on the polypropylene plate is then collected to measure its mass (W_{C}). The film is placed into a stainless steel container with a 300-mesh sieve, extracted for 5 hours in a solvent mixture containing an equivalent amount of acetone and methanol that has been heated to 64° C., and then dried at 110° C. for 60 minutes. The mass (W_{d}) of the resulting coating film is then measured. The remaining ratio (mass %) of the insoluble coating film is calculated according to the following formula, and is referred to as a gel fraction.

Gel fraction mass %=(W_{d}/W_{c})×100

The aqueous base coating composition (Y) applied on the intermediate coating film is generally intended to impart an excellent appearance to a substrate. For example, a coating composition obtained by dissolving or dispersing, in water, a resin component comprising a base resin and a curing agent, together with pigments and other additives.

Examples of the base resin include acrylic resins, polyester resins, alkyd resins, urethane resins, epoxy resins, etc., all containing crosslinkable functional groups such as carboxy groups, hydroxy groups, etc. Examples of the curing agent include blocked or unblocked polyisocyanate compounds, melamine resins, urea resins, etc. Among these, a thermosetting aqueous coating composition containing the hydroxy-containing resin (A1) as a base resin and the melamine resin (B3-1) as a curing agent, and a thermosetting aqueous coating composition containing the carboxy- and hydroxy-containing resin (A3) as a base resin and the melamine resin (B3-1) as a curing agent can be advantageously used in view of the appearance, water-resistance, etc. of the resulting multilayer coating film.

The coloring pigment (D1), extender pigment (D2), luster pigment (D3), etc., can be used as the above-mentioned pigment. It is particularly preferable that the aqueous base coating composition (Y) contain the coloring pigment and/or luster pigment (D3) as at least one of the pigments described above.

Examples of the coloring pigment (D1) include titanium oxide, zinc flower, carbon black, molybdenum red, Prussian blue, cobalt blue, azo pigments, phthalocyanine pigments, quinacridone pigments, isoindoline pigments, threne pigments, perylene pigments, dioxazine pigments, diketo-pyrrolo-pyrrole pigments, etc. as mentioned in the description of the aqueous intermediate coating composition (X).

When the aqueous base coating composition (Y) includes the coloring pigment (D1), the amount of the coloring pigment (D1) is preferably about 1 to about 150 parts by mass, more preferably about 3 to about 130 parts by mass, and even more preferably about 5 to about 110 parts by mass, per 100 parts by mass of the resin solids content in the aqueous base coating composition (Y).

Examples of the luster pigment (D3) include aluminum (including vapor-deposited aluminum), copper, zinc, brass, nickel, aluminum oxide, mica, titanium oxide-coated or iron oxide-coated aluminum oxide, titanium oxide-coated or iron oxide-coated mica, glassflakes, hologram pigment, etc., as mentioned in the description of the aqueous intermediate coating composition (X). Among these, aluminum, aluminum oxide, mica, titanium oxide- or iron oxide-coated aluminum oxide, and titanium oxide-coated or iron oxide-coated mica are more preferable, and aluminum is even more preferable. Such luster pigments (D3) can be used singly or in a combination of two or more.

The luster pigment (D3) is preferably in the form of flakes. More specifically, the preferable luster pigment (D3) has a longitudinal dimension of about 1 to about 100 μm, and preferably about 5 to about 40 μm, and a thickness of about 0.001 to about 5 μm, and preferably about 0.01 to about 2 μm.

When the aqueous base coating composition (Y) includes the luster pigment (D3), the amount of the luster pigment (D3) is preferably about 1 to about 50 parts by mass, more preferably about 2 to about 30 parts by mass, and even more preferably about 3 to about 20 parts by mass, per 100 parts by mass of the resin solids in the aqueous base coating composition (Y).

When the aqueous base coating composition (Y) contains the luster pigment (D3) in the method for producing a multilayer coating film of the present invention, it is possible to form a multilayer coating film having excellent appearance with excellent smoothness and distinctness of image, a high flip-flop effect, and little metallic mottling.

This is presumably because, by using the aqueous intermediate coating composition (X) containing the diester compound (C), an intermediate coating film with appropriate hydrophilicity is formed, and the aqueous base coating composition (Y) applied on the intermediate coating film uniformly wets and spreads over the intermediate coating film, so that the luster pigment (D3) in the aqueous base coating composition (Y) is present in the base coating film in a relatively uniform state and is likely to be oriented parallel to the substrate, thereby forming a coating film having excellent appearance with a high flip-flop effect and little metallic mottling.

It is preferable that the aqueous base coating composition (Y) contain the hydrophobic solvent (E). From the viewpoint of the brilliance of the resulting coating film, it is preferable to use an alcohol hydrophobic solvent as the hydrophobic solvent (E). In particular, C₇₋₁₄ alcohol hydrophobic solvents are preferable. For example, it is particularly preferable to use at least one alcohol hydrophobic solvent selected from the group consisting of 1-octanol, 2-octanol, 2-ethyl-1-hexanol, ethylene glycol mono-2-ethylhexyl ether, propylene glycol mono-n-butyl ether, and dipropylene glycol mono-n-butyl ether.

When the aqueous base coating composition (Y) contains the hydrophobic solvent (E), the amount thereof is preferably about 2 to about 70 parts by mass, more preferably about 11 to about 60 parts by mass, and even more preferably about 16 to about 50 parts by mass, per 100 parts by mass of the resin solids content in the aqueous base coating composition (Y).

The aqueous base coating composition (Y) may further contain, if necessary, conventional additives for coating compositions, such as curing catalysts, thickening agents, UV absorbers, light stabilizers, antifoaming agents, plasticizers, organic solvents, surface control agents, antisettling agents, etc. Such additives can be used singly or in a combination of two or more.

The aqueous base coating composition (Y) can be applied using known methods such as air spray coating, airless spray coating, rotary atomization coating, etc. An electrostatic charge may be applied during coating. The coating is formed so as to obtain a cured film with a thickness of usually about 5 to about 30 μm, preferably about 8 to about 25 μm, and more preferably about 10 to about 20 μm.

### 3. Step (3)

In the method for forming a multilayer coating film of the present invention, the clear coating composition (Z) is applied to the layer of the aqueous base coating composition (Y) (hereinafter sometimes referred to as “base coating film”) formed in the above step (2).

It is preferable to perform, prior to the application of the clear coating composition (Z), preheating, air blowing, etc. on a clear coating layer under conditions in which the coating layer does not substantially cure. The preheating temperature is preferably about 40 to about 100° C., more preferably about 50 to about 90° C., and still more preferably about 60 to about 80° C. The preheating time is preferably about 30 seconds to about 15 minutes, more preferably about 1 to about 10 minutes, and still more preferably about 2 to about 5 minutes. Air blowing can usually be performed by blowing room temperature air or air heated to about 25 to about 80° C. over the coated surface of the substrate for about 30 seconds to 15 minutes.

It is preferable to adjust the solids content of the base coating film to generally about 70 to about 100 mass %, preferably about 80 to about 100 mass %, and more preferably about 90 to about 100 mass % by means of preheating, air blowing, etc., prior to the application of the clear coating composition (Z).

As the clear coating composition (Z), any known thermosetting clear coating compositions for coating an automobile body and the like can be used. Examples thereof include organic-solvent thermosetting coating compositions, aqueous thermosetting coating compositions, and powder thermosetting coating compositions, which comprise a crosslinking agent and a base resin having a crosslinkable functional group.

Examples of crosslinkable functional groups contained in a base resin include carboxy, hydroxy, epoxy, silanol, and the like. Examples of the kinds of base resins include acrylic resins, polyester resins, alkyd resins, urethane resins, epoxy resins, fluororesins, and the like. Examples of crosslinking agents include polyisocyanate compounds, blocked polyisocyanate compounds, melamine resins, urea resins, carboxy-containing compounds, carboxy-containing resins, epoxy-containing resins, epoxy-containing compounds, and the like.

Examples of preferable combinations of base resin/crosslinking agent for the clear coating composition (Z) are carboxy-containing resin/epoxy-containing resin, hydroxy-containing resin/polyisocyanate compound, hydroxy-containing resin/blocked polyisocyanate compound, hydroxy-containing resin/melamine resin, and the like.

The clear coating composition (Z) may be a one-component coating composition, or a multi-component coating composition such as a two-component urethane resin coating composition.

If necessary, the clear coating composition (Z) may contain a coloring pigment (D1), luster pigment (D3), dye, etc., in a degree such that the transparency of the clear coating composition is not impaired, and may also contain an extender pigment (D2), UV absorber, light stabilizer, antifoaming agent, thickening agent, anticorrosive, surface control agent, etc.

The clear coating composition (Z) can be applied on the surface of the aqueous base coating composition (Y) using known methods such as airless spray coating, air spray coating, rotary atomization coating, etc. An electrostatic charge may be applied during coating.

The clear coating composition (Z) is applied to a cured film thickness of generally about 10 to about 80 μm, preferably about 15 to about 60 μm, and more preferably about 20 to about 50 μm.

After application of the clear coating composition (Z), if necessary, it is possible to have an interval of about 1 to about 60 minutes at room temperature, or perform preheating at about 40 to about 80° C. for about 1 to about 60 minutes.

### 4. Step (4)

In the method of forming a multilayer coating film of the present invention, the uncured intermediate coating layer, uncured base coating layer, and uncured clear coating layer formed in Steps (1) to (3) are simultaneously heat-cured.

The intermediate coating layer, base coating layer, and clear coating layer are cured by a usual baking method, such as air-blowing, infrared heating, high frequency heating, and the like.

The heating temperature is preferably about 80 to about 180° C., more preferably about 100 to about 170° C., and still more preferably about 120 to about 160° C.

The heating time is preferably about 10 to about 60 minutes, and more preferably about 15 to about 40 minutes. This heating allows the multilayer coating film consisting of three layers, i.e., an intermediate coating layer, base coating layer and clear coating layer to be simultaneously cured.

### EXAMPLES

The present invention is described below in more detail with reference to Examples and Comparative Examples. However, the present invention is not limited to these examples. In the examples, “parts” and “%” are expressed on a weight basis.

### Production of Hydroxy- and Carboxy-Containing Resin (A3)

### Production of Hydroxy- and Carboxy-Containing Polyester Resin (A3-1)

### Production Example 1-1

Eighty eight grams of adipic acid, 490 g of 1,2-cyclohexanedicarboxylic acid anhydride, 199 g of isophthalic acid, 336 g of 2-butyl-2-ethyl-1,3-propanediol, 189 g of neopentylglycol, and 287 g of trimethylolpropane were placed into a reaction vessel equipped with a thermometer, a thermostat, a stirrer, a reflux condenser and a water separator, and heated from 160° C. to 230° C. over 3 hours. The reaction was maintained at 230° C. while removing the condensation water using a water separator, and was allowed to proceed until the acid value became 5 mg KOH/g or less. 48 g of trimellitic anhydride was added to the reaction product, and an addition reaction was performed at 170° C. for 30 minutes. Subsequently, the resultant was cooled to 50° C. or less, and neutralized by adding 0.9 equivalents of 2-(dimethylamino)ethanol relative to acid groups. Then, deionized water was gradually added to obtain an aqueous hydroxy- and carboxy-containing polyester resin dispersion (A3-1-1) with a solids content of 45% and a pH of 7.2. The resulting hydroxy- and carboxy-containing polyester resin had an acid value of 24 mg KOH/g, a hydroxy value of 150 mg KOH/g, and a number average molecular weight of 1,310.

The content of the C₄ or higher linear alkylene group in the resulting hydroxy- and carboxy-containing polyester resin is calculated using the following formula.

$$The molar number of the {C}_{4} or higher linear alkylene group ( Wm ) = 88 / 146 ( adipic acid ) = 0.603 mol$$

$$The mass of condensation water = 18 \times \{ 2 \times 199 / 166 ( isophthalic acid ) + 1 \times 490 / 154 ( 1 , 2 \text{-} cyclohexanedicarboxylic anhydride ) + 2 \times 88 / 146 ( adipic acid ) \} = 122 g$$

$$The resulting amount of the resin without the condensation water ( Wr ) = 287 ( trimethylolpropane ) + 336 ( 2 \text{-} butyl \text{-} 2 \text{-} ethyl \text{-} 1 , 3 \text{-} propanediole ) + 189 ( neopentyl glycol ) + 199 ( isophthalic acid ) + 490 ( 1 , 2 \text{-} cyclohexanedicarboxylic anhydride ) + 88 ( adipic acid ) + 48 ( trimellitic anhydride ) - 122 ( condensation water ) = 1515 g = 1.515 kg$$

$$The content of the {C}_{4} or higher linear alkylene group = The number of mol of the {C}_{4} or higher linear alkylene group ( Wm ) / the resulting amount of the resin without condensation water ( Wr ) = 0.603 / 1.515 = 0.4 mol \text{/} kg ( resin solids content )$$

The total amount of the benzene ring and the cyclohexane ring in the resulting hydroxy- and carboxy-containing polyester resin was calculated according to the following formula.

$$The total molar number of the benzene ring and the cyclohexane ring ( Wn ) = 199 / 166 ( isophtalic acid ) + 490 / 154 ( 1 , 2 \text{-} cyclophexanedicarboxylic anhydride ) + 48 / 192 ( trimellitic anhydride ) = 4.63 mol$$

$$The total amount of the benzene ring and the cyclohexane ring = The total molar number of the benzene ring and the cyclohexane ring ( Wn ) / the resulting amount of the resin without the condensation water ( Wr ) = 4.63 / 1.515 = 3.1 mol \text{/} kg ( resin solids content )$$

### Production Examples 1-2 to 1-12

According to the proportions shown in Tables 1 and 2 below, aqueous hydroxy- and carboxy-containing polyester resin dispersions (A3-1-2) to (A3-1-12), each having a solids content of 45% and a pH of 7.2 were obtained in the same manner as in Example 1-1. Tables 1 and 2 show the content of the C₄ or higher linear alkylene group, total amount of the benzene ring and the cyclohexane ring, acid value, hydroxy value, and number average molecular weight of each of the resulting hydroxy- and carboxy-containing polyester resins, along with those of the aqueous hydroxy- and carboxy-containing polyester resin dispersion (A3-1-1) obtained in Production Example 1-1.

TABLE 1

| Production Example | | | 1-1 | 1-2 | 1-3 | 1-4 | 1-5 | 1-6 |
|---|---|---|---|---|---|---|---|---|
| Hydroxy- and carboxy-containing polyester resin | | | A3-1-1 | A3-1-2 | A3-1-3 | A3-1-4 | A3-1-5 | A3-1-6 |
| Acid | Aliphatic polybasic | Adipic acid (Mw 146) | 88 | 88 | 420 | 263 | 263 | 263 |
| component | acid (a1-1-1) | Dodecanedioic acid (Mw 230) | | | | | | |
| (a1-1) | Alicyclic polybasic | 1,2-Cyclohexanedicarboxylic | 490 | 490 | 231 | 305 | 305 | 305 |
| | acid (a1-1-2) | anhydride (Mw 154) | | | | | | |
| | Aromatic polybasic | Isophthalic acid (Mw 166) | 199 | 199 | 100 | 199 | 199 | 199 |
| | acid (a1-1-3) | | | | | | | |
| Alcohol | Aliphatic diol | 1,6-Hexanediol (Mw 118) | | | | | 212 | |
| component | (a1-2-1) | 1,9-Nonanediol (Mw 160) | | | | | | 288 |
| (a1-2) | | 2-Butyl-2-ethyl-1,3-propane | 336 | 288 | 355 | 336 | 240 | 240 |
| | | diol (Mw 160) | | | | | | |
| | | Neopentyl glycol (Mw 105) | 189 | 95 | 189 | 50 | | |
| | Alicyclic diol | 1,4-Cyclohexane dimethanol | | 173 | | 173 | 86 | 86 |
| | (a1-2-2) | (Mw 144) | | | | | | |
| | | Trimethylolpropane (Mw 134) | 287 | 287 | 270 | 303 | 287 | 287 |
| Acid | Aromatic polybasic | Trimellitic anhydride (Mw 192) | 48 | 48 | 48 | 48 | 48 | 51 |
| component | acid (a1-1-3) | | | | | | | |
| (a1-1) | | | | | | | | |

| | | | | | | |
|---|---|---|---|---|---|---|
| Content of C₄ or higher linear alkylene | 0.4 | 0.4 | 2.0 | 1.2 | 2.4 | 2.3 |
| [mmol/g(resin solids content)] | | | | | | |
| Total amount of benzene ring and cyclohexane ring | 3.1 | 3.8 | 1.6 | 3.0 | 2.7 | 2.6 |
| [mmol/g(resin solids content)] | | | | | | |
| Acid value [mg KOH/g] | 24 | 23 | 25 | 23 | 24 | 24 |
| Hydroxy value [mg KOH/g] | 150 | 146 | 150 | 152 | 151 | 148 |
| Number average molecular weight | 1310 | 1330 | 1270 | 1330 | 1300 | 1350 |
| Weight average molecular weight | 10800 | 10900 | 10400 | 11200 | 10700 | 11500 |

TABLE 2

| Production Example | | | 1-7 | 1-8 | 1-9 | 1-10 | 1-11 | 1-12 |
|---|---|---|---|---|---|---|---|---|
| Hydroxy- and carboxy-containing polyester resin | | | A3-1-7 | A3-1-8 | A3-1-9 | A3-1-10 | A3-1-11 | A3-1-12 |
| Acid | Aliphatic polybasic | Adipic acid (Mw 146) | | | 44 | 438 | 464 | 88 |
| component | acid (a1-1-1) | Dodecanedioic acid (Mw 230) | 138 | 276 | | | | |
| (a1-1) | Alicyclic polybasic | 1,2-Cyclohexanedicarboxylic | 490 | 490 | 370 | 305 | 277 | 397 |
| | acid (a1-1-2) | anhydride (Mw 154) | | | | | | |
| | Aromatic polybasic | Isophthalic acid (Mw 165) | 199 | 100 | 378 | | | 299 |
| | acid (a1-1-3) | | | | | | | |
| Alcohol | Aliphatic diol | 1,6-Hexanediol (Mw 118) | | | | 142 | | |
| component | (a1-2-1) | 1,9-Nonanediol (Mw 160) | | | | | | |
| (a1-2) | | 2-Butyl-2-ethyl-1,3-propane | 336 | 336 | 336 | 154 | 336 | 288 |
| | | diol (Mw 160) | | | | | | |
| | | Neopentyl glycol (Mw 105) | 176 | 164 | 183 | | 202 | |
| | Alicyclic diol | 1,4-Cyclohexane dimethanol | | | | 259 | | 285 |
| | (a1-2-2) | (Mw 144) | | | | | | |
| | | Trimethylolpropane (Mw 134) | 303 | 319 | 295 | 278 | 270 | 303 |
| Acid | Aromatic polybasic | Trimellitic anhydride (Mw 192) | 48 | 53 | 53 | 53 | 50 | 50 |
| component | acid (a1-1-3) | | | | | | | |
| (a1-1) | | | | | | | | |

| | | | | | | |
|---|---|---|---|---|---|---|
| Content of C₄ or higher linear alkylene | 0.4 | 0.7 | 0.2 | 2.8 | 2.2 | 0.4 |
| [mmol/g(resin solids content)] | | | | | | |
| Total amount of benzene ring and cyclohexane ring | 3.0 | 2.5 | 3.3 | 2.7 | 1.4 | 4.2 |
| [mmol/g(resin solids content)] | | | | | | |
| Acid value [mg KOH/g] | 23 | 24 | 24 | 25 | 24 | 23 |
| Hydroxy value [mg KOH/g] | 148 | 147 | 150 | 149 | 148 | 148 |
| Number average molecular weight | 1353 | 1394 | 1310 | 1290 | 1320 | 1360 |
| Weight average molecular weight | 10900 | 12200 | 10500 | 10400 | 10700 | 10900 |

### Production of Hydroxy- and Carboxy-Containing Acrylic Resin (A3-2)

### Production Example 1-13

A 30 part quantity of propylene glycol monopropyl ether was placed into a reaction vessel equipped with a thermometer, a thermostat, a stirrer, a reflux condenser, a nitrogen inlet tube and a dropping funnel, and heated to 85° C. A mixture of 10 parts of styrene, 30 parts of methyl methacrylate, 15 parts of 2-ethylhexyl acrylate, 11.5 parts of n-butyl acrylate, 30 parts of hydroxyethyl acrylate, 3.5 parts of acrylic acid, 10 parts of propylene glycol monopropyl ether and 2 parts of 2,2′-azobis(2,4-dimethylvaleronitrile) was added dropwise over 4 hours, and then aged for 1 hour. A mixture of 5 parts of propylene glycol monopropyl ether and 1 part of 2,2′-azobis(2,4-dimethylvaleronitrile) was further added dropwise into a flask for 1 hour, and after completion of the dropwise addition, aging was conducted for 1 hour. Subsequently, 3.03 parts of 2-(dimethylamino)ethanol was added. Deionized water was gradually added to thereby obtain a hydroxy- and carboxy-containing acrylic resin dispersion (A3-2-1) with a solids content of 40%. The resulting hydroxy- and carboxy-containing acrylic resin had an acid value of 27 mg KOH/g, a hydroxy value of 145 mg KOH/g, and a weight average molecular weight of 24,000.

### Production Example 1-14

A 70.7 part quantity of deionized water and 0.52 parts of polyoxyethylene alkyl ether sulfate ester ammonium salt (trade name “Aqualon KH-10” produced by Dai-Ichi Kogyo Seiyaku Co., Ltd., active ingredient: 97%) were placed into a reaction vessel equipped with a thermometer, a thermostat, a stirrer, a reflux condenser, a nitrogen inlet tube and a dropping funnel. The mixture was stirred and mixed in a nitrogen flow, and heated to 80° C. Subsequently, 1% of the total amount of the emulsified monomer (1) described below and 5 parts of 6% ammonium persulfate solution were introduced into a reaction vessel, and maintained at 80° C. for 15 minutes. The remaining emulsified monomer (1) was added dropwise into a reaction vessel over 3 hours while the same temperature was maintained. After completion of the dropwise addition, the reaction product was aged for 1 hour. Gradually adding 40 parts of 5% 2-(dimethylamino)ethanol solution into a reaction vessel, the reaction product was cooled to 30° C., and filtrated using 100-mesh nylon cloth to obtain a filtrate of an aqueous hydroxy- and carboxy-containing acrylic resin dispersion (A3-2-2) with a solids content of 45%. The resulting hydroxy- and carboxy-containing acrylic resin had an acid value of 12 mg KOH/g, a hydroxy value of 43 mg KOH/g, and a weight average molecular weight of 150,000.

Emulsified monomer (1): Emulsified monomer (1) was obtained by mixing and stirring 50 parts of deionized water, 10 parts of styrene, 40 parts of methyl methacrylate, 35 parts of ethylacrylate, 3.5 parts of n-butyl methacrylate, 10 parts of 2-hydroxyethyl methacrylate, 1.5 parts of acrylic acid, 1.0 part of Aqualon KH-10 and 0.03 parts of ammonium persulfate.

### Production of Water-Dispersible Polyisocyanate Compound (B1)

### Production Example 1-15

A 165 part quantity of tolonate HDT (NCO %=21.9%, a polyisocyanate compound produced by Rhodia Co., Ltd.), 24 parts of butyl acetate, 13 parts of Rhodafac RE610 (a surfactant produced by Rhodia Co., Ltd.) and 3 parts of triethylamine were mixed under stirring using a disperser at 100 rpm for 5 minutes. The water-dispersible polyisocyanate compound (B1-3) was thus obtained.

### Production of Aqueous Intermediate Coating Composition (X1)

### Production Example 1-16

A 44 part quantity (resin solids content: 20 parts) of aqueous hydroxy- and carboxy-containing polyester resin dispersion (A3-1-1) obtained in Production Example 1-1, 60 parts of rutile titanium dioxide (D1-1) (trade name “JR-806”, produced by TAYCA CORP.), 1 part of carbon black (D1-2) (trade name “Carbon MA-100”, produced by Mitsubishi Chemical, Inc.), 15 parts of barium sulfate powder (D2-1) (trade name “Bariace B-35”, produced by Sakai Chemical Industry Co., Ltd.) having an average primary particle diameter of 0.5 μm, 3 parts of powdered talc (D2-2) (trade name “MICRO ACE S-3”, produced by Nippon Talc Co., Ltd) having an average primary particle diameter of 4.8 μm, and 11 parts of deionized water were mixed. After being adjusted to a pH of 8.0 with 2-(dimethylamino)ethanol, the mixture was dispersed using a paint shaker for 30 minutes to obtain a pigment dispersion paste.

Next, 134 parts of the resulting pigment dispersion paste, 98 parts of the aqueous hydroxy- and carboxy-containing polyester resin dispersion (A3-1-1) obtained in Production Example 1-1, 10 parts of a diester compound (C-1) described below, and 10 parts of a hydrophobic solvent (E-1) (2-ethyl-1-hexanol (mass dissolved in 100 g of water at 20° C.: 0.1 g)) were homogeneously mixed to obtain a main agent.

Diester compound (C-1): a diester compound of polyoxyethylene glycol and n-hexanoic acid, the diester compound being represented by Formula (1), wherein R¹ and R² are pentyl, R³ is ethylene, and m is 5. This diester compound has a molecular weight of 434.

Subsequently, 26 parts of polyisocyanate compound (B1-1) (trade name “Bayhydrol XP2570” produced by Sumika Bayer Urethane Co., Ltd., an anionic hydrophilic water-dispersible polyisocyanate compound, solids content: 100%, NCO content: 20.6%), a urethane associative thickening agent (trade name “UH-752”, produced by ADEKA Co., Ltd.), 2-(dimethylamino)ethanol, and deionized water were added to the resulting main agent, to obtain an aqueous intermediate coating composition (X1-1) having a pH of 8.0, a solids content of 48%, and a viscosity of 40 seconds as measured at 20° C. using Ford Cup No. 4. The application was conducted in such a manner that the resulting aqueous intermediate coating composition (X1-1) had a cured film thickness of 30 μm, and the gel fraction (G₈₀) of the coating film after being heated at 80° C. for 10 minutes was 40%.

### Production Examples 1-17 to 1-53, and 1-56 to 1-60

According to the proportions shown in Tables 3 to 9 below, aqueous intermediate coating compositions (X1-2) to (X1-38) and (X1-41) to (X1-45), each having a pH of 8.0, solids content of 48%, and a viscosity of 40 seconds as measured at 20° C. using Ford Cup No. 4 were obtained in the same manner as in Example 1-16.

In Production Example 1-49, 25 parts of a carbodiimide-containing compound (trade name “Carbodilite V-02” produced by Nisshinbo Industries, Inc., solids content: 40%) was further added during the production of the aqueous intermediate coating composition (X). In production Example 1-50, 11 parts of melamine resin (trade name “Cymel 327” produced by Japan Cytec Industries, Inc., solids content: 90%) was further added during the production of the aqueous intermediate coating composition (X). In Production Example 1-53, 10 parts of ethylene glycol mono-n-butyl ether (mass dissolved in 100 g of water at 20° C.: unlimited) was added in place of the hydrophobic solvent (E-1). In Production Example 1-59, 29 parts of melamine resin (trade name “Cymel 327” produced by Japanese Cytec Industries, Inc., solids content 90%) was further added during the production of the aqueous intermediate coating composition (X1). In Production Example 1-60, 68 parts of a blocked polyisocyanate compound (trade name “Bayhydrol VP LS-2310” produced by Sumika Bayer Urethane Co., Ltd., solids content: 38%) was further added during the production of the aqueous intermediate coating composition (X1).

The polyisocyanate compounds (B1-2) to (B1-4) represented in Tables 3 to 9 below are as follows.

Polyisocyanate compound (B1-2): Bayhydrol VP LS-2319 produced by Sumika Bayer Urethane Co., Ltd., nonionic hydrophilic water-dispersible polyisocyanate compound, solids content: 100%, NCO content: 18.0%)

Polyisocyanate compound (B1-3): The water-dispersible polyisocyanate compound obtained in Production Example 1-15

Polyisocyanate compound (B1-4): Desmodur XP 2410 (Sumika Bayer Urethane Co., Ltd., solids content: 100%, NCO content: 24.0%)

Diester compounds (C-2) to (C-20) represented in Tables 3 to 9 below are as follows.

Diester compound (C-2): a diester compound of polyoxyethylene glycol and 2-ethylbutanoic acid, the diester compound being represented by Formula (1), wherein R¹ and R² are sec-butyl, R³ is ethylene, and m is 7. This diester compound has a molecular weight of 522.

Diester compound (C-3): a diester compound of polyoxyethylene glycol and 2-ethylpentanoic acid, the diester compound being represented by Formula (1), wherein R¹ and R² are 2-ethylbutyl, R³ is ethylene, and m is 7. This diester compound has a molecular weight of 536.

Diester compound (C-4): a diester compound of polyoxyethylene glycol and benzoic acid, the diester compound being represented by Formula (1), wherein R¹ and R² are benzene rings, R² is ethylene, and m is 7. This diester compound has a molecular weight of 536.

Diester compound (C-5): a diester compound of polyoxyethylene glycol and n-octanoic acid, the diester compound being represented by Formula (1), wherein R¹ and R² are heptyl, R³ is ethylene, and m is 7. This diester compound has a molecular weight of 578.

Diester compound (C-6): a diester compound of polyoxypropylene glycol and n-octanoic acid, the diester compound being represented by Formula (1), wherein R¹ and R² are heptyl, R³ is propylene, and m is 7. This diester compound has a molecular weight of 676.

Diester compound (C-7): a diester compound of polyoxybutylene glycol and n-octanoic acid, the diester compound being represented by Formula (1), wherein R¹ and R² are heptyl, R³ is butylene, and m is 7. This diester compound has a molecular weight of 774.

Diester compound (C-8): a diester compound of polyoxyethylene glycol and 2-ethylhexanoic acid, the diester compound being represented by Formula (1), wherein R¹ and R² are 2-ethylpentyl, R³ is ethylene, and m is 7. This diester compound has a molecular weight of 578.

Diester compound (C-9): a diester compound of polyoxyethylene glycol and n-nonoic acid, the diester compound being represented by Formula (1), wherein R¹ and R² are octyl, R³ is ethylene, and m is 7. This diester compound has a molecular weight of 606.

Diester compound (C-10): a diester compound of polyoxyethylene glycol and 2-ethylheptanoic acid, the diester compound being represented by Formula (1), wherein R¹ and R² are 2-ethyl hexyl, R³ is ethylene, and m is 7. This diester compound has a molecular weight of 606.

Diester compound (C-11): a diester compound of polyoxyethylene glycol and n-decanoic acid, the diester compound being represented by Formula (1), wherein R¹ and R² are nonyl, R³ is ethylene, and m is 7. This diester compound has a molecular weight of 634.

Diester compound (C-12): a diester compound of polyoxyethylene glycol and 2-ethyloctanoic acid, the diester compound being represented by Formula (1), wherein R¹ and R² are 2-ethylheptyl, R³ is ethylene, and m is 10. This diester compound has a molecular weight of 766.

Diester compound (C-13): a diester compound of polyoxyethylene glycol and n-dodecanoic acid, the diester compound being represented by Formula (1), wherein R¹ and R² are undecyl, R³ is ethylene, and m is 7. This diester compound has a molecular weight of 690.

Diester compound (C-14): a diester compound of polyoxyethylene glycol and n-octadecanoic acid, the diester compound being represented by Formula (1), wherein R¹ and R² are heptadecyl, R³ is ethylene, and m is 7. This diester compound has a molecular weight of 858.

Diester compound (C-15): a diester compound of polyoxyethylene glycol and 2-ethylhexanoic acid, the diester compound being represented by Formula (1), wherein R¹ and R² are 2-ethylpentyl, R³ is ethylene, and m is 3. This diester compound has a molecular weight of 402.

Diester compound (C-16): a diester compound of polyoxyethylene glycol and 2-ethylhexanoic acid, the diester compound being represented by Formula (1), wherein R¹ and R² are 2-ethylpentyl, R³ is ethylene, and m is 5. This diester compound has a molecular weight of 490.

Diester compound (C-17): a diester compound of polyoxyethylene glycol and 2-ethylhexanoic acid, the diester compound being represented by Formula (1), wherein R¹ and R² are 2-ethylpentyl, R³ is ethylene, and m is 10. This diester compound has a molecular weight of 710.

Diester compound (C-18): a diester compound of polyoxyethylene glycol and 2-ethylhexanoic acid, the diester compound being represented by Formula (1), wherein R¹ and R² are 2-ethylpentyl, R³ is ethylene, and m is 25. This diester compound has a molecular weight of 1370.

Diester compound (C-19): a diester compound of polyoxyethylene glycol and n-butanoic acid, the diester compound being represented by Formula (1), wherein R¹ and R² are n-propyl, R³ is ethylene, and m is 7. This diester compound has a molecular weight of 466.

Diester compound (C-20): a diester compound of polyoxyethylene glycol and n-icosanoic acid, the diester compound being represented by Formula (1), wherein R¹ and R² are nonadecyl, R³ is ethylene, and m is 7. This diester compound has a molecular weight of 914.

### Examples 1-54

A 44 part quantity (resin solids content: 20 parts) of the aqueous hydroxy- and carboxy-containing polyester resin dispersion (A3-1-1) obtained in Production Example 1-1, 60 parts of rutile titanium dioxide (D1-1), 1 part of carbon black (D1-2), 15 parts of barium sulfate powder (D2-1) having an average primary particle diameter of 0.5 μm, 3 parts of powdered talc (D2-2) having an average primary particle diameter of 4.8 μm and 11 parts of deionized water were mixed. After being adjusted to a pH of 8.0 with 2-(dimethylamino)ethanol, the mixture was dispersed using a paint shaker for 30 minutes to obtain a pigment dispersion paste.

Next, 134 parts of the resulting pigment dispersion paste, 98 parts of the aqueous hydroxy- and carboxy-containing polyester resin dispersion (A3-1-1) obtained in Production Example 1-1, 10 parts of the diester compound (C-8), and 10 parts of the hydrophobic solvent (E-1) were homogenously mixed to obtain a main agent.

Subsequently, 26 parts of the polyisocyanate compound (B1-1), a polyacrylic acid thickening agent (trade name “Primal ASE-60”, produced by Rohm and Haas Company), 2-(dimethylamino)ethanol and deionized water were added to the main agent to obtain an aqueous intermediate coating composition (X1-39) having a pH of 8.0, a solids content of 48%, and a viscosity of 40 seconds measured at 20° C. using Ford Cup No. 4.

### Production Example 1-55

A 44 part quantity (resin solids content: 20 parts) of the aqueous hydroxy- and carboxy-containing polyester resin dispersion (A3-1-1) obtained in Production Example 1-1, 60 parts of rutile titanium dioxide (D1-1), 1 part of carbon black (D1-2), 15 parts of barium sulfate powder (D2-1) having an average primary particle diameter of 0.5 μm, 3 parts of powdered talc (D2-2) having an average primary particle diameter of 4.8 μm and 11 parts of deionized water were mixed. After being adjusted to a pH of 8.0 with 2-(dimethylamino)ethanol, the mixture was dispersed using a paint shaker for 30 minutes to obtain a pigment dispersion paste.

Next, 134 parts of the resulting pigment dispersion paste, 98 parts of the aqueous hydroxy- and carboxy-containing polyester resin dispersion (A3-1-1) obtained in Production Example 1-1, 10 parts of the above diester compound (C-8), and 10 parts of the hydrophobic solvent (E-1) were homogenously mixed to obtain a main agent.

Subsequently, 26 parts of the polyisocyanate compound (B1-1), 2-(dimethylamino)ethanol and deionized water were added to the main agent to obtain an aqueous intermediate coating composition (X1-40) having a pH of 8.0, and a viscosity of 40 seconds as measured at 20° C. using Ford Cup No. 4.

TABLE 3

| Production Example | | | | 1-16 | 1-17 | 1-18 | 1-19 | 1-20 | 1-21 | 1-22 | 1-23 |
|---|---|---|---|---|---|---|---|---|---|---|---|
| Aqueous intermediate coating composition (X1) | | | | X1-1 | X1-2 | X1-3 | X1-4 | X1-5 | X1-6 | X1-7 | X1-8 |
| Main | Pigment | Hydroxy- and | Kind | A3-1-1 | A3-1-1 | A3-1-1 | A3-1-1 | A3-1-1 | A3-1-1 | A3-1-1 | A3-1-1 |
| agent | dispersion | carboxy-containing | Content | 44 | 44 | 44 | 44 | 44 | 44 | 44 | 44 |
| | paste | polyester resin (A3-1) | | | | | | | | | |
| | | Coloring pigment | Kind | D1-1 | D1-1 | D1-1 | D1-1 | D1-1 | D1-1 | D1-1 | D1-1 |
| | | (D1) | Content | 60 | 60 | 60 | 60 | 60 | 60 | 60 | 60 |
| | | | Kind | D1-2 | D1-2 | D1-2 | D1-2 | D1-2 | D1-2 | D1-2 | D1-2 |
| | | | Content | 1 | 1 | 1 | 1 | 1 | 1 | 1 | 1 |
| | | Extender pigment | Kind | D2-1 | D2-1 | D2-1 | D2-1 | D2-1 | D2-1 | D2-1 | D2-1 |
| | | (D2) | Content | 15 | 15 | 15 | 15 | 15 | 15 | 15 | 15 |
| | | | Kind | D2-2 | D2-2 | D2-2 | D2-2 | D2-2 | D2-2 | D2-2 | D2-2 |
| | | | Content | 3 | 3 | 3 | 3 | 3 | 3 | 3 | 3 |

| | | | | | | | | | | |
|---|---|---|---|---|---|---|---|---|---|---|
| | Hydroxy- and carboxy-containing | Kind | A3-1-1 | A3-1-1 | A3-1-1 | A3-1-1 | A3-1-1 | A3-1-1 | A3-1-1 | A3-1-1 |
| | polyester resin (A3-1) | Content | 98 | 98 | 98 | 98 | 98 | 98 | 98 | 98 |
| | Diester compound (C) | Kind | C-1 | C-2 | C-3 | C-4 | C-5 | C-6 | C-7 | C-8 |
| | | Content | 10 | 10 | 10 | 10 | 10 | 10 | 10 | 10 |
| | Hydrophobic solvent (E) | Kind | E-1 | E-1 | E-1 | E-1 | E-1 | E-1 | E-1 | E-1 |
| | | Content | 10 | 10 | 10 | 10 | 10 | 10 | 10 | 10 |
| Curing | Polyisocyanate compound (B1) | Kind | B1-1 | B1-1 | B1-1 | B1-1 | B1-1 | B1-1 | B1-1 | B1-1 |
| agent | | Content | 26 | 26 | 26 | 26 | 26 | 26 | 26 | 26 |

| | | | | | | | | |
|---|---|---|---|---|---|---|---|---|
| Gel fraction (G₈₀) of the coating film after being | 40 | 39 | 38 | 43 | 41 | 41 | 41 | 38 |
| heated at 80° C. for 10 minutes [%] | | | | | | | | |

TABLE 4

| Production Example | | | | 1-24 | 1-25 | 1-26 | 1-27 | 1-28 | 1-29 | 1-30 | 1-31 |
|---|---|---|---|---|---|---|---|---|---|---|---|
| Aqueous intermediate coating composition (X1) | | | | X1-9 | X1-10 | X1-11 | X1-12 | X1 -13 | X1-14 | X1-15 | X1-16 |
| Main | Pigment | Hydroxy- and | Kind | A3-1-1 | A3-1-1 | A3-1-1 | A3-1-1 | A3-1-1 | A3-1-1 | A3-1-1 | A3-1-1 |
| agent | dispersion | carboxy-containing | Content | 44 | 44 | 44 | 44 | 44 | 44 | 44 | 44 |
| | paste | polyester resin (A3-1) | | | | | | | | | |
| | | Coloring pigment | Kind | D1-1 | D1-1 | D1-1 | D1-1 | D1-1 | D1-1 | D1-1 | D1-1 |
| | | (D1) | Content | 60 | 60 | 60 | 60 | 60 | 60 | 60 | 60 |
| | | | Kind | D1-2 | D1-2 | D1-2 | D1-2 | D1-2 | D1-2 | D1-2 | D1-2 |
| | | | Content | 1 | 1 | 1 | 1 | 1 | 1 | 1 | 1 |
| | | Extender pigment | Kind | D2-1 | D2-1 | D2-1 | D2-1 | D2-1 | D2-1 | D2-1 | D2-1 |
| | | (D2) | Content | 15 | 15 | 15 | 15 | 15 | 15 | 15 | 15 |
| | | | Kind | D2-2 | D2-2 | D2-2 | D2-2 | D2-2 | D2-2 | D2-2 | D2-2 |
| | | | Content | 3 | 3 | 3 | 3 | 3 | 3 | 3 | 3 |

| | | | | | | | | | | |
|---|---|---|---|---|---|---|---|---|---|---|
| | Hydroxy- and carboxy-containing | Kind | A3-1-1 | A3-1-1 | A3-1-1 | A3-1-1 | A3-1-1 | A3-1-1 | A3-1-1 | A3-1-1 |
| | polyester resin (A3-1) | Content | 98 | 98 | 98 | 98 | 98 | 98 | 98 | 98 |
| | Diester compound (C) | Kind | C-9 | C-10 | C-11 | C-12 | C-13 | C-14 | C-15 | C-16 |
| | | Content | 10 | 10 | 10 | 10 | 10 | 10 | 10 | 10 |
| | Hydrophobic solvent (E) | Kind | E-1 | E-1 | E-1 | E-1 | E-1 | E-1 | E-1 | E-1 |
| | | Content | 10 | 10 | 10 | 10 | 10 | 10 | 10 | 10 |
| Curing | Polyisocyanate compound (B1) | Kind | B1-1 | B1-1 | B1-1 | B1-1 | B1-1 | B1-1 | B1-1 | B1-1 |
| agent | | Content | 26 | 26 | 26 | 26 | 26 | 26 | 26 | 26 |

| | | | | | | | | |
|---|---|---|---|---|---|---|---|---|
| Gel fraction (G₈₀) of the coating film after being | 39 | 41 | 40 | 38 | 39 | 42 | 41 | 40 |
| heated at 80° C. for 10 minutes [%] | | | | | | | | |

TABLE 5

| Production Example | | | | 1-32 | 1-33 | 1-34 | 1-35 | 1-36 | 1-37 | 1-38 |
|---|---|---|---|---|---|---|---|---|---|---|
| Aqueous intermediate coating composition (X1) | | | | X1-17 | X1-18 | X1-19 | X1-20 | X1-21 | X1-22 | X1-23 |
| Main | Pigment | Hydroxy- and | Kind | A3-1-1 | A3-1-1 | A3-1-2 | A3-1-3 | A3-1-4 | A3-1-5 | A3-1-6 |
| agent | dispersion | carboxy-containing | Content | 44 | 44 | 44 | 44 | 44 | 44 | 44 |
| | paste | polyester resin (A3-1) | | | | | | | | |
| | | Coloring pigment | Kind | D1-1 | D1-1 | D1-1 | D1-1 | D1-1 | D1-1 | D1-1 |
| | | (D1) | Content | 60 | 60 | 60 | 60 | 60 | 60 | 60 |
| | | | Kind | D1-2 | D1-2 | D1-2 | D1-2 | D1-2 | D1-2 | D1-2 |
| | | | Content | 1 | 1 | 1 | 1 | 1 | 1 | 1 |
| | | Extender pigment | Kind | D2-1 | D2-1 | D2-1 | D2-1 | D2-1 | D2-1 | D2-1 |
| | | (D2) | Content | 15 | 15 | 15 | 15 | 15 | 15 | 15 |
| | | | Kind | D2-2 | D2-2 | D2-2 | D2-2 | D2-2 | D2-2 | D2-2 |
| | | | Content | 3 | 3 | 3 | 3 | 3 | 3 | 3 |

| | | | | | | | | | |
|---|---|---|---|---|---|---|---|---|---|
| | Hydroxy- and carboxy-containing | Kind | A3-1-1 | A3-1-1 | A3-1-2 | A3-1-3 | A3-1-4 | A3-1-5 | A3-1-6 |
| | polyester resin (A3-1) | Content | 98 | 98 | 98 | 98 | 98 | 98 | 98 |
| | Diester compound (C) | Kind | C-17 | C-18 | C-8 | C-8 | C-8 | C-8 | C-8 |
| | | Content | 10 | 10 | 10 | 10 | 10 | 10 | 10 |
| | Hydrophobic solvent (E) | Kind | E-1 | E-1 | E-1 | E-1 | E-1 | E-1 | E-1 |
| | | Content | 10 | 10 | 10 | 10 | 10 | 10 | 10 |
| Curing | Polyisocyanate compound (B1) | Kind | B1-1 | B1-1 | B1-1 | B1-1 | B1-1 | B1-1 | B1-1 |
| agent | | Content | 26 | 26 | 26 | 26 | 26 | 26 | 26 |

| | | | | | | | |
|---|---|---|---|---|---|---|---|
| Gel fraction (G₈₀) of the coating film after being | 38 | 42 | 41 | 40 | 39 | 42 | 38 |
| heated at 80° C. for 10 minutes [%] | | | | | | | |

TABLE 6

| Production Example | | | | 1-39 | 1-40 | 1-41 | 1-42 | 1-43 | 1-44 |
|---|---|---|---|---|---|---|---|---|---|
| Aqueous intermediate coating composition (X1) | | | | X1-24 | X1-25 | X1-26 | X1-27 | X1-28 | X1-29 |
| Main | Pigment | Hydroxy- and | Kind | A3-1-7 | A3-1-8 | A3-1-9 | A3-1-10 | A3-1-11 | A3-1-12 |
| agent | dispersion | carboxy-containing | Content | 44 | 44 | 44 | 44 | 44 | 44 |
| | paste | polyester resin (A3-1) | | | | | | | |
| | | Coloring pigment | Kind | D1-1 | D1-1 | D1-1 | D1-1 | D1-1 | D1-1 |
| | | (D1) | Content | 60 | 60 | 60 | 60 | 60 | 60 |
| | | | Kind | D1-2 | D1-2 | D1-2 | D1-2 | D1-2 | D1-2 |
| | | | Content | 1 | 1 | 1 | 1 | 1 | 1 |
| | | Extender pigment | Kind | D2-1 | D2-1 | D2-1 | D2-1 | D2-1 | D2-1 |
| | | (D2) | Content | 15 | 15 | 15 | 15 | 15 | 15 |
| | | | Kind | D2-2 | D2-2 | D2-2 | D2-2 | D2-2 | D2-2 |
| | | | Content | 3 | 3 | 3 | 3 | 3 | 3 |

| | | | | | | | | |
|---|---|---|---|---|---|---|---|---|
| | Hydroxy- and carboxy-containing | Kind | A3-1-7 | A3-1-8 | A3-1-9 | A3-1-10 | A3-1-11 | A3-1-12 |
| | polyester resin (A3-1) | Content | 98 | 98 | 98 | 98 | 98 | 98 |
| | Diester compound (C) | Kind | C-8 | C-8 | C-8 | C-8 | C-8 | C-8 |
| | | Content | 10 | 10 | 10 | 10 | 10 | 10 |
| | Hydrophobic solvent (E) | Kind | E-1 | E-1 | E-1 | E-1 | E-1 | E-1 |
| | | Content | 10 | 10 | 10 | 10 | 10 | 10 |
| Curing | Polyisocyanate compound (B1) | Kind | B1-1 | B1-1 | B1-1 | B1-1 | B1-1 | B1-1 |
| agent | | Content | 26 | 26 | 26 | 26 | 26 | 26 |

| | | | | | | |
|---|---|---|---|---|---|---|
| Gel fraction (G₈₀) of the coating film after being | 38 | 41 | 40 | 39 | 40 | 38 |
| heated at 80° C. for 10 minutes [%] | | | | | | |

TABLE 7

| Production Example | | | | 1-45 | 1-46 | 1-47 | 1-48 | 1-49 |
|---|---|---|---|---|---|---|---|---|
| Aqueous intermediate coating composition (X1) | | | | X1-30 | X1-31 | X1-32 | X1-33 | X1-34 |
| Main | Pigment | Hydroxy- and | Kind | A3-1-1 | A3-1-1 | A3-1-1 | A3-1-1 | A3-1-1 |
| agent | dispersion | carboxy-containing | Content | 44 | 44 | 44 | 44 | 44 |
| | paste | polyester resin (A3-1) | | | | | | |
| | | Coloring pigment | Kind | D1-1 | D1-1 | D1-1 | D1-1 | D1-1 |
| | | (D1) | Content | 60 | 60 | 60 | 60 | 60 |
| | | | Kind | D1-2 | D1-2 | D1-2 | D1-2 | D1-2 |
| | | | Content | 1 | 1 | 1 | 1 | 1 |
| | | Extender pigment | Kind | D2-1 | D2-1 | D2-1 | D2-1 | D2-1 |
| | | (D2) | Content | 15 | 15 | 15 | 15 | 15 |
| | | | Kind | D2-2 | D2-2 | D2-2 | D2-2 | D2-2 |
| | | | Content | 3 | 3 | 3 | 3 | 3 |

| | | | | | | | |
|---|---|---|---|---|---|---|---|
| | Hydroxy- and carboxy-containing | Kind | | A3-1-1 | A3-1-1 | A3-1-1 | A3-1-1 |
| | polyester resin (A3-1) | Content | | 65 | 98 | 98 | 98 |
| | Hydroxy- and carboxy-containing | Kind | A3-2-1 | A3-2-2 | | | |
| | acrylic resin (A3-2) | Content | 110 | 33 | | | |
| | Diester compound (C) | Kind | C-8 | C-8 | C-8 | C-8 | C-8 |
| | | Content | 10 | 10 | 10 | 10 | 10 |
| | Hydrophobic solvent (E) | Kind | E-1 | E-1 | E-1 | E-1 | E-1 |
| | | Content | 10 | 10 | 10 | 10 | 10 |
| Curing | Polyisocyanate compound (B1) | Kind | B1-1 | B1-1 | B1-2 | B1-3 | B1-1 |
| agent | | Content | 26 | 26 | 26 | 33 | 16 |

| | |
|---|---|
| Carbodilite V-02 | 25 |

| | | | | | |
|---|---|---|---|---|---|
| Gel fraction (G₈₀) of the coating film after being | 41 | 52 | 36 | 35 | 29 |
| heated at 80° C. for 10 minutes [%] | | | | | |

TABLE 8

| Production Example | | | | 1-50 | 1-51 | 1-52 | 1-53 | 1-54 | 1-55 |
|---|---|---|---|---|---|---|---|---|---|
| Aqueous intermediate coating composition (X1) | | | | X1-35 | X1-36 | X1-37 | X1-38 | X1-39 | X1-40 |
| Main | Pigment | Hydroxy- and | Kind | A3-1-1 | A3-1-1 | A3-1-1 | A3-1-1 | A3-1-1 | A3-1-1 |
| agent | dispersion | carboxy-containing | Content | 44 | 44 | 44 | 44 | 44 | 44 |
| | paste | polyester resin (A3-1) | | | | | | | |
| | | Coloring pigment | Kind | D1-1 | D1-1 | D1-1 | D1-1 | D1-1 | D1-1 |
| | | (D1) | Content | 60 | 60 | 60 | 60 | 60 | 60 |
| | | | Kind | D1-2 | D1-2 | D1-2 | D1-2 | D1-2 | D1-2 |
| | | | Content | 1 | 1 | 1 | 1 | 1 | 1 |
| | | Extender pigment | Kind | D2-1 | D2-1 | D2-1 | D2-1 | D2-1 | D2-1 |
| | | (D2) | Content | 15 | 15 | 15 | 15 | 15 | 15 |
| | | | Kind | D2-2 | D2-2 | D2-2 | D2-2 | D2-2 | D2-2 |
| | | | Content | 3 | 3 | 3 | 3 | 3 | 3 |

| | Hydroxy- and carboxy-containing | Kind | A3-1-1 | A3-1-1 | A3-1-1 | A3-1-1 | A3-1-1 | A3-1-1 |
|---|---|---|---|---|---|---|---|---|
| | polyester resin (A3-1) | Content | 98 | 98 | 98 | 98 | 98 | 98 |
| | Diester compound (C) | Kind | C-8 | C-8 | C-8 | C-8 | C-8 | C-8 |
| | | Content | 10 | 10 | 10 | 10 | 10 | 10 |
| | Hydrophobic solvent (E) | Kind | E-1 | E-1 | E-1 | | E-1 | E-1 |
| | | Content | 10 | 10 | 10 | | 10 | 10 |
| | Ethylene glycol mono-n-butyl ether | | | | | 10 | | |
| Curing | Polyisocyanate compound (B1) | Kind | B1-1 | B1-1 | B1-4 | B1-1 | B1-1 | B1-1 |
| agent | | Content | 16 | 20 | 26 | 26 | 26 | 26 |
| | | Kind | | B1-4 | | | | |
| | | Content | | 6 | | | | |

| | |
|---|---|
| Cymel 327 | 11 |

| | | | | | | |
|---|---|---|---|---|---|---|
| Gel fraction (G₈₀) of the coating film after being | 20 | 45 | 41 | 38 | 38 | 39 |
| heated at 80° C. for 10 minutes [%] | | | | | | |

TABLE 9

| Production Example | | | | 1-56 | 1-57 | 1-58 | 1-59 | 1-60 |
|---|---|---|---|---|---|---|---|---|
| Aqueous intermediate coating composition (X1) | | | | X1-41 | X1-42 | X1-43 | X1-44 | X1-45 |
| Main | Pigment | Hydroxy- and | Kind | A3-1-1 | A3-1-1 | A3-1-1 | A3-1-1 | A3-1-1 |
| agent | dispersion | carboxy-containing | Content | 44 | 44 | 44 | 44 | 44 |
| | paste | polyester resin (A3-1) | | | | | | |
| | | Coloring pigment | Kind | D1-1 | D1-1 | D1-1 | D1-1 | D1-1 |
| | | (D1) | Content | 60 | 60 | 60 | 60 | 60 |
| | | | Kind | D1-2 | D1-2 | D1-2 | D1-2 | D1-2 |
| | | | Content | 1 | 1 | 1 | 1 | 1 |
| | | Extender pigment | Kind | D2-1 | D2-1 | D2-1 | D2-1 | D2-1 |
| | | (D2) | Content | 15 | 15 | 15 | 15 | 15 |
| | | | Kind | D2-2 | D2-2 | D2-2 | D2-2 | D2-2 |
| | | | Content | 3 | 3 | 3 | 3 | 3 |

| | | | | | | | |
|---|---|---|---|---|---|---|---|
| | Hydroxy- and carboxy-containing | Kind | A3-1-1 | A3-1-1 | A3-1-1 | A3-1-1 | A3-1-1 |
| | polyester resin (A3-1) | Content | 98 | 98 | 113 | 98 | 98 |
| | Diester compound (C) | Kind | C-19 | C-20 | | C-8 | C-8 |
| | | Content | 10 | 10 | | 10 | 10 |
| | Hydrophobic solvent (E) | Kind | E-1 | E-1 | E-1 | E-1 | E-1 |
| | | Content | 10 | 10 | 10 | 10 | 10 |
| Curing | Polyisocyanate compound (B1) | Kind | B1-1 | B1-1 | B1-1 | | |
| agent | | Content | 26 | 26 | 29 | | |

| | | |
|---|---|---|
| Cymel 327 | 29 | |
| Bayhydrol VP LS-2310 | | 68 |

| | | | | | |
|---|---|---|---|---|---|
| Gel fraction (G₈₀) of the coating film after being | 38 | 37 | 43 | 2 | 0 |
| heated at 80° C. for 10 minutes [%] | | | | | |

### Production Example of Acrylic Resin Emulsion for an Aqueous Base Coating Composition (Y)

### Production Example 1-61

A 130 part quantity of deionized water and 0.52 parts of Aqualon KH-10 were placed into a reaction vessel equipped with a thermometer, a thermostat, a stirrer, a reflux condenser, a nitrogen inlet tube and a dropping funnel, stirred and mixed in a nitrogen flow, and heated to 80° C. Subsequently, 1% of the total amount of the emulsified monomer (1) described below and 5.3 parts of 6% ammonium persulfate solution were introduced into the reaction vessel and maintained at 80° C. for 15 minutes. The remaining emulsified monomer (1) was then added dropwise into a reaction vessel over 3 hours where the reaction vessel was maintained at the same temperature. After completion of the dropwise addition, the reaction product was aged for 1 hour. Subsequently, the emulsified monomer (2) described below was added dropwise over 1 hour. After aging for 1 hour, the reaction product was cooled to 30° C. while gradually adding 40 parts of 5% dimethylethanolamine solution into a reaction vessel, and filtrated using 100-mesh nylon cloth to obtain a filtrate of acrylic resin emulsion (AC) having a mean particle diameter of 100 nm and a solids content of 30%.

After diluting the emulsion with deionized water, the mean particle diameter was measured using the submicron particle size distribution analyzer (“COULTER N4”, a product of Beckman Coulter, Inc.) at 20° C.

The resulting acrylic resin had an acid value of 33 mg KOH/g and a hydroxy value of 25 mg KOH/g.

Emulsified monomer (1): 42 parts of deionized water, 0.72 parts of Aqualon KH-10, 2.1 parts of methylene-bis-acrylamide, 2.8 parts of styrene, 16.1 parts of methyl methacrylate, 28 parts of ethyl acrylate and 21 parts of n-butyl acrylate were mixed under stirring to obtain an emulsified monomer (1).

Emulsified monomer (2): 18 parts of deionized water, 0.31 parts of Aqualon KH-10, 0.03 parts of ammonium persulfate, 5.1 parts of methacrylic acid, 5.1 parts of 2-hydroxyethyl acrylate, 3 parts of styrene, 6 parts of methyl methacrylate, 1.8 parts of ethyl acrylate and 9 parts of n-butyl acrylate were mixed under stirring to obtain an emulsified monomer (2).

### Production of Polyester Resin for an Aqueous Base Coating Composition (Y)

### Production Example 1-62

A 109 part quantity of trimethylolpropane, 141 parts of 1,6-hexanediol, 126 parts of hexahydrophthalic anhydride and 120 parts of adipic acid were placed into a reaction vessel equipped with a thermometer, a thermostat, a stirrer, a reflux condenser and a water separator, and were heated from 160° C. to 230° C. over 3 hours, followed by a condensation reaction at 230° C. for 4 hours. Subsequently, in order to add a carboxyl group to the resulting condensation reaction product, 38.3 parts of trimellitic anhydride was further added, and allowed to react at 170° C. for 30 minutes. The reaction product was diluted with 2-ethyl-1-hexanol (mass dissolved in 100 g of water at 20° C.: 0.1 g) to obtain a polyester resin solution (9E1) with a solid content of 70%. The resulting polyester resin had an acid value of 46 mg KOH/g, a hydroxy value of 150 mg KOH/g, and a weight average molecular weight of 6,400.

### Production Example 1-63

A polyester resin solution (PE2) was obtained in the same manner as in Production Example 1-62, except that ethylene glycolmono-n-butyl ether (mass dissolved in 100 g of water at 20° C.: unlimited) was used in place of 2-ethyl-1-hexanol.

### Production Example of Luster Pigment Dispersion

### Production Example 1-64

In a stirring and mixing container, 19 parts of an aluminium pigment paste (trade name “GX-180A”, produced by Asahi Kasei Metals Co., Ltd., metal content: 74%), 35 parts of 2-ethyl-1-hexanol, 8 parts of a phosphoric acid-containing resin solution (refer to Note 1 below) and 0.2 parts of 2-(dimethylamino)ethanol were homogenously mixed to obtain a luster pigment dispersion (P1).

Note 1: The phosphoric acid-containing resin solution was prepared as follows. A solvent mixture comprising 27.5 parts of methoxypropanol and 27.5 parts of isobutanol was put into a reaction vessel equipped with a thermometer, a thermostat, a stirrer, a reflux condenser, a nitrogen inlet tube and a dropping funnel, and then heated to 110° C. Subsequently, 121.5 parts of a mixture comprising 25 parts of styrene, 27.5 parts of n-butyl methacrylate, 20 parts of branched higher alkyl acrylate (trade name: “isostearyl acrylate”, product of Osaka Organic Chemical Industry, Ltd.), 7.5 parts of 4-hydroxybutyl acrylate, 15 parts of a phosphoric acid-containing polymerizable monomer (refer to Note 2 below), 12.5 parts of 2-methacryloyloxy ethyl acid phosphate, 10 parts of isobutanol and 4 parts of t-butyl peroxyoctanoate were added to the above solvent mixture over 4 hours. Subsequently, a mixture comprising 0.5 parts of t-butyl peroxyoctanoate and 20 parts of isopropanol was added dropwise to the mixture obtained as above over 1 hour. Subsequently, the resulting mixture was aged over 1 hour with stirring to obtain a phosphoric acid-containing resin solution with a solid content of 50%. The phosphoric acid-containing resin had an acid value of 83 mg KOH/g based on the phosphoric acid group, a hydroxy value of 29 mg KOH/g, and a weight average molecular, weight of 10,000.

Note 2: The phosphoric acid-containing polymerizable monomer was prepared as follows. 57.5 parts of monobutyl phosphate and 41 parts of isobutanol were put into a reaction vessel equipped with a thermometer, a thermostat, a stirrer, a reflux condenser, a nitrogen inlet tube and a dropping funnel, and were heated to 90° C. Subsequently, 42.5 parts of glycidyl methacrylate was added dropwise over 2 hours. After aging for 1 hour with stirring, 59 parts of isopropanol was added to obtain a phosphoric acid-containing polymerizable monomer solution with a solid content of 50%. The resulting monomer had an acid value of 285 mg KOH/g based on the phosphoric acid group.

### Production Example 1-65

A luster pigment dispersion (P2) was obtained in the same manner as in Production Example 1-64, except that ethylene glycolmono-n-butyl ether was used in place of 2-ethyl-1-hexanol.

### Production of an Aqueous Base Coating Composition (Y)

### Production Example 1-66

A 100 part quantity of the acrylic resin emulsion (AC) obtained in Production Example 1-61, 57 parts of the polyester resin solution (PE1) obtained in Production Example 1-62, 62 parts of the luster pigment dispersion (P1) obtained in Production Example 1-64 and 37.5 parts of the melamine resin (trade name “Cymel 325”, produced by Japan Cytec Industries, Inc., solids content: 80%) were homogenously mixed, and a polyacrylic acid thickening agent (trade name “Primal ASE-60”, produced by Rohm and Haas), 2-(dimethylamino)ethanol and deionized water were further added to obtain an aqueous base coating composition (Y-1) having a pH of 8.0, a solids content of 25%, and a viscosity of 40 seconds as measured at 20° C. using Ford Cup No. 4.

### Production Example 1-67

A 100 part quantity of the acrylic resin emulsion (AC) obtained in Production Example 1-61, 57 parts of the polyester resin solution (PE2) obtained in Production Example 1-63, 62 parts of the luster pigment dispersion (P2) obtained in Production Example 1-65 and 37.5 parts of melamine resin (trade name “Cymel 325”, produced by Japan Cytec Industries, Inc., solids content: 80%) were homogenously mixed, and a polyacrylic acid thickening agent (trade name “Primal ASE-60”, produced by Rohm and Haas), 2-(dimethylamino)ethanol and deionized water were further added to obtain an aqueous base coating composition (Y-2) having a pH of 8.0, a solids content of 25%, and a viscosity of 40 seconds as measured at 20° C. using Ford Cup No. 4.

### Preparation of Test Plate

The aqueous intermediate coating compositions (X1-1) to (X1-45) obtained in Production Examples 1-16 to 1-60, and the aqueous base coating compositions (Y-1) and (Y-2) obtained in Production Examples 1-66 and 1-67 were used in the following manner to form test plates. Evaluation tests were then performed.

### Preparation of Test Substrate to be Coated

A cationic electrodeposition coating composition (trade name “Electron GT-10”, produced by Kansai Paint Co., Ltd.) was applied to a cold-rolled steel plate treated with zinc phosphate by electrodeposition to a cured film thickness of 20 μm, and was cured by heating at 170° C. for 30 minutes. A test substrate to be coated was thus prepared.

### Example 1-1

The aqueous intermediate coating composition (X1-1) obtained in Production Example 1-16 was electrostatically applied to the substrate to a cured film thickness of 25 μm using a rotary atomizing electrostatic coating machine. The substrate was then allowed to stand for 2 minutes, and preheated at 80° C. for 3 minutes. Subsequently, the aqueous base coating composition (Y-1) obtained in Production Example 1-66 was electrostatically applied to the uncured intermediate coating film to a cured film thickness of 15 μm using a rotary atomizing electrostatic coating machine, then allowed to stand for 2 minutes, and preheated at 80° C. for 3 minutes. Next, an acrylic resin solvent-based clear topcoat composition (trade name “Magicron KINO-1210”, produced by Kansai Paint Co., Ltd.; hereinafter sometimes referred to as “clear coating composition (Z-1)”) was electrostatically applied to the uncured base coating film to a cured film thickness of 35 μm, then allowed to stand for 7 minutes, and heated at 140° C. for minutes to cure the intermediate coating film, the base coating film and the clear coating film simultaneously. A test plate was thus obtained.

### Examples 1-2 to 1-41, Comparative Examples 1-1 to 1-5

Test plates were obtained in the same manner as in Example 1-1, except that any one of the aqueous intermediate coating compositions (X1-2) to (X1-45) shown in Tables 10 to 14 was used in place of the aqueous intermediate coating composition (X1-1) obtained in Production Example 1-16, and that the aqueous base coating composition (Y-1) shown in Tables 10 to 14, or the aqueous base coating composition (Y-2) obtained in Production Example 1-67 was used in place of the aqueous base coating composition (Y-1) obtained in Production Example 1-66.

### Evaluation Test

Test plates obtained in Examples 1-1 to 1-41 and Comparative Examples 1-1 to 1-5 were evaluated according to the test method below. Tables 10 to 14 show the evaluation results.

### Test Method

Smoothness: Smoothness was evaluated based on the Long Wave (LW) values that were measured by “Wave Scan” (produced by BYK Gardner). The smaller the Long Wave (LW) value, the higher the smoothness of the coating surface. In Tables 10 to 14, “initial” indicates the smoothness of the aqueous intermediate coating composition (X1) coated immediately after production, and “post-storage” indicates the smoothness of the coated aqueous intermediate composition (X1) obtained by mixing the main agent that is stored at 30° C. for 30 days after the production, with other raw materials.

Distinctness of image: Distinctness of image was evaluated based on the Short Wave (SW) values measured by the “Wave Scan”. The smaller the Short Wave (SW) value, the higher the distinctness of image on the coating surface.

Flip-flop effect: Test plates were observed visually from various angles, and a flip-flop effect was rated according to the following criteria.

A: There were significant changes in the metallic appearance visually observed (exceedingly excellent flip-flop effect);

B: There were large changes in the metallic appearance visually observed (excellent flip-flop effect);

C: There was relatively little change in the metallic appearance visually observed (slightly poor flip-flop effect); and

D: There was little change in the metallic appearance visually observed (poor flip-flop effect).

Metallic mottling: Test plates were visually observed, and the occurrence of metallic mottling was rated according to the following criteria.

A: Almost no metallic mottling was observed, and the coating film had an extremely excellent appearance;

B: A small amount of metallic mottling was observed, but the coating film had an excellent appearance;

C: Metallic mottling was observed, and the coating film had a relatively poor appearance; and

D: A considerable amount of metallic mottling was observed, and the coating film had a poor appearance.

Water resistance: Test plates were immersed in warm water at 40° C. for 240 hours and removed therefrom, and then dried at 20° C. for 12 hours. Lattice-like cuts were made in the multilayer coating films on the test plates in a manner such that a knife reaches the base material, making 100 crosscuts having a size of 2 mm×2 mm. Subsequently, an adhesive cellophane tape was adfixed to their surfaces, and the tape was abruptly peeled off at 20° C. The conditions of the remaining crosscut coating films were checked.

A: 100 crosscut sections of the coating film remained, and no small chipped edges were produced at the cutting edges made by the cutter knife;

B: 100 crosscut sections of the coating film remained, but small chipped edges were observed at the cutting edges made by the cutter knife;

C: 90 to 99 crosscut sections of the coating film remained; and

D: The number of remaining crosscut sections of the coating film was 89 or less.

Chipping resistance: A test plate was fixed on the sample holder of a gravel chipping test instrument (trade name “JA-400”, produced by Suga Test Instruments Co., Ltd.,) and 50 g of granite gravel of No. 7 particle size was sprayed at a distance of 30 cm from the test plate and at an angle of 45° onto the test plate with compressed air at 0.392 MPa (4 kgf/cm²) at −20° C. Subsequently, the resulting test plate was washed with water and dried. A cloth adhesive tape (a product of Nichiban Co., Ltd.) was applied to the coating surface, and then peeled off. The degree of the occurrence of the scratches formed on the coating film was visually observed and evaluated.

A: Sizes of scratches were exceedingly small, and the electrodeposition surface and the substrate of the steel plate were not exposed.

B: Sizes of scratches were small, and the electrodeposition surface and the substrate of the steel plate were not exposed.

C: Sizes of scratches were small, but the electrodeposition surface or the substrate of the steel plate was exposed.

D: Sizes of scratches were considerably large, and the substrate of the steel plate was largely exposed.

TABLE 10

| | | Example | | | | | | | | | |
|---|---|---|---|---|---|---|---|---|---|---|---|
| | | 1-1 | 1-2 | 1-3 | 1-4 | 1-5 | 1-6 | 1-7 | 1-8 | 1-9 | 1-10 |
| Aqueous intermediate | | X1-1 | X1-2 | X1-3 | X1-4 | X1-5 | X1-6 | X1-7 | X1-8 | X1-9 | X1-10 |
| coating composition (X1) | | | | | | | | | | | |
| Aqueous base coating | | Y-1 | Y-1 | Y-1 | Y-1 | Y-1 | Y-1 | Y-1 | Y-1 | Y-1 | Y-1 |
| composition (Y) | | | | | | | | | | | |
| Clear coating | | Z-1 | Z-1 | Z-1 | Z-1 | Z-1 | Z-1 | Z-1 | Z-1 | Z-1 | Z-1 |
| composition (Z) | | | | | | | | | | | |
| Evaluation result | | | | | | | | | | | |
| Smoothness | Initial | 8.1 | 8.2 | 7.5 | 7.7 | 7.0 | 7.3 | 7.7 | 7.2 | 7.3 | 7.4 |
| | Post- | 9.3 | 8.6 | 7.9 | 8.2 | 8.1 | 8.3 | 8.8 | 7.5 | 8.1 | 7.9 |
| | storage | | | | | | | | | | |

| | | | | | | | | | | |
|---|---|---|---|---|---|---|---|---|---|---|
| Distinctness of image | 15.4 | 15.2 | 13.8 | 14.3 | 13.4 | 13.6 | 13.8 | 13.2 | 13.8 | 13.6 |
| Flip-flop effect | B | A | A | A | A | B | B | A | A | A |
| Metallic mottling | B | A | A | A | A | A | B | A | A | A |
| Water resistance | B | A | A | A | A | A | A | A | A | A |
| Chipping resistance | A | A | A | A | A | A | A | A | A | A |

TABLE 11

| | | Example | | | | | | | | | |
|---|---|---|---|---|---|---|---|---|---|---|---|
| | | 1-11 | 1-12 | 1-13 | 1-14 | 1-15 | 1-16 | 1-17 | 1-18 | 1-19 | 1-20 |
| Aqueous intermediate | | X1-11 | X1-12 | X1-13 | X1-14 | X1-15 | X1-16 | X1-17 | X1-18 | X1-19 | X1-20 |
| coating composition (X1) | | | | | | | | | | | |
| Aqueous base coating | | Y-1 | Y-1 | Y-1 | Y-1 | Y-1 | Y-1 | Y-1 | Y-1 | Y-1 | Y-1 |
| composition (Y) | | | | | | | | | | | |
| Clear coating | | Z-1 | Z-1 | Z-1 | Z-1 | Z-1 | Z-1 | Z-1 | Z-1 | Z-1 | Z-1 |
| composition (Z) | | | | | | | | | | | |
| Evaluation result | | | | | | | | | | | |
| Smoothness | Initial | 7.9 | 8.1 | 8.3 | 8.4 | 8.3 | 7.2 | 8.3 | 8.5 | 7.4 | 7.2 |
| | Post- | 9.3 | 8.5 | 9.3 | 9.4 | 8.7 | 7.6 | 8.4 | 9.5 | 7.9 | 7.7 |
| | storage | | | | | | | | | | |

| | | | | | | | | | | |
|---|---|---|---|---|---|---|---|---|---|---|
| Distinctness of image | 14.4 | 15.0 | 15.5 | 15.8 | 15.6 | 13.7 | 15.4 | 15.8 | 13.5 | 13.2 |
| Flip-flop effect | A | A | B | B | B | A | B | B | A | A |
| Metallic mottling | B | A | B | B | B | A | A | B | A | A |
| Water resistance | A | A | B | B | B | A | B | B | A | A |
| Chipping resistance | A | A | A | A | A | A | A | A | A | A |

TABLE 12

| | | Example | | | | | | | | | |
|---|---|---|---|---|---|---|---|---|---|---|---|
| | | 1-21 | 1-22 | 1-23 | 1-24 | 1-25 | 1-26 | 1-27 | 1-28 | 1-29 | 1-30 |
| Aqueous intermediate | | X1-21 | X1-22 | X1-23 | X1-24 | X1-25 | X1-26 | X1-27 | X1-28 | X1-29 | X1-30 |
| coating composition (X1) | | | | | | | | | | | |
| Aqueous base coating | | Y-1 | Y-1 | Y-1 | Y-1 | Y-1 | Y-1 | Y-1 | Y-1 | Y-1 | Y-1 |
| composition (Y) | | | | | | | | | | | |
| Clear coating | | Z-1 | Z-1 | Z-1 | Z-1 | Z-1 | Z-1 | Z-1 | Z-1 | Z-1 | Z-1 |
| Composition (Z) | | | | | | | | | | | |
| Evaluation result | | | | | | | | | | | |
| Smoothness | Initial | 7.2 | 6.8 | 6.4 | 6.7 | 6.2 | 7.8 | 8.3 | 8.5 | 7.7 | 8.3 |
| | Post- | 7.6 | 7.3 | 6.9 | 7.2 | 6.6 | 8.3 | 8.8 | 9.1 | 8.3 | 8.8 |
| | storage | | | | | | | | | | |

| | | | | | | | | | | |
|---|---|---|---|---|---|---|---|---|---|---|
| Distinctness of image | 12.9 | 13.1 | 12.8 | 13.1 | 12.9 | 14.2 | 15.3 | 15.9 | 13.8 | 12.8 |
| Flip-flop effect | A | A | A | A | A | A | A | A | A | A |
| Metallic mottling | A | A | A | A | A | A | A | A | A | A |
| Water resistance | A | A | A | A | A | A | B | B | A | A |
| Chipping resistance | A | A | A | A | A | B | A | A | B | B |

TABLE 13

| | | Example | | | | | | | | | | |
|---|---|---|---|---|---|---|---|---|---|---|---|---|
| | | 1-31 | 1-32 | 1-33 | 1-34 | 1-35 | 1-36 | 1-37 | 1-38 | 1-39 | 1-40 | 1-41 |
| Aqueous intermediate | | X1-31 | X1-32 | X1-33 | X1-34 | X1-35 | X1-36 | X1-37 | X1-38 | X1-39 | X1-40 | X1-8 |
| coating composition (X1) | | | | | | | | | | | | |
| Aqueous base coating | | Y-1 | Y-1 | Y-1 | Y-1 | Y-1 | Y-1 | Y-1 | Y-1 | Y-1 | Y-1 | Y-2 |
| composition (Y) | | | | | | | | | | | | |
| Clear coating | | Z-1 | Z-1 | Z-1 | Z-1 | Z-1 | Z-1 | Z-1 | Z-1 | Z-1 | Z-1 | Z-1 |
| composition (Z) | | | | | | | | | | | | |
| Evaluation result | | | | | | | | | | | | |
| Smoothness | Initial | 9.1 | 7.3 | 7.5 | 7.3 | 9.4 | 8.2 | 8.9 | 9.4 | 9.5 | 9.4 | 8.2 |
| | Post- | 9.5 | 7.8 | 8.0 | 7.8 | 9.9 | 8.8 | 9.4 | 9.8 | 9.9 | 9.9 | 8.7 |
| | storage | | | | | | | | | | | |

| | | | | | | | | | | | |
|---|---|---|---|---|---|---|---|---|---|---|---|
| Distinctness of image | 13.2 | 13.6 | 14.2 | 14.1 | 15.9 | 13.1 | 13.2 | 12.9 | 13.0 | 12.8 | 14.1 |
| Flip-flop effect | A | A | A | B | B | A | A | A | A | B | B |
| Metallic mottling | A | A | A | B | B | A | A | A | A | B | B |
| Water resistance | A | A | B | A | A | A | A | A | B | A | A |
| Chipping resistance | A | A | A | B | B | A | A | A | A | A | A |

TABLE 14

| | | Comparative Example | | | | |
|---|---|---|---|---|---|---|
| | | 1-1 | 1-2 | 1-3 | 1-4 | 1-5 |
| Aqueous intermediate | | X1-41 | X1-42 | X1-43 | X1-44 | X1-45 |
| coating composition (X1) | | | | | | |
| Aqueous base coating | | Y-1 | Y-1 | Y-1 | Y-1 | Y-1 |
| composition (Y) | | | | | | |
| Clear coating | | Z-1 | Z-1 | Z-1 | Z-1 | Z-1 |
| Composition (Z) | | | | | | |
| Evaluation result | | | | | | |
| Smoothness | Initial | 11.1 | 13.1 | 11.5 | 12.2 | 12.5 |
| | Post- | 12.1 | 13.3 | 11.9 | 12.8 | 13.0 |
| | storage | | | | | |

| | | | | | |
|---|---|---|---|---|---|
| Distinctness of image | 17.7 | 17.1 | 18.4 | 19.4 | 19.1 |
| Flip-flop effect | C | C | C | C | C |
| Metallic mottling | D | D | C | C | C |
| Water resistance | A | A | A | A | A |
| Chipping resistance | A | A | A | A | A |

### Production of Aqueous Intermediate Coating Composition (X2)

### Production Example 2-1

A 44 part quantity (resin solids content: 20 parts) of aqueous hydroxy- and carboxy-containing polyester resin dispersion (A3-1-1) obtained in Production Example 1-1, 60 parts of rutile titanium dioxide (D1-1) (trade name “JR-806”, produced by TAYCA CORP.), 1 part of carbon black (D1-2) (trade name “Carbon MA-100”, produced by Mitsubishi Chemical, Inc.), 15 parts of barium sulfate powder (D2-1) (trade name “Bariace B-35”, produced by Sakai Chemical Industry Co., Ltd.) having an average primary particle diameter of 0.5 μm, 3 parts of powdered talc (D2-2) (trade name “MICRO ACE S-3”, produced by Nippon Talc Co., Ltd) having an average primary particle diameter of 4.8 μm, and 11 parts of deionized water were mixed. After being adjusted to a pH of 8.0 with 2-(dimethylamino)ethanol, the mixture was dispersed using a paint shaker for 30 minutes to obtain a pigment dispersion paste.

Next, 134 parts of the resulting pigment dispersion paste, 89 parts of aqueous hydroxy- and carboxy-containing polyester resin dispersion (A3-1-1) obtained in Production Example 1-1, 10 parts of the diester compound (C-1) used in Production Example 1-16, and 10 parts of hydrophobic solvent (E-1) (2-ethyl-1-hexanol (mass dissolved in 100 g of water at 20° C.: 0.1 g)) were homogeneously mixed to obtain a main agent.

Subsequently, 38 parts of polycarbodiimide compound (B2-1) (trade name “Carbodilite SV-02” produced by Nisshinbo Industries, Inc., solids content 40%), 19 parts of melamine resin (B3-1) (a methyl-butyl-etherified melamine resin, molar ratio of methoxy/butoxy=70/30, weight average molecular weight: 700, solids content: 80%), a urethane associative thickening agent (trade name “UH-752”, produced by ADEKA Co., Ltd.), 2-(dimethylamino)ethanol, and deionized water were added to the resulting main agent, to obtain an aqueous intermediate coating composition (X2-1) having a pH of 8.0, a solids content of 48%, and a viscosity of 40 seconds as measured at 20° C. using Ford Cup No. 4. The application was conducted so that the resulting aqueous intermediate coating composition (X2-1) had a cured film thickness of 30 μm, and the gel fraction (G₈₀) of the coating film after being heated at 80° C. for 10 minutes was 32%.

### Production Examples 2-2 to 2-36, and 2-39 to 2-43

According to the proportions shown in Tables 15 to 21 below, aqueous intermediate coating compositions (X2-2) to (X2-36) and (X2-39) to (X2-43), each having a pH of 8.0, solids content of 48%, and a viscosity of 40 seconds as measured at 20° C. using Ford Cup No. 4 were obtained in the same manner as in Production Example 2-1.

In Production Example 2-36, 10 parts of ethylene glycol mono-n-butyl ether (mass dissolved in 100 g of water at 20° C.: unlimited) was added in place of the hydrophobic solvent (E-1). In Production Example 2-43, 68 parts of a blocked polyisocyanate compound (trade name “Bayhydrol VPLS2310”, produced by Sumika Bayer Urethane Co., Ltd., solids content: 38%) was added during the production of the aqueous intermediate coating composition (X2).

Polycarbodiimide compound (B2-2) represented in Table 19 below is as follows.

Polycarbodiimide Compound (B2-2): Carbodilite V-02 produced by Nisshinbo Industries, Inc., solids content: 40%)

Diester compounds (C-2 to C-20) represented in Tables 15 to 21 are the same as above.

Melamine resins (B3-2 and B3-3) represented in Table 20 are as follows.

Melamine resin (B3-2): a methyl-etherified melamine resin, molar ratio of methoxy/butoxy=100/0, weight average molecular weight: 650, solids content: 90%)

Melamine resin (B3-3): a methyl-butyl-etherified melamine resin, molar ratio of methoxy/butoxy=55/45, weight average molecular weight: 1200, solids content: 70%)

### Production Example 2-37

A 44 part quantity (resin solids content: 20 parts) of aqueous hydroxy- and carboxy-containing polyester resin dispersion (A3-1-1) obtained in Production Example 1-1, 60 parts of rutile titanium dioxide (D1-1), 1 part of carbon black (D1-2), 15 parts of barium sulfate powder (D2-1) having an average primary particle diameter of 0.5 μm, 3 parts of powdered talc (D2-2) having an average primary particle diameter of 4.8 μm, and 11 parts of deionized water were mixed. After being adjusted to a pH of 8.0 with 2-(dimethylamino)ethanol, the mixture was dispersed using a paint shaker for 30 minutes to obtain a pigment dispersion paste.

Next, 134 parts of the resulting pigment dispersion paste, 89 parts of aqueous hydroxy- and carboxy-containing polyester resin dispersion (A3-1-1) obtained in Production Example 1-1, 10 parts of diester compound (C-8), and 10 parts of hydrophobic solvent (E-1) were homogeneously mixed to obtain a main agent.

Subsequently, 38 parts of polycarbodiimide compound (B2-1), 19 parts of melamine resin (B3-1), a polyacrylic acid thickening agent (trade name “PRIMAL ASE-60”, produced by Rohm and Haas), 2-(dimethylamino)ethanol, and deionized water were added to the resulting main agent, to obtain an aqueous intermediate coating composition (X2-37) having a pH of 8.0, a solids content of 48%, and a viscosity of 40 seconds as measured at 20° C. using Ford Cup No. 4.

### Production Example 2-38

A 44 part quantity (resin solids content: 20 parts) of aqueous hydroxy- and carboxy-containing polyester resin dispersion (A3-1-1) obtained in Production Example 1-1, 60 parts of rutile titanium dioxide (D1-1), 1 part of carbon black (D1-2), 15 parts of barium sulfate powder (D2-1) having an average primary particle diameter of 0.5 μm, 3 parts of powdered talc (D2-2) having an average primary particle diameter of 4.8 μm, and 11 parts of deionized water were mixed. After being adjusted to a pH of 8.0 with 2-(dimethylamino)ethanol, the mixture was dispersed using a paint shaker for 30 minutes to obtain a pigment dispersion paste.

Next, 134 parts of the resulting pigment dispersion paste, 89 parts of aqueous hydroxy- and carboxy-containing polyester resin dispersion (A3-1-1) obtained in Production Example 1-1, 10 parts of diester compound (C-8), and 10 parts of hydrophobic solvent (E-1) were homogeneously mixed to obtain a main agent.

Subsequently, 38 parts of polycarbodiimide compound (B2-1), 19 parts of melamine resin (B3-1), 2-(dimethylamino)ethanol, and deionized water were added to the resulting main agent, to obtain an aqueous intermediate coating composition (X2-38) having a pH of 8.0 and a viscosity of 40 seconds as measured at 20° C. using Ford Cup No. 4.

TABLE 15

| Production Example | | | | 2-1 | 2-2 | 2-3 | 2-4 | 2-5 | 2-6 | 2-7 |
|---|---|---|---|---|---|---|---|---|---|---|
| Aqueous intermediate coating composition (X2) | | | | X2-1 | X2-2 | X2-3 | X2-4 | X2-5 | X2-6 | X2-7 |
| Main | Pigment | Hydroxy- and | Kind | A3-1-1 | A3-1-1 | A3-1-1 | A3-1-1 | A3-1-1 | A3-1-1 | A3-1-1 |
| agent | dispersion | carboxy-containing | Content | 44 | 44 | 44 | 44 | 44 | 44 | 44 |
| | paste | polyester resin (A3-1) | | | | | | | | |
| | | Coloring pigment | Kind | D1-1 | D1-1 | D1-1 | D1-1 | D1-1 | D1-1 | D1-1 |
| | | (D1) | Content | 60 | 60 | 60 | 60 | 60 | 60 | 60 |
| | | | Kind | D1-2 | D1-2 | D1-2 | D1-2 | D1-2 | D1-2 | D1-2 |
| | | | Content | 1 | 1 | 1 | 1 | 1 | 1 | 1 |
| | | Extender pigment | Kind | D2-1 | D2-1 | D2-1 | D2-1 | D2-1 | D2-1 | D2-1 |
| | | (D2) | Content | 15 | 15 | 15 | 15 | 15 | 15 | 15 |
| | | | Kind | D2-2 | D2-2 | D2-2 | D2-2 | D2-2 | D2-2 | D2-2 |
| | | | Content | 3 | 3 | 3 | 3 | 3 | 3 | 3 |

| | | | | | | | | | |
|---|---|---|---|---|---|---|---|---|---|
| | Hydroxy- and carboxy-containing | Kind | A3-1-1 | A3-1-1 | A3-1-1 | A3-1-1 | A3-1-1 | A3-1-1 | A3-1-1 |
| | polyester resin (A3-1) | Content | 89 | 89 | 89 | 89 | 89 | 89 | 89 |
| | Diester compound (C) | Kind | C-1 | C-2 | C-3 | C-4 | C-5 | C-6 | C-7 |
| | | Content | 10 | 10 | 10 | 10 | 10 | 10 | 10 |
| | Hydrophobic solvent (E) | Kind | E-1 | E-1 | E-1 | E-1 | E-1 | E-1 | E-1 |
| | | Content | 10 | 10 | 10 | 10 | 10 | 10 | 10 |
| Curing | Polycarbodiimido compound (B2) | Kind | B2-1 | B2-1 | B2-1 | B2-1 | B2-1 | B2-1 | B2-1 |
| agent | | Content | 38 | 38 | 38 | 38 | 38 | 38 | 38 |
| | Melamine resin (B3) | Kind | B3-1 | B3-1 | B3-1 | B3-1 | B3-1 | B3-1 | B3-1 |
| | | Content | 19 | 19 | 19 | 19 | 19 | 19 | 19 |

| | | | | | | | |
|---|---|---|---|---|---|---|---|
| Gel fraction (G₈₀) of the coating film after being | 32 | 31 | 30 | 34 | 33 | 33 | 34 |
| heated at 80° C. for 10 minutes [%] | | | | | | | |

TABLE 16

| Production Example | | | | 2-8 | 2-9 | 2-10 | 2-11 | 2-12 | 2-13 | 2-14 | 2-15 |
|---|---|---|---|---|---|---|---|---|---|---|---|
| Aqueous intermediate coating composition (X2) | | | | X2-8 | X2-9 | X2-10 | X2-11 | X2-12 | X2-13 | X2-14 | X2-15 |
| Main | Pigment | Hydroxy- and | Kind | A3-1-1 | A3-1-1 | A3-1-1 | A3-1-1 | A3-1-1 | A3-1-1 | A3-1-1 | A3-1-1 |
| agent | dispersion | carboxy-containing | Content | 44 | 44 | 44 | 44 | 44 | 44 | 44 | 44 |
| | paste | polyester resin (A3-1) | | | | | | | | | |
| | | Coloring pigment | Kind | D1-1 | D1-1 | D1-1 | D1-1 | D1-1 | D1-1 | D1-1 | D1-1 |
| | | (D1) | Content | 60 | 60 | 60 | 60 | 60 | 60 | 60 | 60 |
| | | | Kind | D1-2 | D1-2 | D1-2 | D1-2 | D1-2 | D1-2 | D1-2 | D1-2 |
| | | | Content | 1 | 1 | 1 | 1 | 1 | 1 | 1 | 1 |
| | | Extender pigment | Kind | D2-1 | D2-1 | D2-1 | D2-1 | D2-1 | D2-1 | D2-1 | D2-1 |
| | | (D2) | Content | 15 | 15 | 15 | 15 | 15 | 15 | 15 | 15 |
| | | | Kind | D2-2 | D2-2 | D2-2 | D2-2 | D2-2 | D2-2 | D2-2 | D2-2 |
| | | | Content | 3 | 3 | 3 | 3 | 3 | 3 | 3 | 3 |

| | | | | | | | | | | |
|---|---|---|---|---|---|---|---|---|---|---|
| | Hydroxy- and carboxy-containing | Kind | A3-1-1 | A3-1-1 | A3-1-1 | A3-1-1 | A3-1-1 | A3-1-1 | A3-1-1 | A3-1-1 |
| | polyester resin (A3-1) | Content | 89 | 89 | 89 | 89 | 89 | 89 | 89 | 89 |
| | Diester compound (C) | Kind | C-8 | C-9 | C-10 | C-11 | C-12 | C-13 | C-14 | C-15 |
| | | Content | 10 | 10 | 10 | 10 | 10 | 10 | 10 | 10 |
| | Hydrophobic solvent (E) | Kind | E-1 | E-1 | E-1 | E-1 | E-1 | E-1 | E-1 | E-1 |
| | | Content | 10 | 10 | 10 | 10 | 10 | 10 | 10 | 10 |
| Curing | Polycarbodiimido compound (B2) | Kind | B2-1 | B2-1 | B2-1 | B2-1 | B2-1 | B2-1 | B2-1 | B2-1 |
| agent | | Content | 38 | 38 | 38 | 38 | 38 | 38 | 38 | 38 |
| | Melamine resin (B3) | Kind | B3-1 | B3-1 | B3-1 | B3-1 | B3-1 | B3-1 | B3-1 | B3-1 |
| | | Content | 19 | 19 | 19 | 19 | 19 | 19 | 19 | 19 |

| | | | | | | | | |
|---|---|---|---|---|---|---|---|---|
| Gel fraction (G₈₀) of the coating film after being | 30 | 31 | 33 | 32 | 30 | 31 | 34 | 33 |
| heated at 80° C. for 10 minutes [%] | | | | | | | | |

TABLE 17

| Production Example | | | | 2-16 | 2-17 | 2-18 | 2-19 | 2-20 | 2-21 | 2-22 |
|---|---|---|---|---|---|---|---|---|---|---|
| Aqueous intermediate coating composition (X2) | | | | X2-16 | X2-17 | X2-18 | X2-19 | X2-20 | X2-21 | X2-22 |
| Main | Pigment | Hydroxy- and | Kind | A3-1-1 | A3-1-1 | A3-1-1 | A3-1-2 | A3-1-3 | A3-1-4 | A3-1-5 |
| agent | dispersion | carboxy-containing | Content | 44 | 44 | 44 | 44 | 44 | 44 | 44 |
| | paste | polyester resin (A3-1) | | | | | | | | |
| | | Coloring pigment | Kind | D1-1 | D1-1 | D1-1 | D1-1 | D1-1 | D1-1 | D1-1 |
| | | (D1) | Content | 60 | 60 | 60 | 60 | 60 | 60 | 60 |
| | | | Kind | D1-2 | D1-2 | D1-2 | D1-2 | D1-2 | D1-2 | D1-2 |
| | | | Content | 1 | 1 | 1 | 1 | 1 | 1 | 1 |
| | | Extender pigment | Kind | D2-1 | D2-1 | D2-1 | D2-1 | D2-1 | D2-1 | D2-1 |
| | | (D2) | Content | 15 | 15 | 15 | 15 | 15 | 15 | 15 |
| | | | Kind | D2-2 | D2-2 | D2-2 | D2-2 | D2-2 | D2-2 | D2-2 |
| | | | Content | 3 | 3 | 3 | 3 | 3 | 3 | 3 |

| | | | | | | | | | |
|---|---|---|---|---|---|---|---|---|---|
| | Hydroxy- and carboxy-containing | Kind | A3-1-1 | A3-1-1 | A3-1-1 | A3-1-2 | A3-1-3 | A3-1-4 | A3-1-5 |
| | polyester resin (A3-1) | Content | 89 | 89 | 89 | 89 | 89 | 89 | 89 |
| | Diester compound (C) | Kind | C-16 | C-17 | C-18 | C-8 | C-8 | C-8 | C-8 |
| | | Content | 10 | 10 | 10 | 10 | 10 | 10 | 10 |
| | Hydrophobic solvent (E) | Kind | E-1 | E-1 | E-1 | E-1 | E-1 | E-1 | E-1 |
| | | Content | 10 | 10 | 10 | 10 | 10 | 10 | 10 |
| Curing | Polycarbodiimido compound (B2) | Kind | B2-1 | B2-1 | B2-1 | B2-1 | B2-1 | B2-1 | B2-1 |
| agent | | Content | 38 | 38 | 38 | 38 | 38 | 38 | 38 |
| | Melamine resin (B3) | Kind | B3-1 | B3-1 | B3-1 | B3-1 | B3-1 | B3-1 | B3-1 |
| | | Content | 19 | 19 | 19 | 19 | 19 | 19 | 19 |

| | | | | | | | |
|---|---|---|---|---|---|---|---|
| Gel fraction (G₈₀) of the coating film after being | 32 | 30 | 34 | 33 | 32 | 31 | 34 |
| heated at 80° C. for 10 minutes [%] | | | | | | | |

TABLE 18

| Production Example | | | | 2-23 | 2-24 | 2-25 | 2-26 | 2-27 | 2-28 |
|---|---|---|---|---|---|---|---|---|---|
| Aqueous intermediate coating composition (X2) | | | | X2-23 | X2-24 | X2-25 | X2-26 | X2-27 | X2-28 |
| Main | Pigment | Hydroxy- and | Kind | A3-1-6 | A3-1-7 | A3-1-8 | A3-1-9 | A3-1-10 | A3-1-11 |
| agent | dispersion | carboxy-containing | Content | 44 | 44 | 44 | 44 | 44 | 44 |
| | paste | polyester resin (A3-1) | | | | | | | |
| | | Coloring pigment | Kind | D1-1 | D1-1 | D1-1 | D1-1 | D1-1 | D1-1 |
| | | (D1) | Content | 60 | 60 | 60 | 60 | 60 | 60 |
| | | | Kind | D1-2 | D1-2 | D1-2 | D1-2 | D1-2 | D1-2 |
| | | | Content | 1 | 1 | 1 | 1 | 1 | 1 |
| | | Extender pigment | Kind | D2-1 | D2-1 | D2-1 | D2-1 | D2-1 | D2-1 |
| | | (D2) | Content | 15 | 15 | 15 | 15 | 15 | 15 |
| | | | Kind | D2-2 | D2-2 | D2-2 | D2-2 | D2-2 | D2-2 |
| | | | Content | 3 | 3 | 3 | 3 | 3 | 3 |

| | | | | | | | | |
|---|---|---|---|---|---|---|---|---|
| | Hydroxy- and carboxy-containing | Kind | A3-1-6 | A3-1-7 | A3-1-8 | A3-1-9 | A3-1-10 | A3-1-11 |
| | polyester resin (A3-1) | Content | 89 | 89 | 89 | 89 | 89 | 89 |
| | Diester compound (C) | Kind | C-8 | C-8 | C-8 | C-8 | C-8 | C-8 |
| | | Content | 10 | 10 | 10 | 10 | 10 | 10 |
| | Hydrophobic solvent (E) | Kind | E-1 | E-1 | E-1 | E-1 | E-1 | E-1 |
| | | Content | 10 | 10 | 10 | 10 | 10 | 10 |
| Curing | Polycarbodiimido compound (B2) | Kind | B2-1 | B2-1 | B2-1 | B2-1 | B2-1 | B2-1 |
| agent | | Content | 38 | 38 | 38 | 38 | 38 | 38 |
| | Melamine resin (B3) | Kind | B3-1 | B3-1 | B3-1 | B3-1 | B3-1 | B3-1 |
| | | Content | 19 | 19 | 19 | 19 | 19 | 19 |

| | | | | | | |
|---|---|---|---|---|---|---|
| Gel fraction (G₈₀) of the coating film after being | 31 | 30 | 33 | 32 | 31 | 32 |
| heated at 80° C. for 10 minutes [%] | | | | | | |

TABLE 19

| Production Example | | | | 2-29 | 2-30 | 2-31 | 2-32 | 2-33 |
|---|---|---|---|---|---|---|---|---|
| Aqueous intermediate coating composition (X2) | | | | X2-29 | X2-30 | X2-31 | X2-32 | X2-33 |
| Main | Pigment | Hydroxy- and | Kind | A3-1-12 | A3-1-1 | A3-1-1 | A3-1-1 | A3-1-1 |
| agent | dispersion | carboxy-containing | Content | 44 | 44 | 44 | 44 | 44 |
| | paste | polyester resin (A3-1) | | | | | | |
| | | Coloring pigment | Kind | D1-1 | D1-1 | D1-1 | D1-1 | D1-1 |
| | | (D1) | Content | 60 | 60 | 60 | 60 | 60 |
| | | | Kind | D1-2 | D1-2 | D1-2 | D1-2 | D1-2 |
| | | | Content | 1 | 1 | 1 | 1 | 1 |
| | | Extender pigment | Kind | D2-1 | D2-1 | D2-1 | D2-1 | D2-1 |
| | | (D2) | Content | 15 | 15 | 15 | 15 | 15 |
| | | | Kind | D2-2 | D2-2 | D2-2 | D2-2 | D2-2 |
| | | | Content | 3 | 3 | 3 | 3 | 3 |

| | | | | | | | |
|---|---|---|---|---|---|---|---|
| | Hydroxy- and carboxy-containing | Kind | A3-1-12 | | | A3-1-1 | A3-1-1 |
| | polyester resin (A3-1) | Content | 89 | | | 100 | 89 |
| | Hydroxy- and carboxy-containing | Kind | | A3-2-1 | A3-2-2 | | |
| | acrylic resin (A3-2) | Content | | 100 | 89 | | |
| | Diester compound (C) | Kind | C-8 | C-8 | C-8 | C-8 | C-8 |
| | | Content | 10 | 10 | 10 | 10 | 10 |
| | Hydrophobic solvent (E) | Kind | E-1 | E-1 | E-1 | E-1 | E-1 |
| | | Content | 10 | 10 | 10 | 10 | 10 |
| Curing | Polycarbodiimido compound (B2) | Kind | B2-1 | B2-1 | B2-1 | B2-1 | B2-2 |
| agent | | Content | 38 | 38 | 38 | 63 | 38 |
| | Melamine resin (B3) | Kind | B3-1 | B3-1 | B3-1 | | B3-1 |
| | | Content | 19 | 19 | 19 | | 19 |

| | | | | | |
|---|---|---|---|---|---|
| Gel fraction (G₈₀) of the coating film after being | 30 | 33 | 42 | 20 | 28 |
| heated at 80° C. for 10 minutes [%] | | | | | |

TABLE 20

| Production Example | | | | 2-34 | 2-35 | 2-36 | 2-37 | 2-38 |
|---|---|---|---|---|---|---|---|---|
| Aqueous intermediate coating composition (X2) | | | | X2-34 | X2-35 | X2-36 | X2-37 | X2-38 |
| Main | Pigment | Hydroxy- and | Kind | A3-1-1 | A3-1-1 | A3-1-1 | A3-1-1 | A3-1-1 |
| agent | dispersion | carboxy-containing | Content | 44 | 44 | 44 | 44 | 44 |
| | paste | polyester resin (A3-1) | | | | | | |
| | | Coloring pigment | Kind | D1-1 | D1-1 | D1-1 | D1-1 | D1-1 |
| | | (D1) | Content | 60 | 60 | 60 | 60 | 60 |
| | | | Kind | D1-2 | D1-2 | D1-2 | D1-2 | D1-2 |
| | | | Content | 1 | 1 | 1 | 1 | 1 |
| | | Extender pigment | Kind | D2-1 | D2-1 | D2-1 | D2-1 | D2-1 |
| | | (D2) | Content | 15 | 15 | 15 | 15 | 15 |
| | | | Kind | D2-2 | D2-2 | D2-2 | D2-2 | D2-2 |
| | | | Content | 3 | 3 | 3 | 3 | 3 |

| | Hydroxy- and carboxy-containing | Kind | A3-1-1 | A3-1-1 | A3-1-1 | A3-1-1 | A3-1-1 |
|---|---|---|---|---|---|---|---|
| | polyester resin (A3-1) | Content | 89 | 89 | 89 | 89 | 89 |
| | Diester compound (C) | Kind | C-8 | C-8 | C-8 | C-8 | C-8 |
| | | Content | 10 | 10 | 10 | 10 | 10 |
| | Hydrophobic solvent (E) | Kind | E-1 | E-1 | | E-1 | E-1 |
| | | Content | 10 | 10 | | 10 | 10 |
| | Ethylene glycol mono-n-butyl ether | | | | 10 | | |
| Curing | Polycarbodiimido compound (B2) | Kind | B2-1 | B2-1 | B2-1 | B2-1 | B2-1 |
| agent | | Content | 38 | 38 | 38 | 38 | 38 |
| | Melamine resin (B3) | Kind | B3-2 | B3-3 | B3-1 | B3-1 | B3-1 |
| | | Content | 17 | 21 | 19 | 19 | 19 |

| | | | | | |
|---|---|---|---|---|---|
| Gel fraction (G₈₀) of the coating film after being | 29 | 30 | 23 | 30 | 30 |
| heated at 80° C. for 10 minutes [%] | | | | | |

TABLE 21

| Production Example | | | | 2-39 | 2-40 | 2-41 | 2-42 | 2-43 |
|---|---|---|---|---|---|---|---|---|
| Aqueous intermediate coating composition (X2) | | | | X2-39 | X2-40 | X2-41 | X2-42 | X2-43 |
| Main | Pigment | Hydroxy- and | Kind | A3-1-1 | A3-1-1 | A3-1-1 | A3-1-1 | A3-1-1 |
| agent | dispersion | carboxy-containing | Content | 44 | 44 | 44 | 44 | 44 |
| | paste | polyester resin (A3-1) | | | | | | |
| | | Coloring pigment | Kind | D1-1 | D1-1 | D1-1 | D1-1 | D1-1 |
| | | (D1) | Content | 60 | 60 | 60 | 60 | 60 |
| | | | Kind | D1-2 | D1-2 | D1-2 | D1-2 | D1-2 |
| | | | Content | 1 | 1 | 1 | 1 | 1 |
| | | Extender pigment | Kind | D2-1 | D2-1 | D2-1 | D2-1 | D2-1 |
| | | (D2) | Content | 15 | 15 | 15 | 15 | 15 |
| | | | Kind | D2-2 | D2-2 | D2-2 | D2-2 | D2-2 |
| | | | Content | 3 | 3 | 3 | 3 | 3 |

| | | | | | | | |
|---|---|---|---|---|---|---|---|
| | Hydroxy- and carboxy-containing | Kind | A3-1-1 | A3-1-1 | A3-1-1 | A3-1-1 | A3-1-1 |
| | polyester resin (A3-1) | Content | 89 | 89 | 104 | 98 | 98 |
| | Diester compound (C) | Kind | C-19 | C-20 | | C-8 | C-8 |
| | | Content | 10 | 10 | | 10 | 10 |
| | Hydrophobic solvent (E) | Kind | E-1 | E-1 | E-1 | E-1 | E-1 |
| | | Content | 10 | 10 | 10 | 10 | 10 |
| Curing | Polycarbodiimido compound (B2) | Kind | B2-1 | B2-1 | B2-1 | | |
| agent | | Content | 38 | 38 | 41 | | |
| | Melamine resin (B3) | Kind | B3-1 | B3-1 | B3-1 | B3-1 | |
| | | Content | 19 | 19 | 21 | 33 | |

| | |
|---|---|
| Bayhydrol VP LS-2310 | 68 |

| | | | | | |
|---|---|---|---|---|---|
| Gel fraction (G₈₀) of the coating film after being | 30 | 30 | 34 | 2 | 0 |
| heated at 80° C. for 10 minutes [%] | | | | | |

### Preparation of Test Plate

The aqueous intermediate coating compositions (X2-1) to (X2-43) obtained in Production Examples 2-1 to 2-43, and the aqueous base coating compositions (Y-1) and (Y-2) obtained in Production Examples 1-66 and 1-67 were used in the following manner to form test plates. Evaluation tests were then performed.

### Preparation of Substrate to be Coated

A cationic electrodeposition coating composition (trade name “Electron GT-10”, produced by Kansai Paint Co., Ltd.) was applied to a cold-rolled steel plate treated with zinc phosphate by electrodeposition to a cured film thickness of 20 μm, and was cured by heating at 170° C. for 30 minutes. A test substrate was thus prepared.

### Example 2-1

The aqueous intermediate coating composition (X2-1) obtained in Production Example 2-1 was electrostatically applied to the substrate using a rotary atomizing electrostatic coating machine to a cured film thickness of 25 μm, then allowed to stand for 2 minutes, and preheated at 80° C. for 3 minutes. Subsequently, the aqueous base coating composition (Y-1) obtained in Production Example 1-66 was electrostatically applied to the uncured intermediate coating film using a rotary atomizing electrostatic coating machine to a cured film thickness of 15 μm, then allowed to stand for 2 minutes, and preheated at 80° C. for 3 minutes. Next, an acrylic resin solvent-based clear topcoat composition (trade name “Magicron KINO-1210”, produced by Kansai Paint Co., Ltd; hereinafter sometimes referred to as “clear coating composition (Z-1))” was electrostatically applied to the uncured base coating film to a cured film thickness of 35 pin, then allowed to stand for 7 minutes, and heated at 140° C. for 30 minutes to cure the intermediate coating film, the base coating film and the clear coating film simultaneously. A test plate was thus obtained.

### Examples 2-2 to 2-39, Comparative Examples 2-1 to 2-5

Test plates were obtained in the same manner as in Example 2-1, except that any one of aqueous intermediate coating compositions (X2-2) to (X2-43) shown in Tables 22 to 26 was used in place of the aqueous intermediate coating composition (X2-1) obtained in Production Example 2-1, and that aqueous base coating compositions shown in Tables 22 to 26 were used in place of the aqueous base coating composition (Y-1) obtained in Production Example 1-66.

### Evaluation Test

Test plates obtained in Examples 2-1 to 2-39 and Comparative Examples 2-1 to 2-5 were evaluated in the same manner as above for smoothness, distinctness of image, flip-flop effect, metallic mottling, water resistance, and chipping resistance. Tables 22 to 26 show the evaluation results.

TABLE 22

| | | Example | | | | | | | | | |
|---|---|---|---|---|---|---|---|---|---|---|---|
| | | 2-1 | 2-2 | 2-3 | 2-4 | 2-5 | 2-6 | 2-7 | 2-8 | 2-9 | 2-10 |
| Aqueous intermediate | | X2-1 | X2-2 | X2-3 | X2-4 | X2-5 | X2-6 | X2-7 | X2-8 | X2-9 | X2-10 |
| coating composition (X2) | | | | | | | | | | | |
| Aqueous base coating | | Y-1 | Y-1 | Y-1 | Y-1 | Y-1 | Y-1 | Y-1 | Y-1 | Y-1 | Y-1 |
| composition (Y) | | | | | | | | | | | |
| Clear coating | | Z-1 | Z-1 | Z-1 | Z-1 | Z-1 | Z-1 | Z-1 | Z-1 | Z-1 | Z-1 |
| Composition (Z) | | | | | | | | | | | |
| Evaluation result | | | | | | | | | | | |
| Smoothness | Initial | 8.5 | 8.6 | 7.9 | 8.1 | 7.4 | 7.7 | 8.0 | 7.6 | 7.7 | 7.8 |
| | Post- | 9.7 | 9.0 | 8.4 | 8.6 | 8.5 | 8.7 | 9.1 | 7.9 | 8.5 | 8.3 |
| | storage | | | | | | | | | | |

| | | | | | | | | | | |
|---|---|---|---|---|---|---|---|---|---|---|
| Distinctness of image | 16.3 | 16.1 | 14.6 | 15.1 | 14.2 | 14.4 | 14.7 | 13.6 | 14.6 | 14.4 |
| Flip-flop effect | B | A | A | A | A | B | B | A | A | A |
| Metallic mottling | B | A | A | A | A | A | B | A | A | A |
| Water resistance | B | A | A | A | A | A | A | A | A | A |
| Chipping resistance | A | A | A | A | A | A | A | A | A | A |

TABLE 23

| | | Example | | | | | | | | | |
|---|---|---|---|---|---|---|---|---|---|---|---|
| | | 2-11 | 2-12 | 2-13 | 2-14 | 2-15 | 2-16 | 2-17 | 2-18 | 2-19 | 2-20 |
| Aqueous intermediate | | X2-11 | X2-12 | X2-13 | X2-14 | X2-15 | X2-16 | X2-17 | X2-18 | X2-19 | X2-20 |
| coating composition (X2) | | | | | | | | | | | |
| Aqueous base coating | | Y-1 | Y-1 | Y-1 | Y-1 | Y-1 | Y-1 | Y-1 | Y-1 | Y-1 | Y-1 |
| composition (Y) | | | | | | | | | | | |
| Clear coating | | Z-1 | Z-1 | Z-1 | Z-1 | Z-1 | Z-1 | Z-1 | Z-1 | Z-1 | Z-1 |
| Composition (Z) | | | | | | | | | | | |
| Evaluation result | | | | | | | | | | | |
| Smoothness | Initial | 8.3 | 8.5 | 8.7 | 8.8 | 8.7 | 7.6 | 8.7 | 8.9 | 7.8 | 7.6 |
| | Post- | 9.7 | 8.9 | 9.7 | 9.8 | 9.1 | 8.0 | 8.8 | 9.9 | 8.3 | 8.1 |
| | storage | | | | | | | | | | |

| | | | | | | | | | | |
|---|---|---|---|---|---|---|---|---|---|---|
| Distinctness of image | 15.2 | 15.9 | 16.4 | 16.7 | 16.5 | 14.5 | 16.3 | 16.7 | 13.9 | 13.6 |
| Flip-flop effect | A | A | B | B | B | A | B | B | A | A |
| Metallic mottling | B | A | B | B | B | A | A | B | A | A |
| Water resistance | A | A | B | B | B | A | B | B | A | A |
| Chipping resistance | A | A | A | A | A | A | A | A | A | A |

TABLE 24

| | | Example | | | | | | | | | |
|---|---|---|---|---|---|---|---|---|---|---|---|
| | | 2-21 | 2-22 | 2-23 | 2-24 | 2-25 | 2-26 | 2-27 | 2-28 | 2-29 | 2-30 |
| Aqueous intermediate | | X2-21 | X2-22 | X2-23 | X2-24 | X2-25 | X2-26 | X2-27 | X2-28 | X2-29 | X2-30 |
| coating composition (X2) | | | | | | | | | | | |
| Aqueous base coating | | Y-1 | Y-1 | Y-1 | Y-1 | Y-1 | Y-1 | Y-1 | Y-1 | Y-1 | Y-1 |
| composition (Y) | | | | | | | | | | | |
| Clear coating | | Z-1 | Z-1 | Z-1 | Z-1 | Z-1 | Z-1 | Z-1 | Z-1 | Z-1 | Z-1 |
| composition (Z) | | | | | | | | | | | |
| Evaluation result | | | | | | | | | | | |
| Smoothness | Initial | 7.6 | 7.2 | 7.3 | 7.1 | 6.6 | 8.2 | 8.7 | 8.9 | 7.8 | 8.7 |
| | Post- | 8.0 | 7.7 | 7.8 | 7.6 | 7.0 | 8.7 | 9.2 | 9.5 | 8.4 | 9.2 |
| | storage | | | | | | | | | | |

| | | | | | | | | | | |
|---|---|---|---|---|---|---|---|---|---|---|
| Distinctness of image | 13.3 | 13.5 | 13.2 | 13.5 | 13.3 | 14.6 | 15.7 | 16.3 | 13.9 | 13.2 |
| Flip-flop effect | A | A | A | A | A | A | A | A | A | A |
| Metallic mottling | A | A | A | A | A | A | A | A | A | A |
| Water resistance | A | A | A | A | A | A | B | B | A | A |
| Chipping resistance | A | A | A | A | A | B | A | A | B | B |

TABLE 25

| | | Example | | | | | | | | |
|---|---|---|---|---|---|---|---|---|---|---|
| | | 2-31 | 2-32 | 2-33 | 2-34 | 2-35 | 2-36 | 2-37 | 2-38 | 2-39 |
| Aqueous intermediate | | X2-31 | X2-32 | X2-33 | X2-34 | X2-35 | X2-36 | X2-37 | X2-38 | X2-8 |
| coating composition (X2) | | | | | | | | | | |
| Aqueous base coating | | Y-1 | Y-1 | Y-1 | Y-1 | Y-1 | Y-1 | Y-1 | Y-1 | Y-2 |
| composition (Y) | | | | | | | | | | |
| Clear coating | | Z-1 | Z-1 | Z-1 | Z-1 | Z-1 | Z-1 | Z-1 | Z-1 | Z-1 |
| Composition (Z) | | | | | | | | | | |
| Evaluation result | | | | | | | | | | |
| Smoothness | Initial | 9.5 | 8.0 | 7.9 | 7.7 | 7.9 | 7.7 | 8.5 | 9.8 | 9.6 |
| | Post- | 9.9 | 8.5 | 8.4 | 8.2 | 8.4 | 8.1 | 8.9 | 10.3 | 10.1 |
| | storage | | | | | | | | | |

| | | | | | | | | | |
|---|---|---|---|---|---|---|---|---|---|
| Distinctness of image | 13.6 | 14.0 | 14.6 | 13.8 | 14.0 | 14.5 | 14.0 | 13.2 | 14.5 |
| Flip-flop effect | A | A | A | A | A | B | A | B | B |
| Metallic mottling | A | A | A | A | A | B | A | B | B |
| Water resistance | A | B | A | B | A | A | B | A | A |
| Chipping resistance | A | B | A | A | A | B | A | A | A |

TABLE 26

| | | Comparative Example | | | | |
|---|---|---|---|---|---|---|
| | | 2-1 | 2-2 | 2-3 | 2-4 | 2-5 |
| Aqueous intermediate | | X2-39 | X2-40 | X2-41 | X2-42 | X2-43 |
| coating composition (X2) | | | | | | |
| Aqueous base coating | | Y-1 | Y-1 | Y-1 | Y-1 | Y-1 |
| composition (Y) | | | | | | |
| Clear coating | | Z-1 | Z-1 | Z-1 | Z-1 | Z-1 |
| Composition (Z) | | | | | | |
| Evaluation result | | | | | | |
| Smoothness | Initial | 11.5 | 13.5 | 13.8 | 12.2 | 12.5 |
| | Post- | 12.5 | 13.7 | 14.2 | 12.8 | 13.0 |
| | storage | | | | | |

| | | | | | |
|---|---|---|---|---|---|
| Distinctness of image | 18.1 | 17.5 | 18.8 | 19.4 | 19.1 |
| Flip-flop effect | C | C | C | C | C |
| Metallic mottling | D | D | C | C | C |
| Water resistance | A | A | A | A | A |
| Chipping resistance | A | A | A | A | A |

1. A method of forming a multilayer coating film comprising the steps of:
(1) applying an aqueous intermediate coating composition (X) to a substrate to form an intermediate coating layer thereon;
(2) applying an aqueous base coating composition (Y) to the uncured intermediate coating layer formed in step (1) to form a base coating layer thereon;
(3) applying a clear coating composition (Z) to the uncured base coating layer formed in step (2) to form a clear coating layer thereon; and
(4) simultaneously heat-curing the uncured intermediate coating, uncured base coating, and uncured clear coating layers formed in steps (1) to (3), the aqueous intermediate coating composition (X) comprising: a base resin (A); a curing agent (B); and a diester compound (C),
the curing agent (B) being a polyisocyanate compound (B1) and/or a polycarbodiimide compound (B2); and
the diester compound (C) being represented by formula (1): 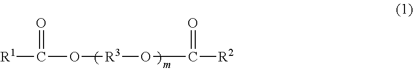
(wherein R¹ and R² are each independently a hydrocarbon group having 4 to 18 carbon atoms, R³ is an alkylene group having 2 to 4 carbon atoms, m is an integer of 3 to 25, and m oxyalkylene units (R³—O) may be the same or different).

2. The method of forming a multilayer coating film according to claim 1 wherein the base resin (A) is a hydroxy-containing resin (A1), and the curing agent (B) is a polyisocyanate compound (B1).

3. The method of forming a multilayer coating film according to claim 2 wherein the hydroxy-containing resin (A1) is a hydroxy-containing polyester resin (A1-1) and/or a hydroxy-containing acrylic resin (A1-2).

4. The method of forming a multilayer coating film according to claim 3 wherein the hydroxy-containing polyester resin (A1-1) is a polyester resin containing a C₄ or higher linear alkylene group in an amount of 0.3 to 2.5 mol/kg (on a resin solids basis).

5. The method of forming a multilayer coating film according to claim 3 wherein the hydroxy-containing polyester resin (A1-1) contains a benzene ring and/or a cyclohexane ring in such an amount that the total amount of benzene ring and cyclohexane ring is in the range of 1.5 to 4.0 mol/kg (on a resin solids basis).

6. The method of forming a multilayer coating film according to claim 2 wherein the polyisocyanate compound (B1) is a water-dispersible polyisocyanate compound.

7. The method of forming a multilayer coating film according to claim 2 wherein the proportions of the hydroxy-containing resin (A1), polyisocyanate compound (B1), and diester compound (C) are such that the amount of hydroxyl-containing resin (A1) is 30 to 95 parts by mass, the amount of polyisocyanate compound (B1) is 5 to 70 parts by mass, and the amount of diester compound (C) is 1 to 30 parts by mass, per 100 parts by mass of the total amount of hydroxy-containing resin (A1) and polyisocyanate compound (B1), on a solids basis.

8. The method of forming a multilayer coating film according to claim 1 wherein the base resin (A) is a carboxy-containing resin (A2), and the curing agent (B) is a polycarbodiimide compound (B2).

9. The method of forming a multilayer coating film according to claim 8 wherein the carboxy-containing resin (A2) is a carboxy-containing polyester resin (A2-1) and/or a carboxy-containing acrylic resin (A2-2).

10. The method of forming a multilayer coating film according to claim 9 wherein the carboxy-containing polyester resin (A2-1) is a polyester resin containing a C₄ or higher linear alkylene group in an amount of 0.3 to 2.5 mol/kg (on a resin solids basis).

11. The method of forming a multilayer coating film according to claim 9 wherein the carboxy-containing polyester resin (A2-1) contains a benzene ring and/or a cyclohexane ring in such an amount that the total amount of benzene ring and cyclohexane ring is in the range of 1.5 to 4.0 mol/kg (on a resin solids basis).

12. The method of forming a multilayer coating film according to claim 8 wherein the proportions of the carboxy-containing resin (A2), the polycarbodiimide compound (B2), and the diester compound (C) are such that the amount of carboxy-containing resin (A2) is 30 to 95 parts by mass, the amount of polycarbodiimide compound (B2) is 5 to 70 parts by mass, and the amount of diester compound (C) is 1 to 30 parts by mass, per 100 parts by mass of the total amount of carboxy-containing resin (A2) and polycarbodiimide compound (B2), on a solids basis.

13. The method of forming a multilayer coating film according to claim 1 wherein the coating composition (X) contains a carboxy- and hydroxy-containing resin (A3) as the base resin (A), a polycarbodiimide compound (B2) as the curing agent (B), and further contains an amino resin (B3).

14. The method of forming a multilayer coating film according to claim 13 wherein the amino resin (B3) is a melamine resin (B3-1), the melamine resin (B3-1) being a methyl-butyl mixed etherified melamine resin having a methoxy/butoxy molar ratio in the range of 90/10 to 50/50.

15. The method of forming a multilayer coating film according to claim 1 wherein the aqueous intermediate coating composition (X) further contains a coloring pigment (D1) and/or an extender pigment (D2) in such an amount that the total amount of coloring pigment (D1) and extender pigment (D2) is in the range of 40 to 180 parts by mass per 100 parts by mass of the total amount of base resin (A) and curing agent (B), on a solids basis.

16. The method of forming a multilayer coating film according to claim 1 wherein the aqueous base coating composition (Y) comprises a luster pigment (D3).

17. The method of forming a multilayer coating film according to claim 1 wherein the substrate is a vehicle body having an undercoating layer formed thereon using an electrodeposition coating composition.

18. An article having a multilayer coating film formed thereon by the method of claim 1.

19. An aqueous intermediate coating composition for forming a multilayer coating film comprising a base resin (A), a curing agent (B), and a diester compound (C), the curing agent (B) being a polyisocyanate compound (B1) and/or a polycarbodiimide compound (B2); and the diester compound (C) being represented by formula (1): 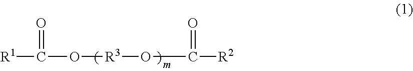
(wherein R¹ and R² are each independently a hydrocarbon group having 4 to 18 carbon atoms, R³ is an alkylene group having 2 to 4 carbon atoms, m is an integer of 3 to 25, and m oxyalkylene units (R³—O) may be the same or different).
